(19) United States
(12) Patent Application Publication
(10) Pub. No.: US 2022/0349435 A1
(43) Pub. Date: Nov. 3, 2022

(54) MULTI-MODAL INDUSTRIAL SECURING DEVICES

(71) Applicant: Grodab LLC, Wheeling, IL (US)

(72) Inventors: Martin DIMITROV, Wheeling, IL (US); Karol GRYCUK, Mount Prospect, IL (US)

(21) Appl. No.: 17/640,986

(22) PCT Filed: Sep. 5, 2020
(86) PCT No.: PCT/US20/49584

§ 371 Date: Mar. 7, 2022

Related U.S. Application Data
(60) Provisional application No. 62/896,432, filed on Sep. 5, 2019.
(60) Provisional application No. 62/896,436, filed on Sep. 5, 2019.
(60) Provisional application No. 62/896,440, filed on Sep. 5, 2019.
(60) Provisional application No. 62/896,444, filed on Sep. 5, 2019.
(60) Provisional application No. 62/896,447, filed on Sep. 5, 2019.

(51) Int. Cl. F16B 21/08; B65D 63/02; B65D 63/10; F16B 2/24; F16B 7/04

(52) U.S. Cl. CPC F16B 21/086; B65D 63/02; B65D 63/1018; F16B 2/241; F16B 7/04

(57) ABSTRACT

The present disclosure provides fasteners movable between a first configuration and a second configuration, and fastener systems comprising same.

### PRIORITY CLAIMS

This application is a national stage entry of International Patent Application Serial No. PCT/US20/49584, filed Sep. 5, 2020, which claims priority to U.S. Provisional Patent Application Ser. No. 62/896,432, filed Sep. 5, 2019; to U.S. Provisional Patent Application Ser. No. 62/896,436, filed Sep. 5, 2019; to U.S. Provisional Patent Application Ser. No. 62/896,440, filed Sep. 5, 2019; to U.S. Provisional Patent Application Ser. No. 62/896,444, filed Sep. 5, 2019; and to U.S. Provisional Patent Application Ser. No. 62/896,447, filed Sep. 5, 2019, the entire contents of each of which are incorporated herein by reference and relied upon.

### BACKGROUND

Industrial fasteners for relatively long objects (e.g., wires, cables, rope, string, etc.) known in the art are generally formed of a long uniform piece of material. While such designs (e.g., VELCRO strips) offer some benefits, fastening loops of these uniform materials to each other is inconvenient, or even impossible. Available industrial fasteners can cause stress and even breakage of the retained objects. Retention and organization of groups of objects using industrial fasteners therefore remains an unsolved but desirable goal.

The present disclosure describes systems and methods that meet that need.

### SUMMARY

The present disclosure relates generally to multi-modal (e.g., bimodal) devices configured to be movable from a first resting configuration to at least a second resting configuration to conveniently and releasably retain one or more loose objects, such as cables, ropes, cords, tubing, etc., or to wrap around an object, such as a pipe, a branch, a pole, etc.

In one embodiment, the present disclosure provides a multi-modal fastener including a first end, a second end opposite the first end, a first face, and a second face opposite the first face, the multi-modal fastener comprising: a length of material extending substantially from the first end to the second end; a securing portion disposed proximal to the second end; and a mating portion disposed proximal to the first end and configured to reversibly mate with the securing portion, wherein the length of material is movable between a first stable resting configuration and a second stable resting configuration.

In some embodiments, the present disclosure provides a bi-modal fastener including a first end, a second end opposite the first end, the bi-modal fastener comprising: a bi-modal length of material extending substantially from the first end to the second end and configured to selectably adopt a first stable generally planar resting configuration and a second stable generally coil-shaped resting configuration; a cover substantially surrounding the bi-modal length of material and including a first face, and a second face opposite the first face; a mating portion comprising at least one mating feature disposed proximal to the first end and on the second face; and a securing portion comprising a plurality of securing features disposed proximal to the second end and on the first face, wherein the plurality of securing features are each configured to reversibly mate with the at least one mating feature.

### BRIEF DESCRIPTION OF THE DRAWINGS

FIG. 1A shows a top perspective view of a pair of loop-shaped devices joined to each other according to one embodiment of the present disclosure.

FIG. 1B shows a top perspective view of the pair of loop-shaped devices of FIG. 1A, wherein the loop-shaped devices have been rotated 90° compared to their relative positions shown in FIG. 1A.

FIG. 10 shows a longitudinal cross-sectional view of a length of material consistent with one embodiment of the present disclosure.

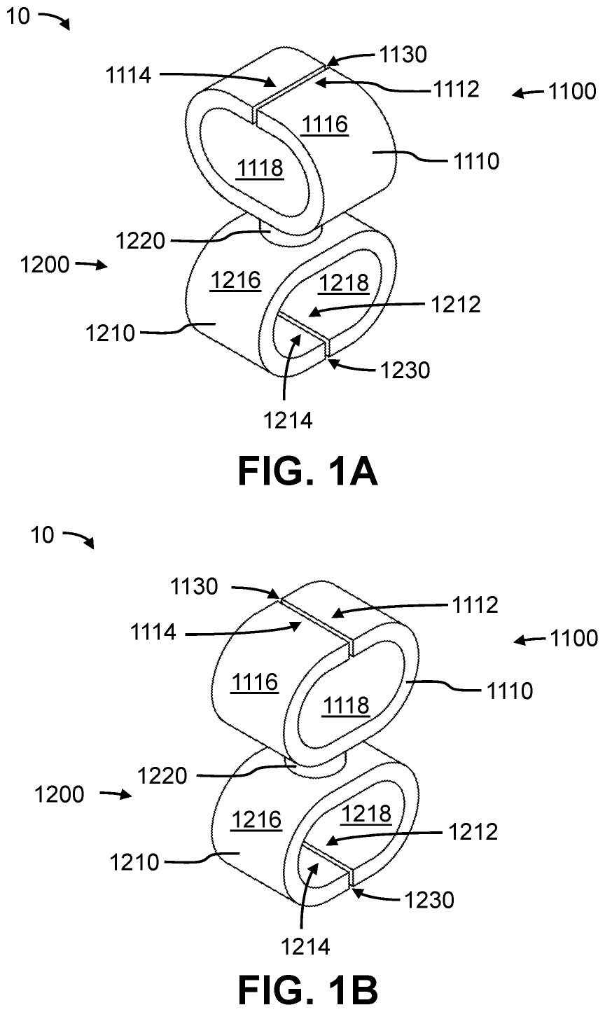

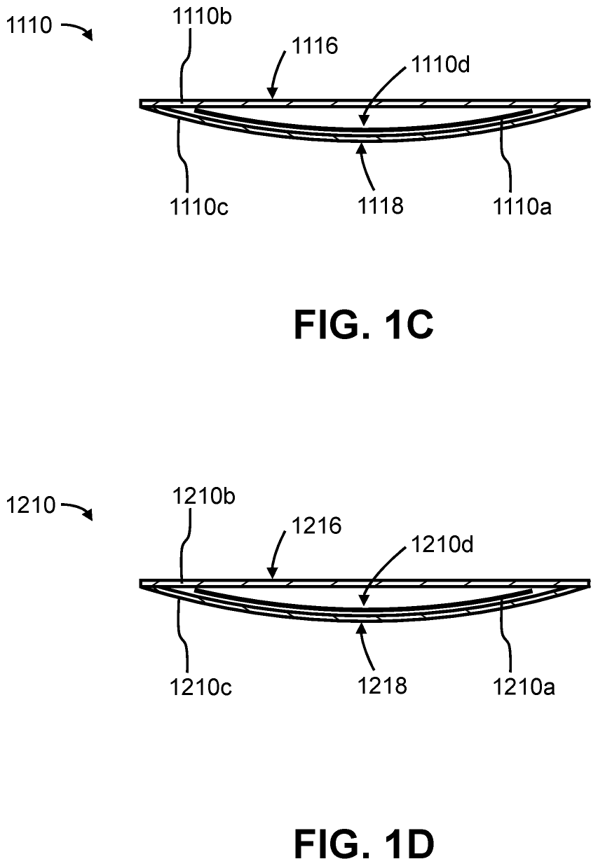

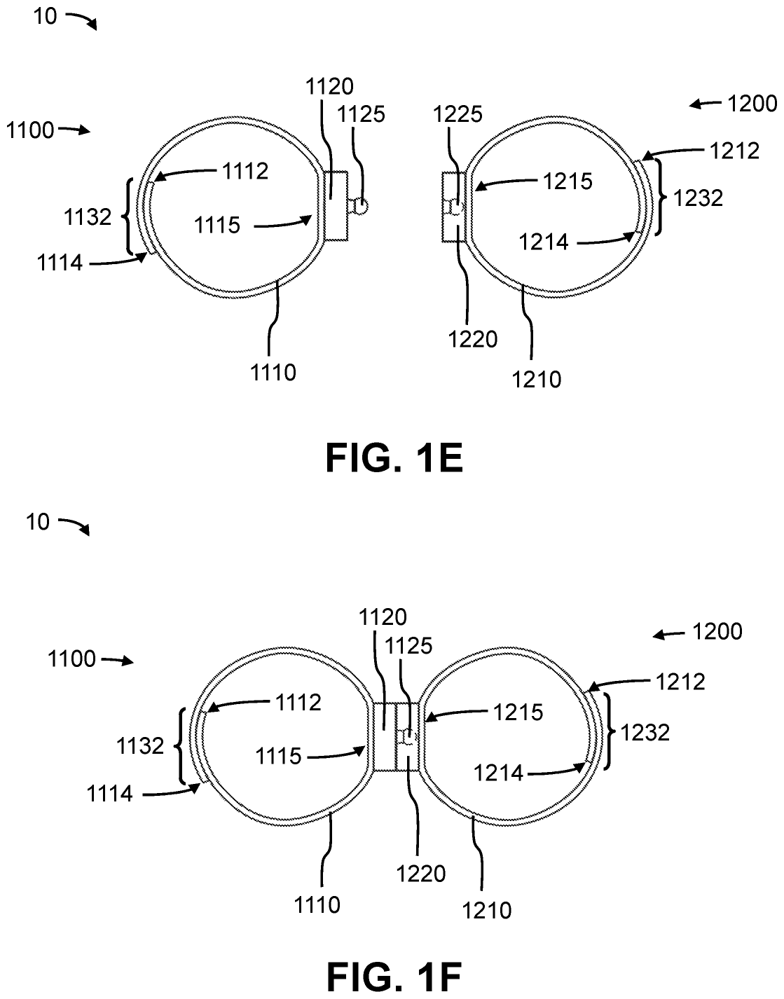

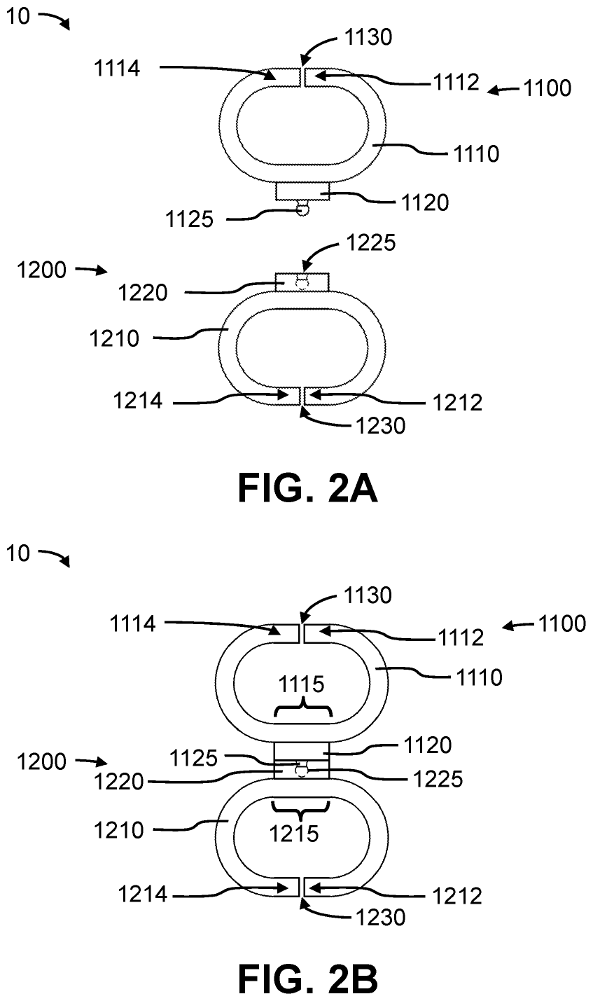

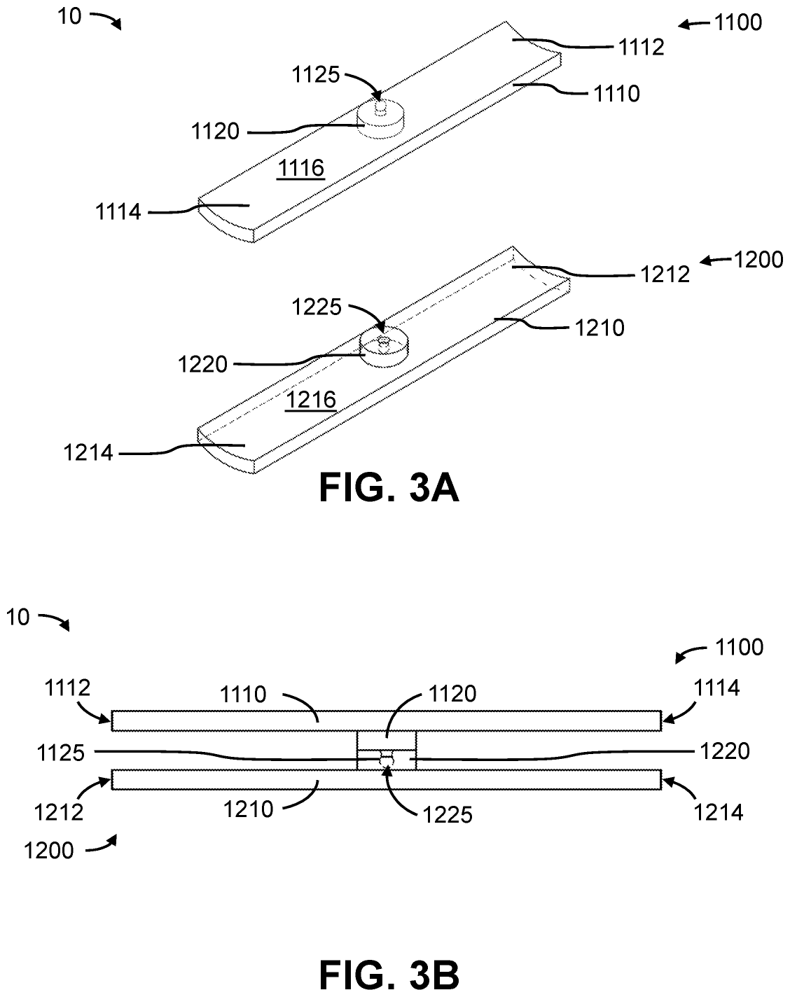

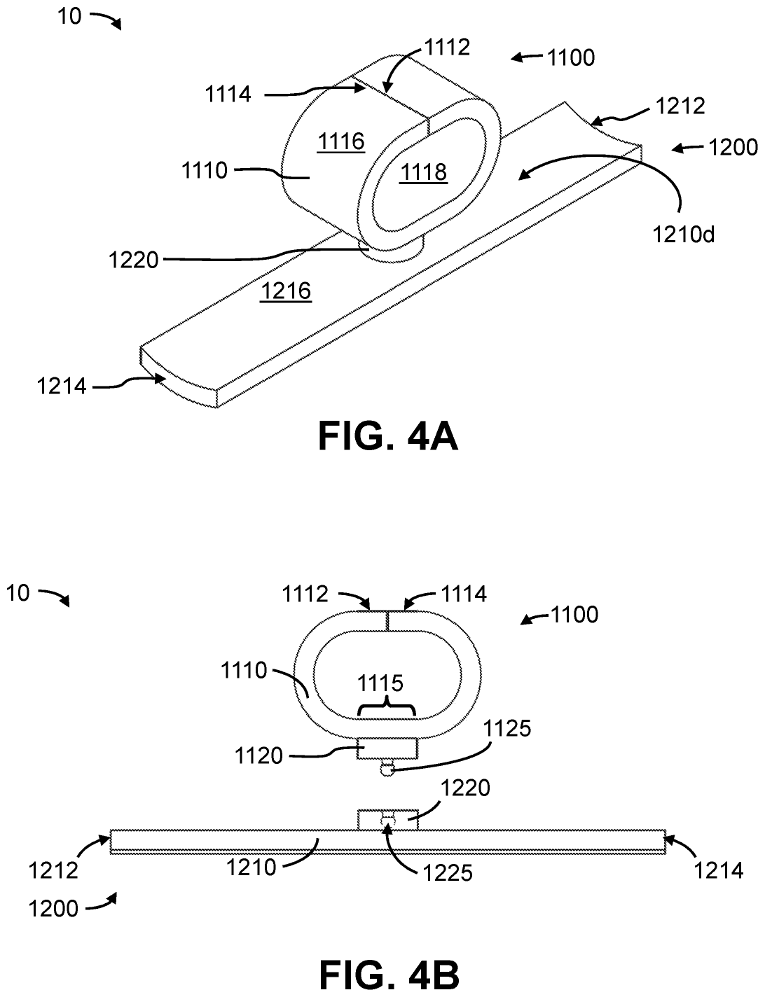

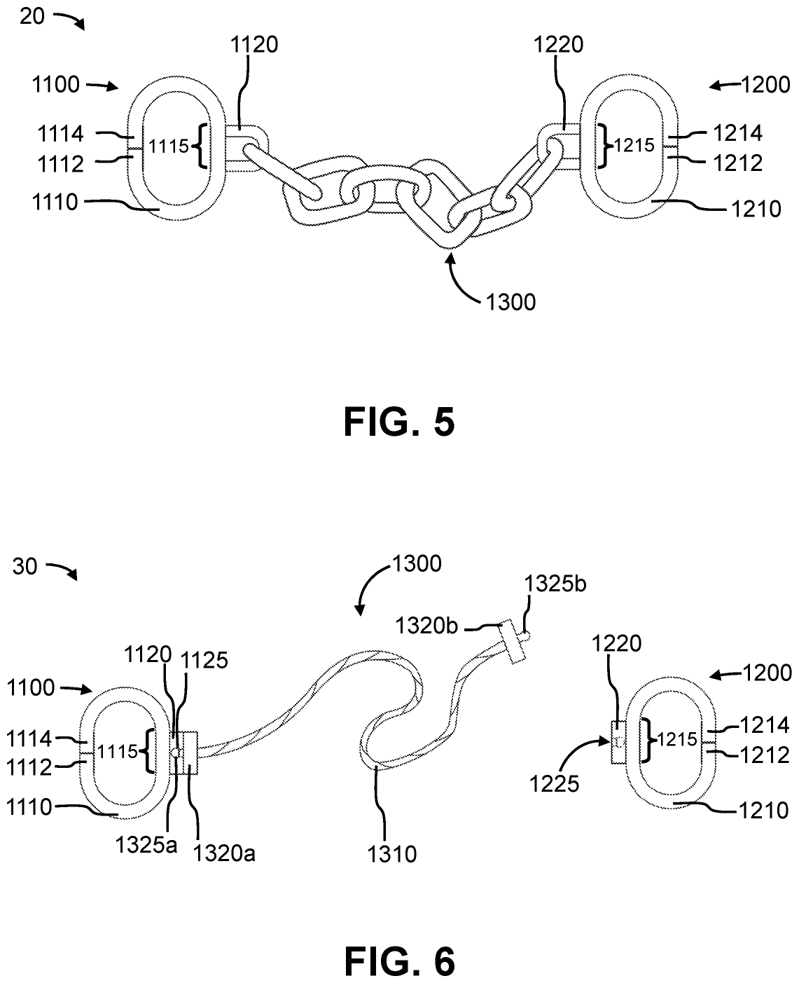

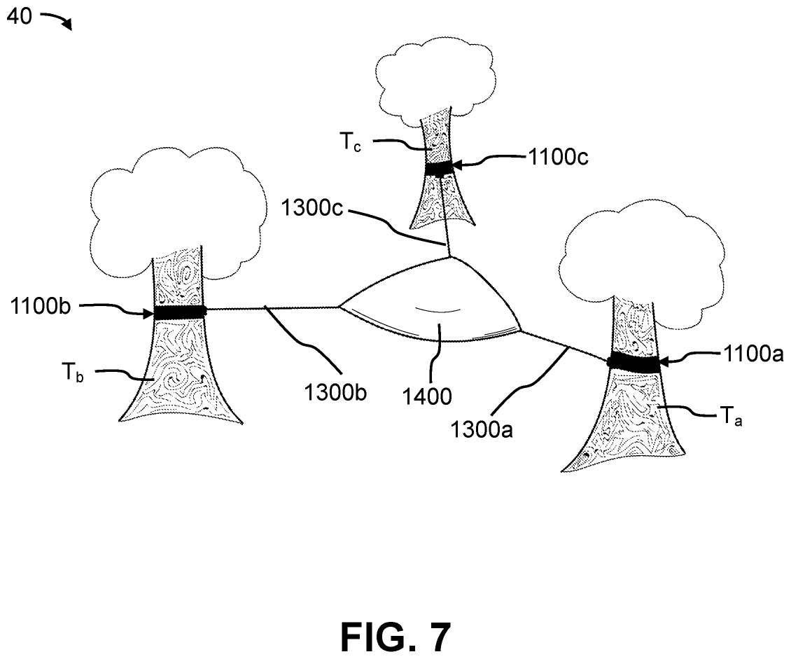

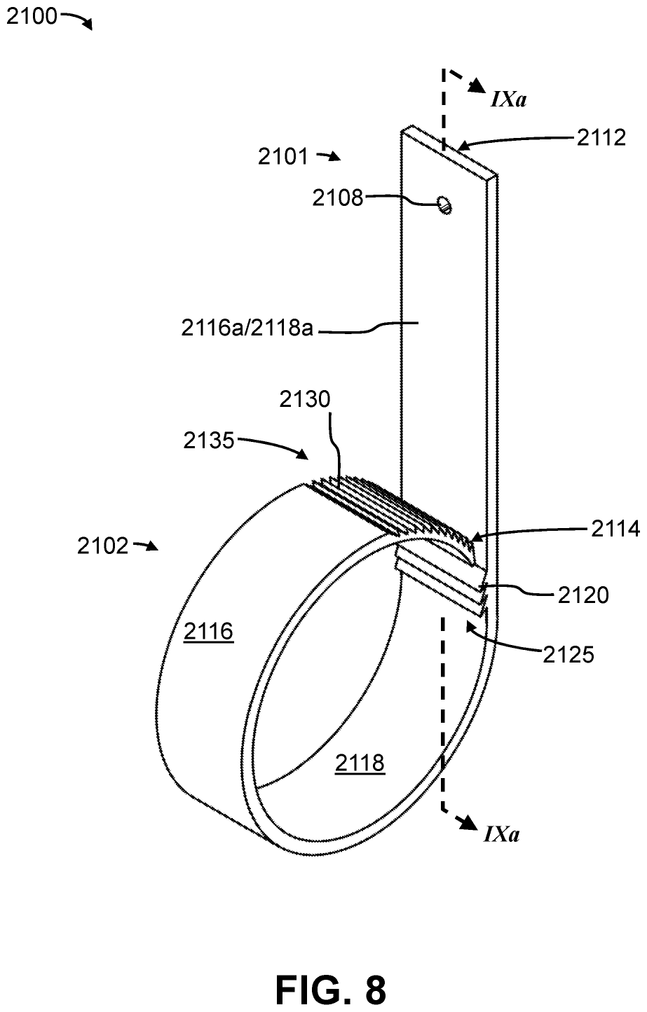

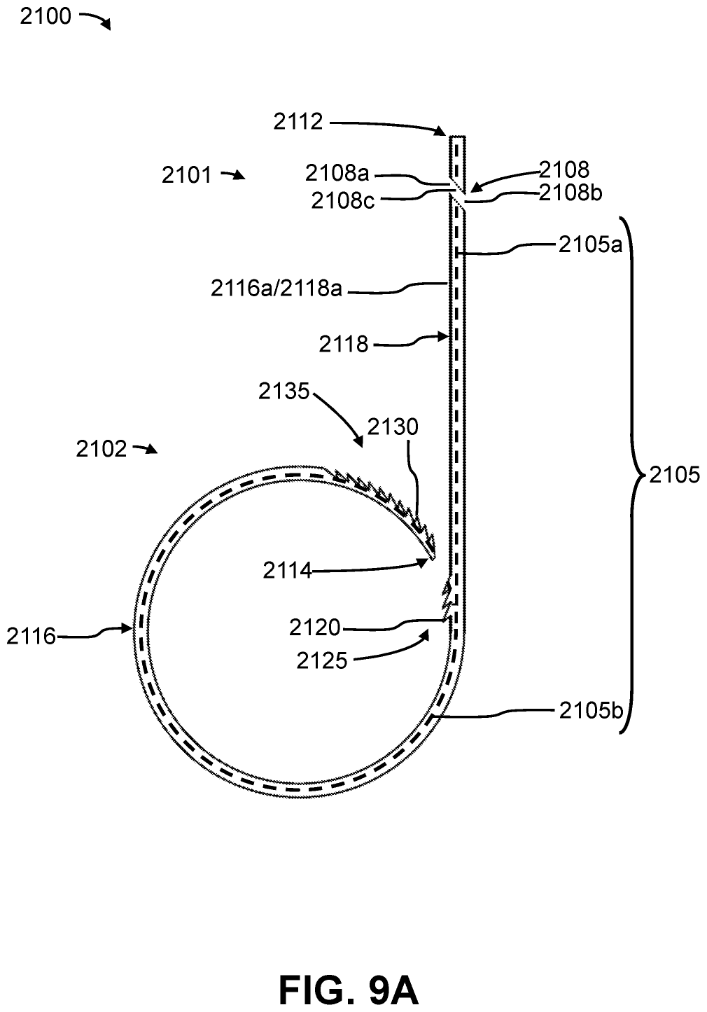

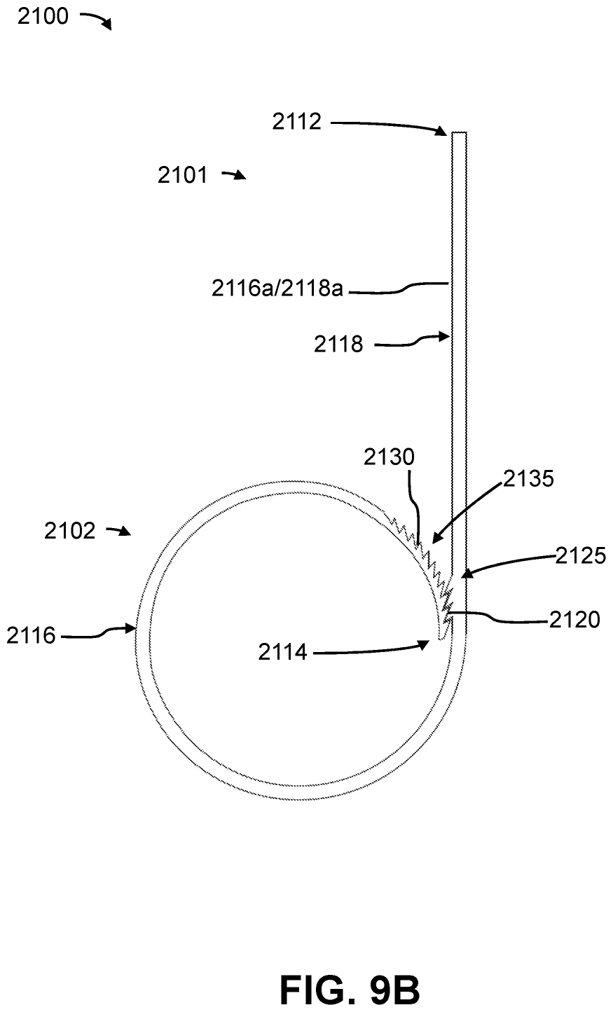

FIG. 1D shows a longitudinal cross-sectional view of a length of material consistent with one embodiment of the present disclosure.

FIG. 1E shows a side view of a pair of loop-shaped devices not joined to each other according to one embodiment of the present disclosure.

FIG. 1F shows a side view of the pair of loop-shaped devices of FIG. 1E, wherein the pair of loop-shaped devices are joined to each other.

FIG. 2A shows a side view of a pair of loop-shaped devices not joined to each other according to one embodiment of the present disclosure.

FIG. 2B shows a side view of the pair of loop-shaped devices of FIG. 2A, wherein the pair of loop-shaped devices are joined to each other.

FIG. 3A shows a top perspective view of a pair of loop-shaped devices, each in an open (not looped) configuration, according to one embodiment of the present disclosure.

FIG. 3B shows a side view of the pair of loop-shaped devices of FIG. 3A joined together and each in an open (not looped) configuration.

FIG. 4A shows a top perspective view of a pair of loop-shaped devices joined to each other, with one device in a closed (looped) configuration and the other device in an open (not looped) configuration.

FIG. 4B shows a side view of the pair of loop-shaped devices of FIG. 4A joined together, with one device in a closed (looped) configuration and the other device in an open (not looped) configuration.

FIG. 5 shows a perspective view of a pair of loop-shaped devices connected by a chain according to another embodiment of the present disclosure.

FIG. 6 shows a perspective view of a pair of loop-shaped devices connectable by a detachable strand according to another embodiment of the present disclosure.

FIG. 7 shows a perspective view of a trio of loop-shaped devices joined by a hammock according to another embodiment of the present disclosure.

FIG. 8 shows a perspective view of a fastener in a closed resting configuration according to one embodiment of the present disclosure.

FIG. 9A shows a side cross-sectional view of the fastener of FIG. 8 wherein the multi-modal portion 2102 is in a closed resting configuration.

FIG. 9B shows a side view of the fastener of FIG. 9A in a closed resting configuration wherein the first mating portion is mated with the second mating portion.

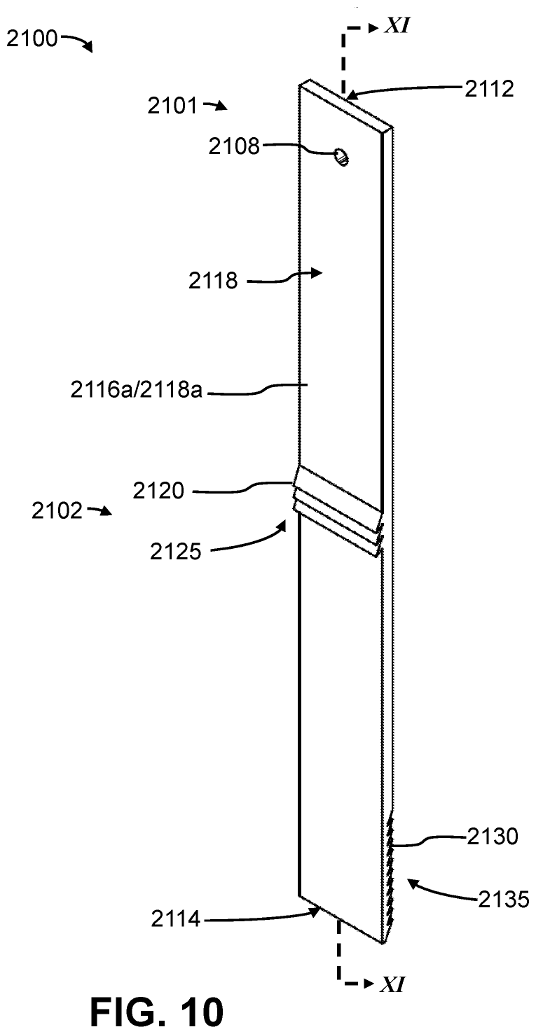

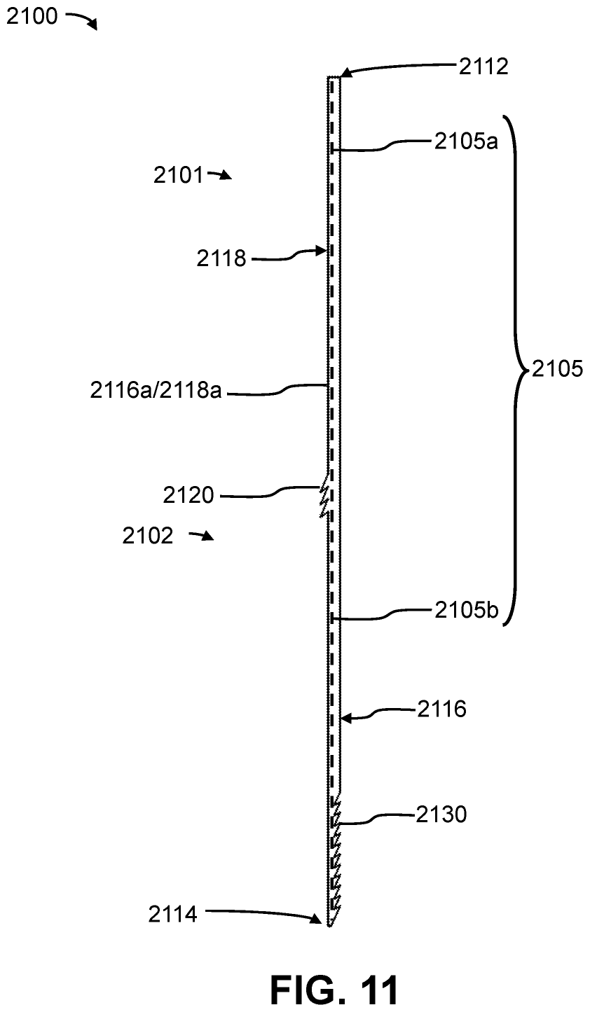

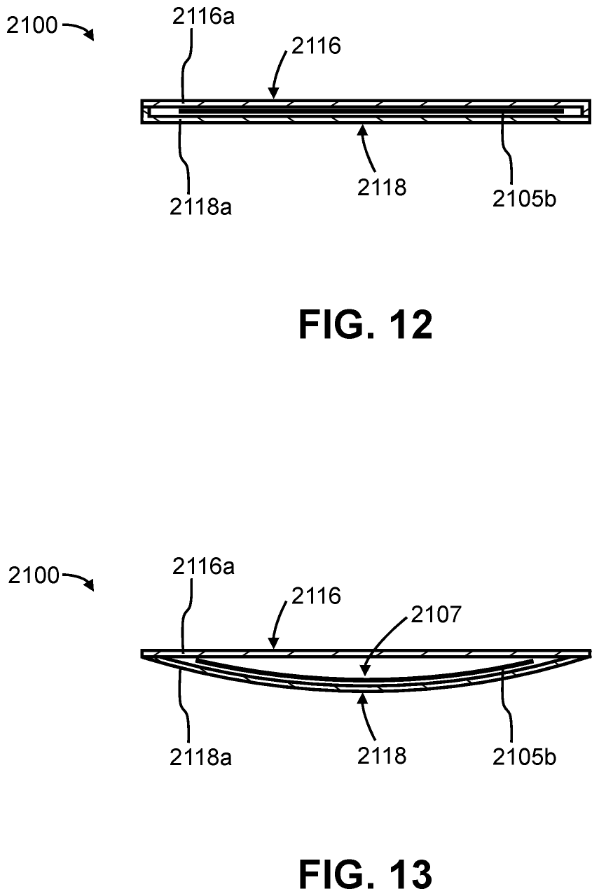

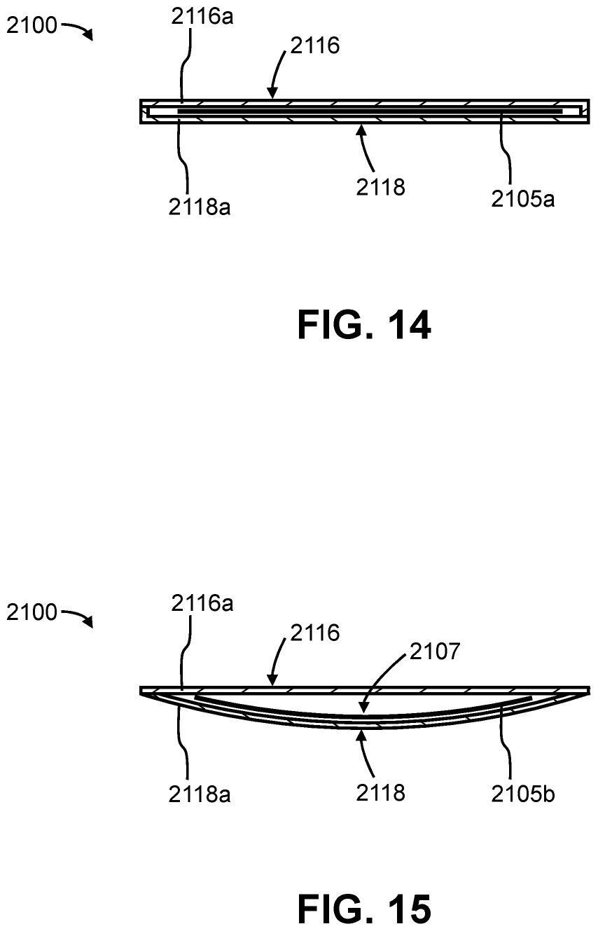

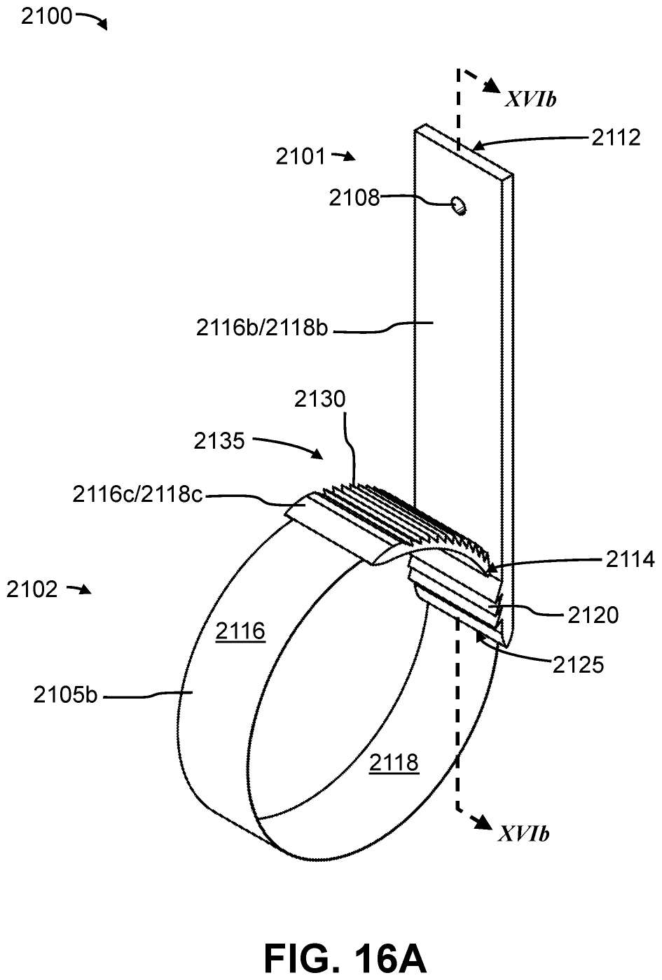

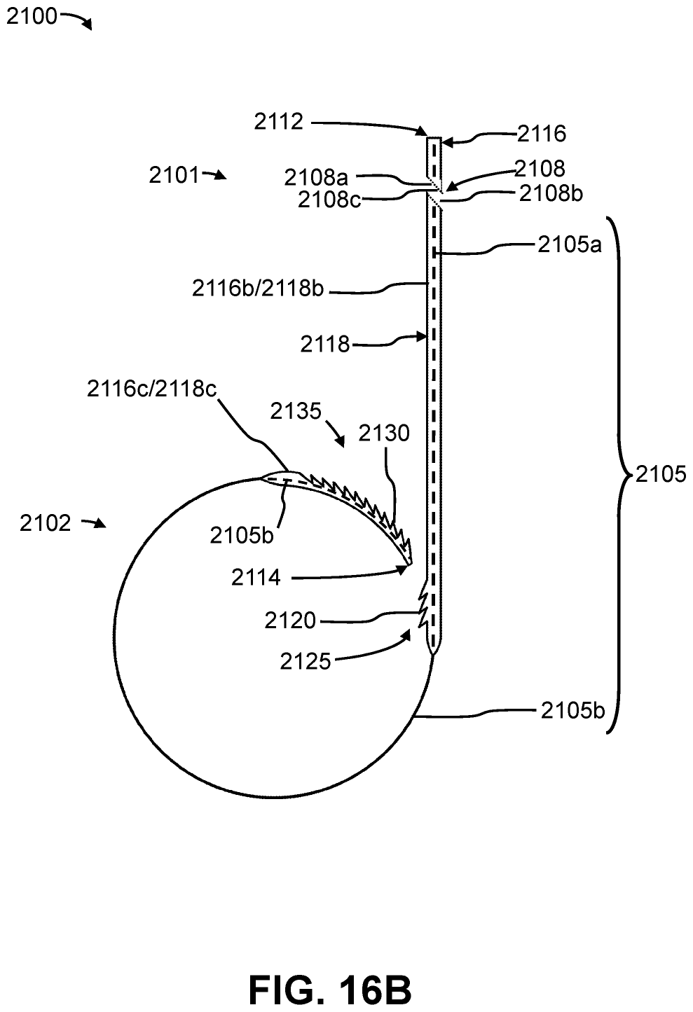

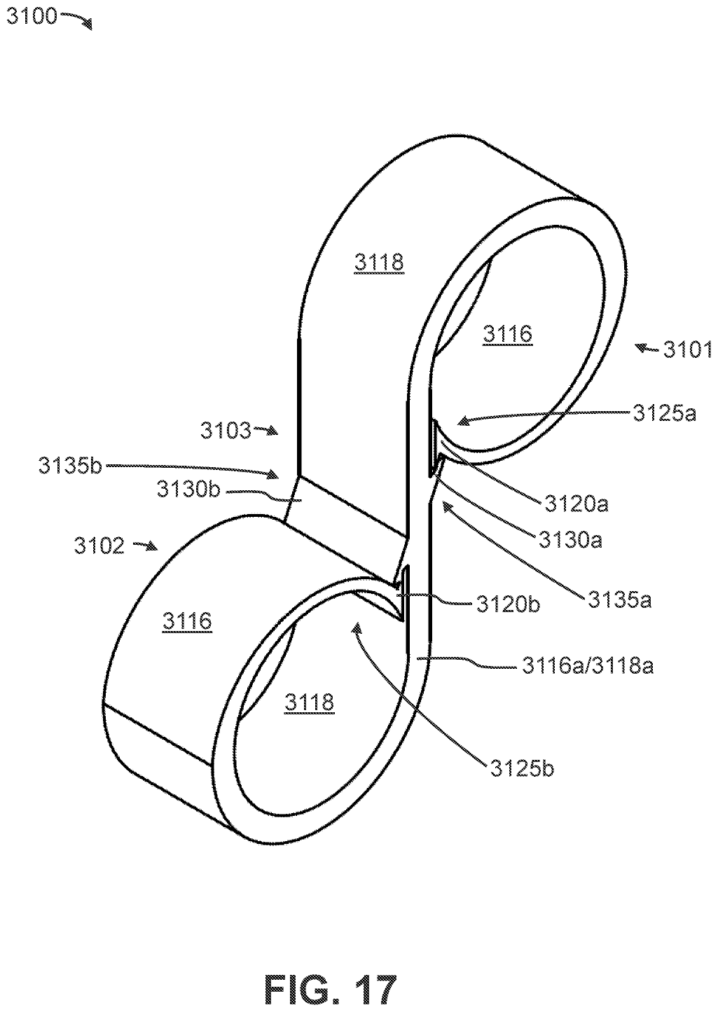

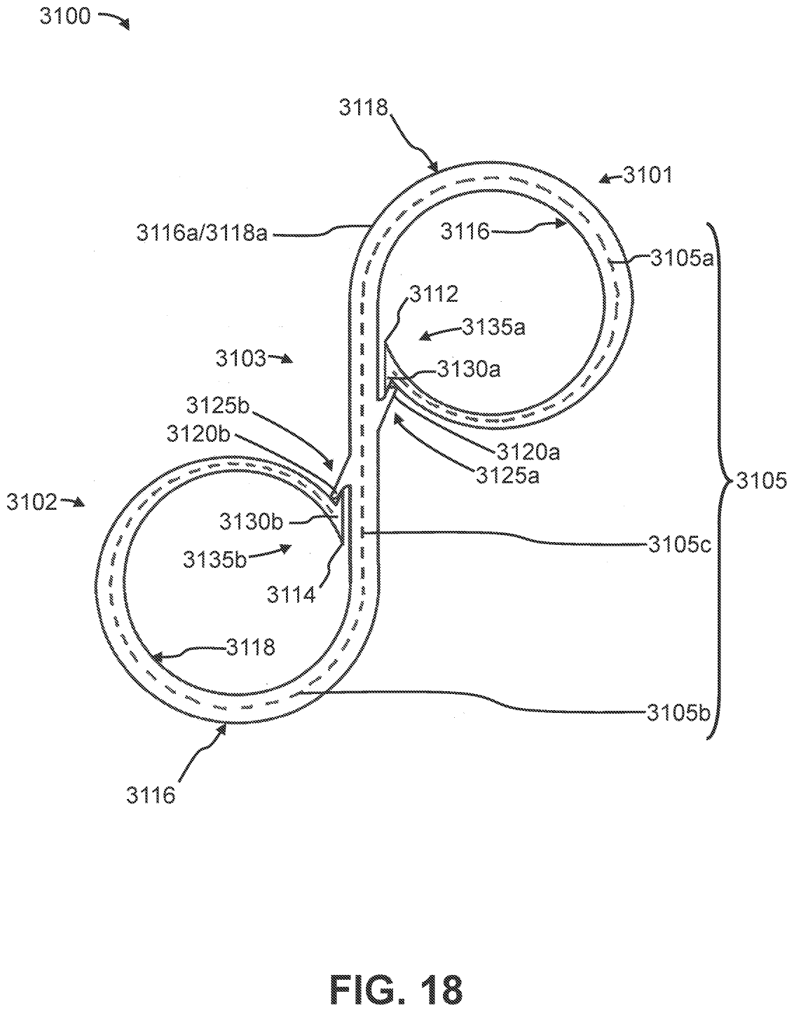

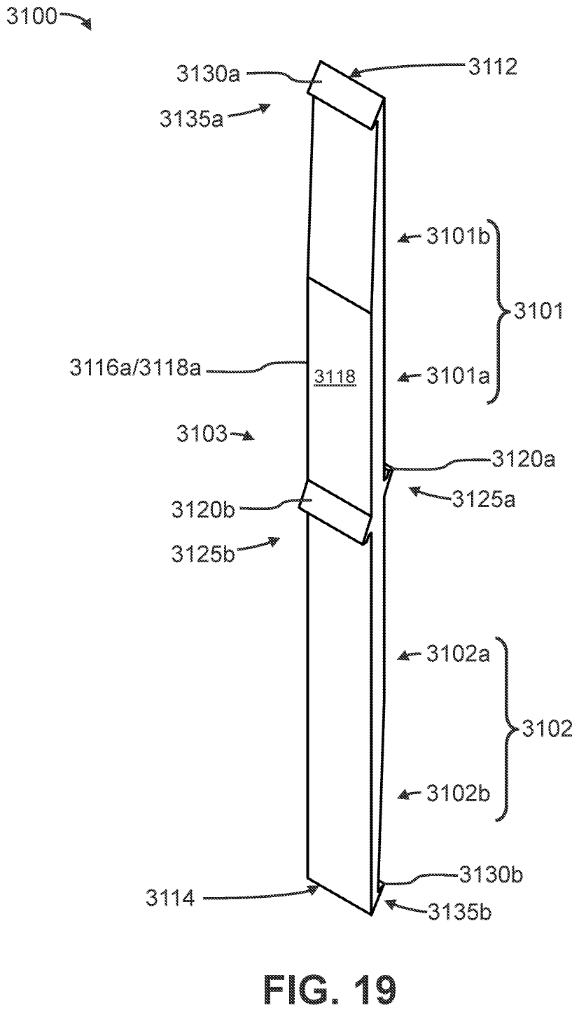

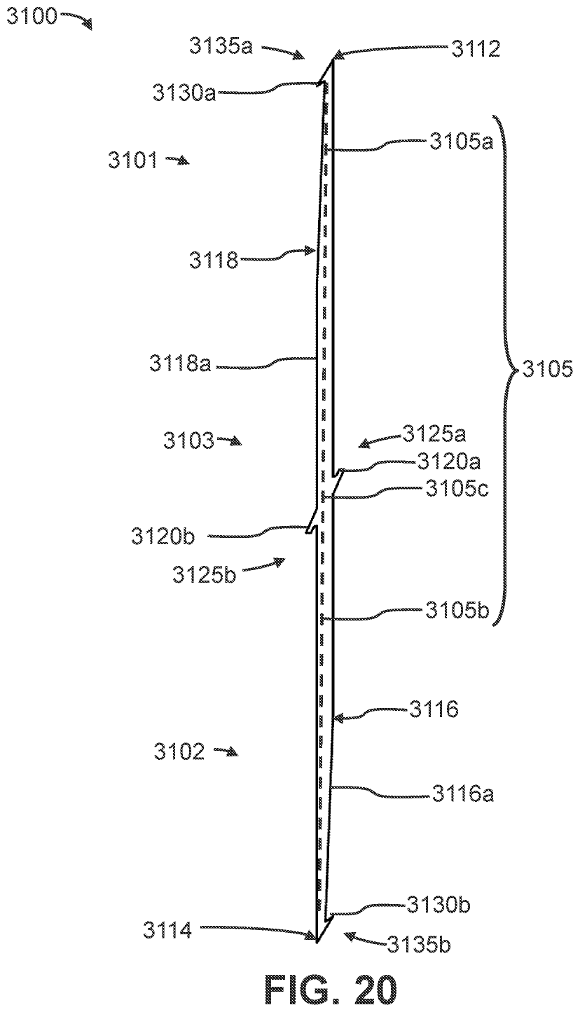

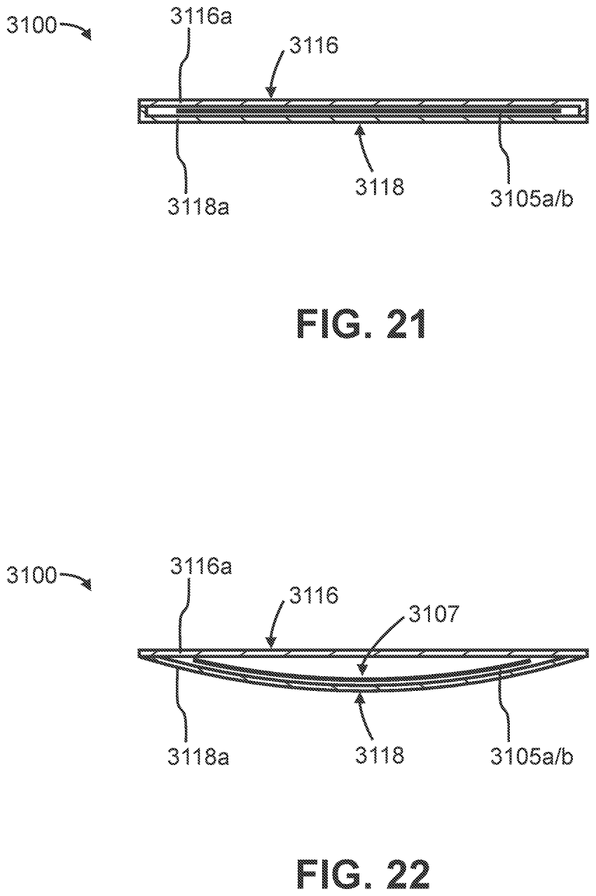

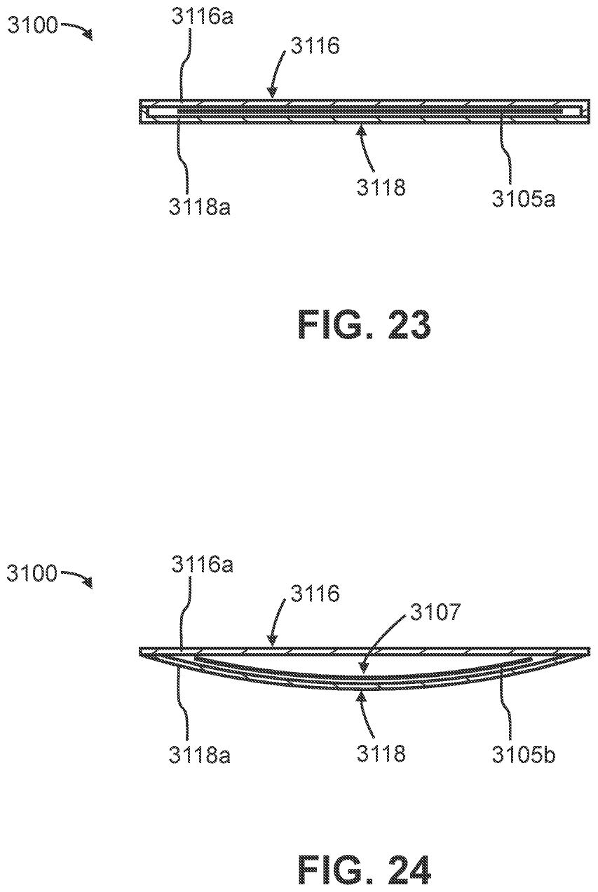

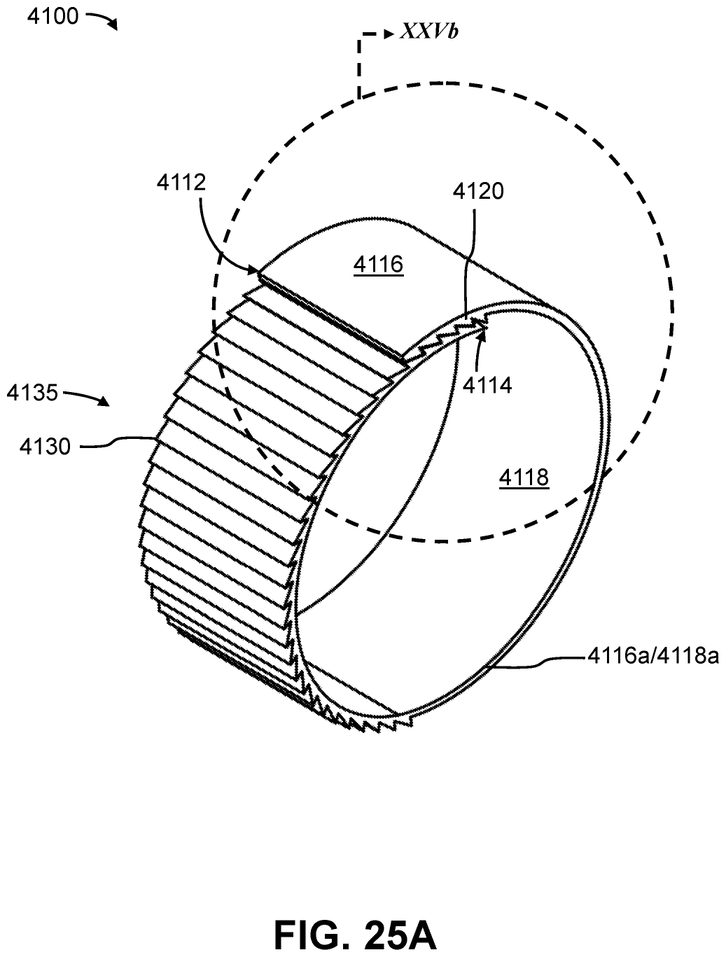

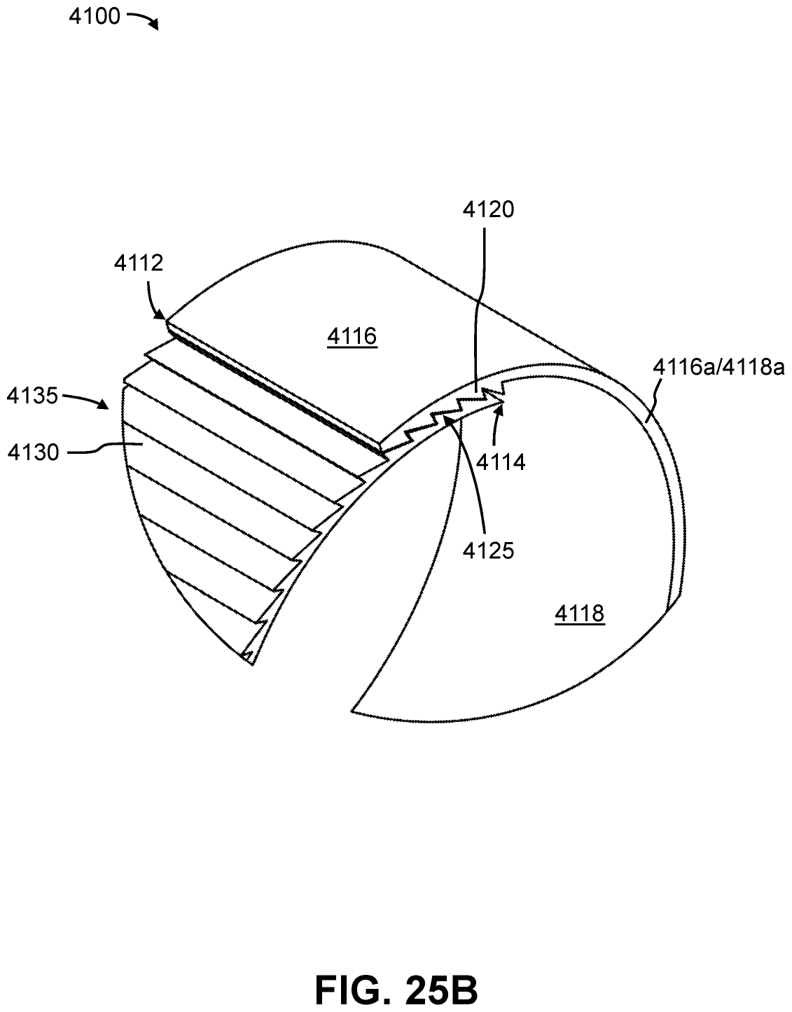

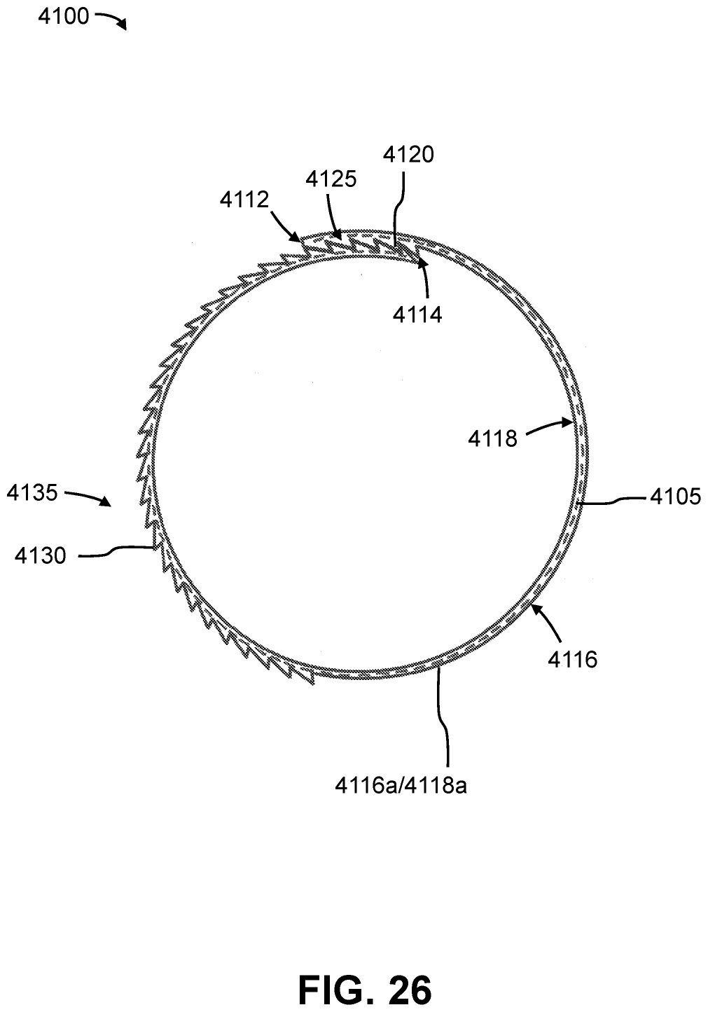

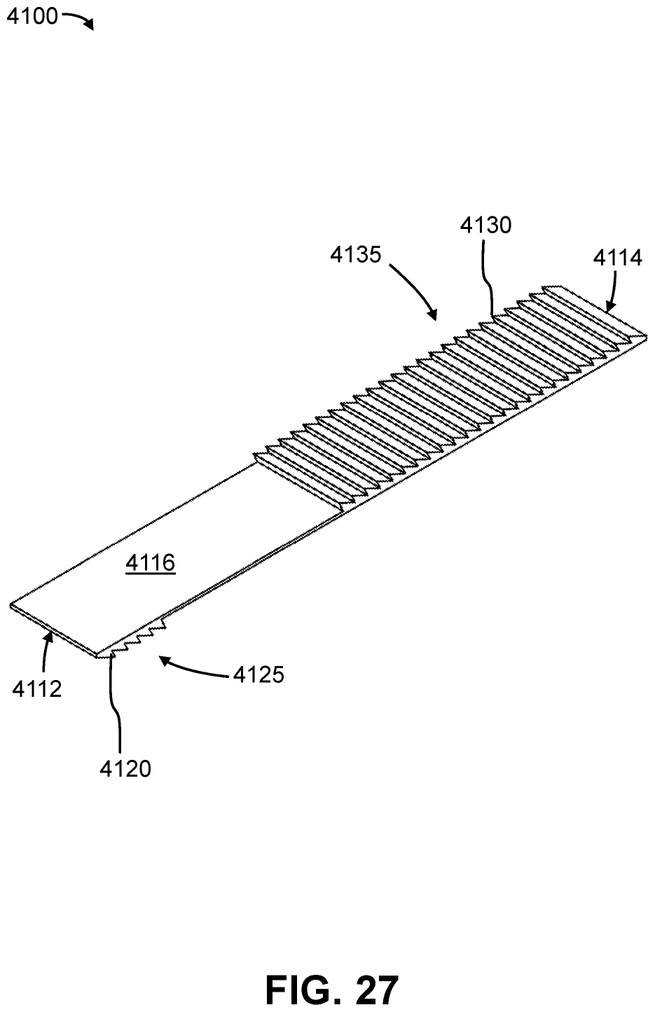

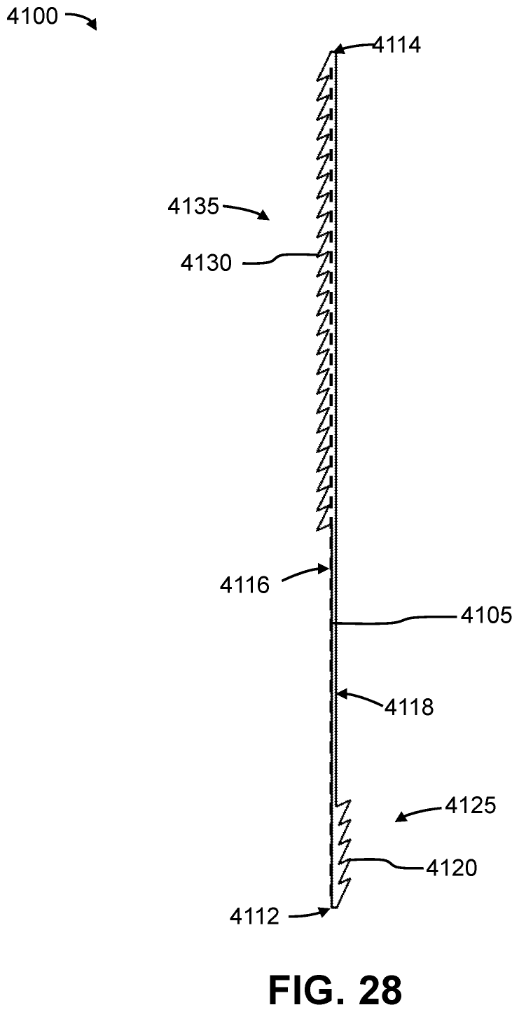

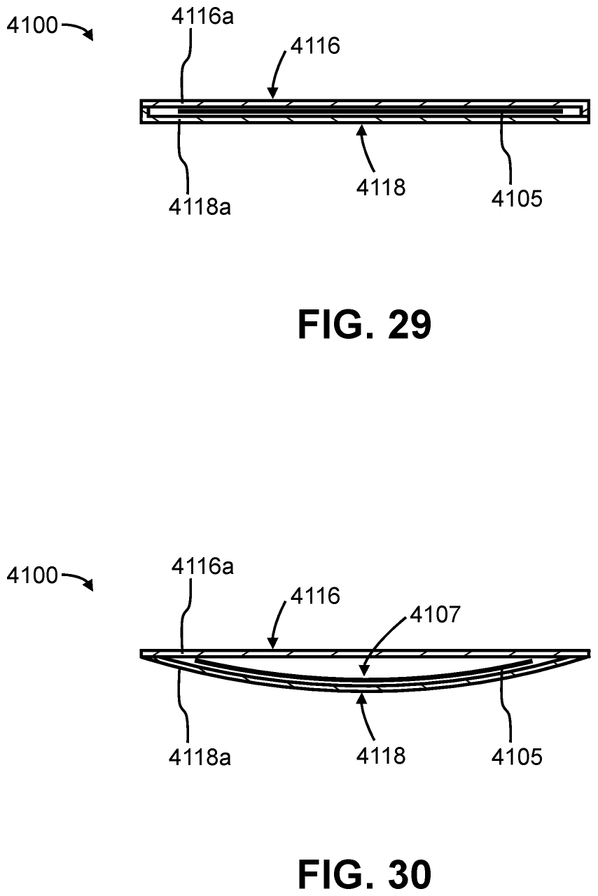

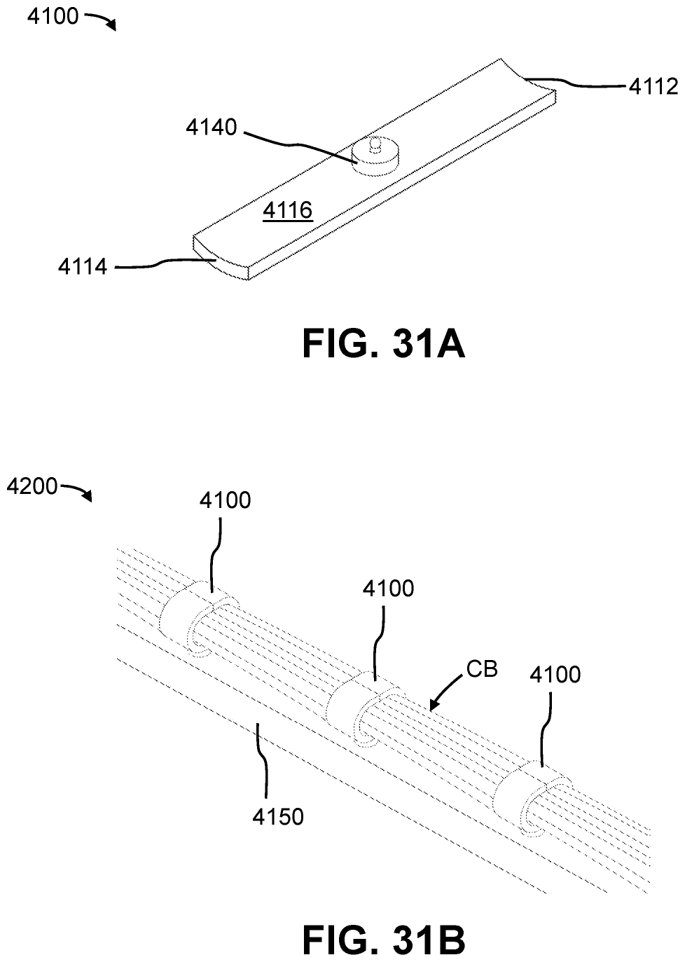

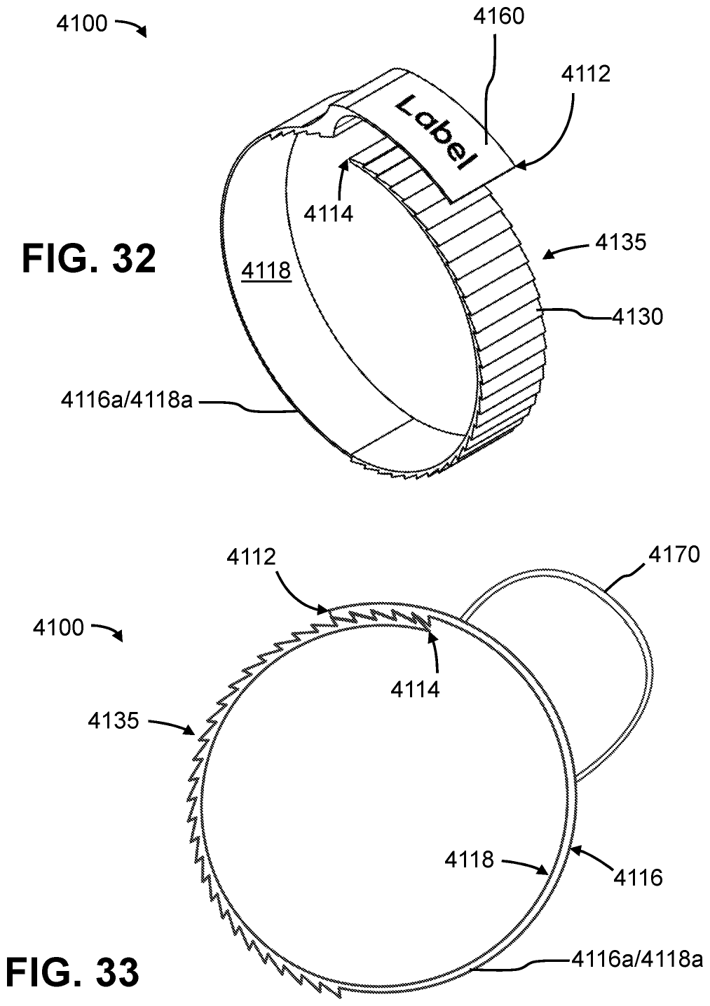

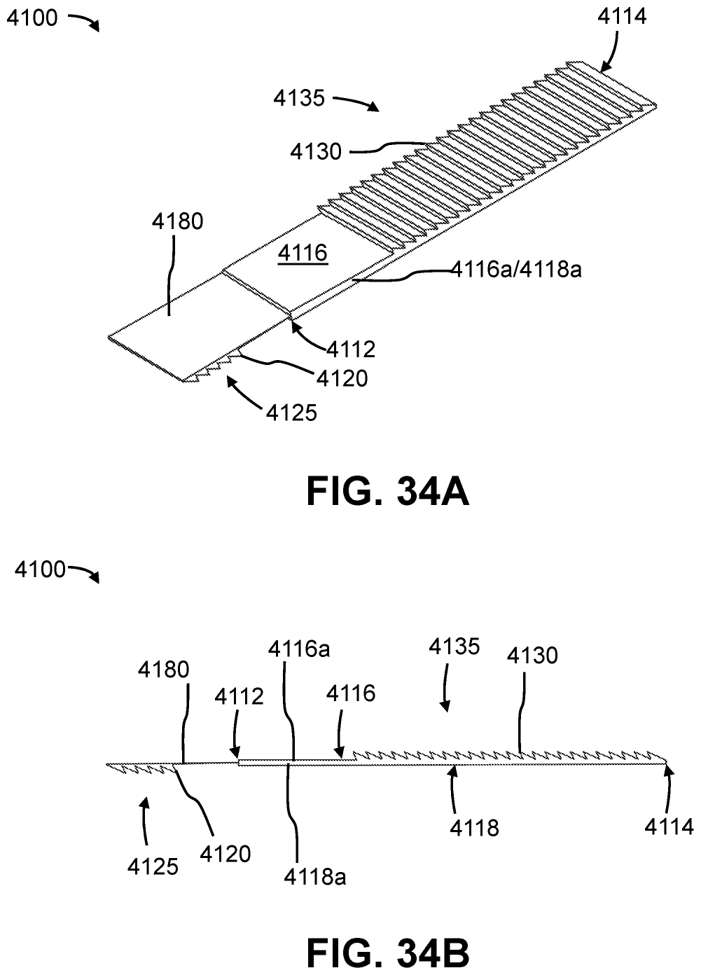

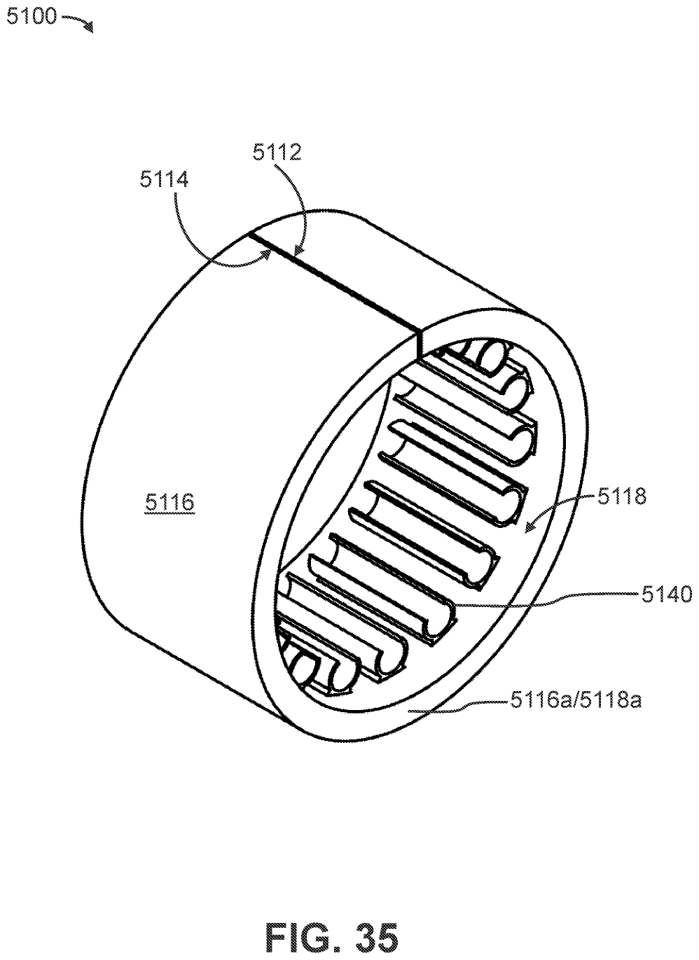

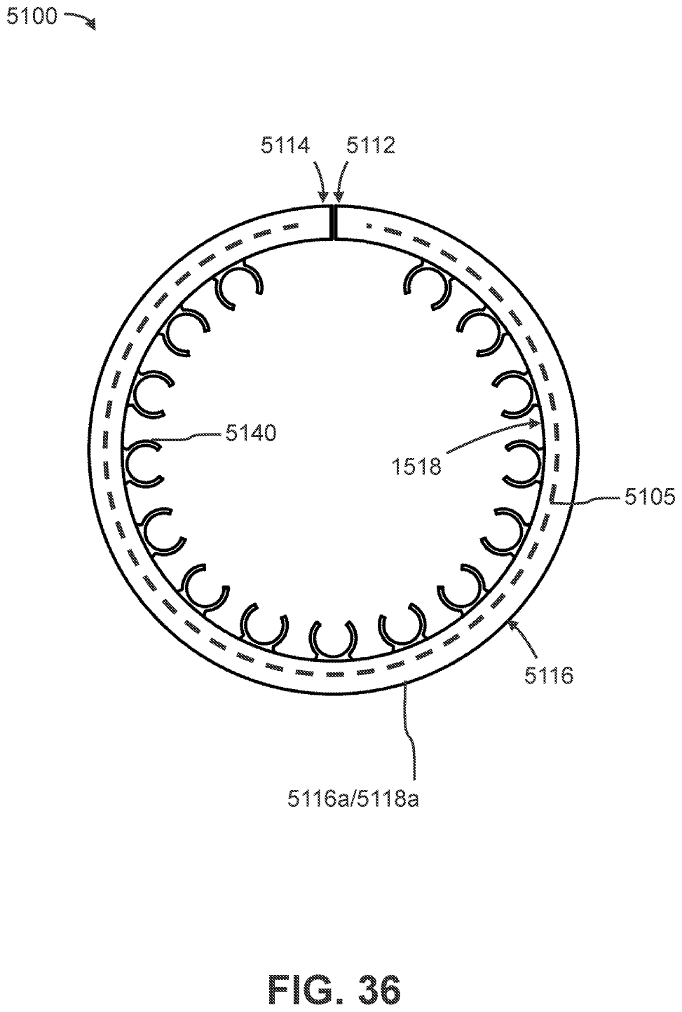

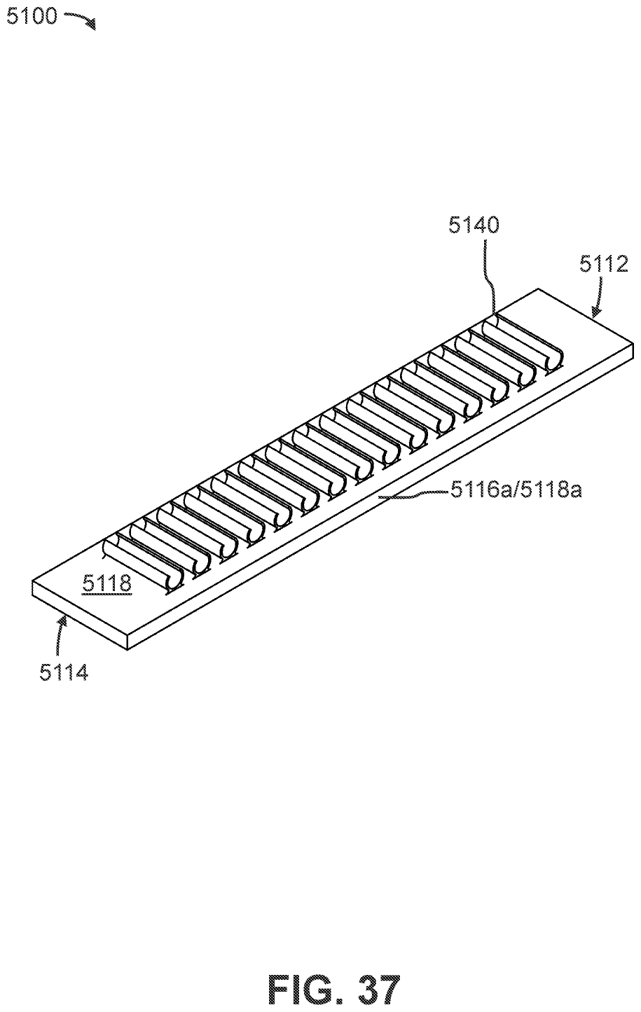

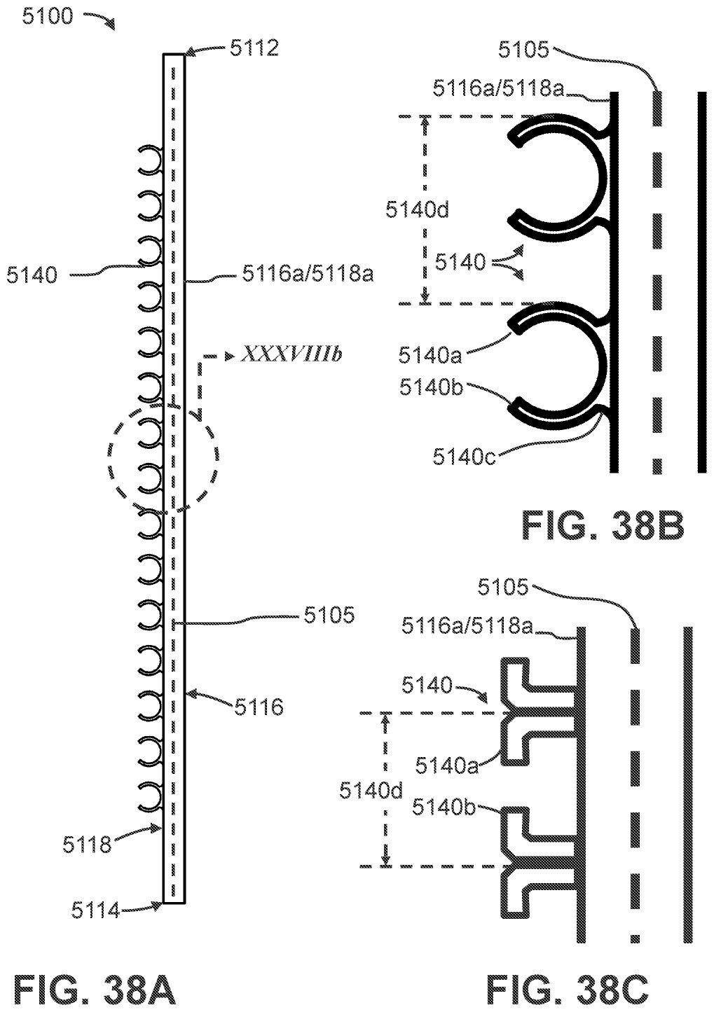

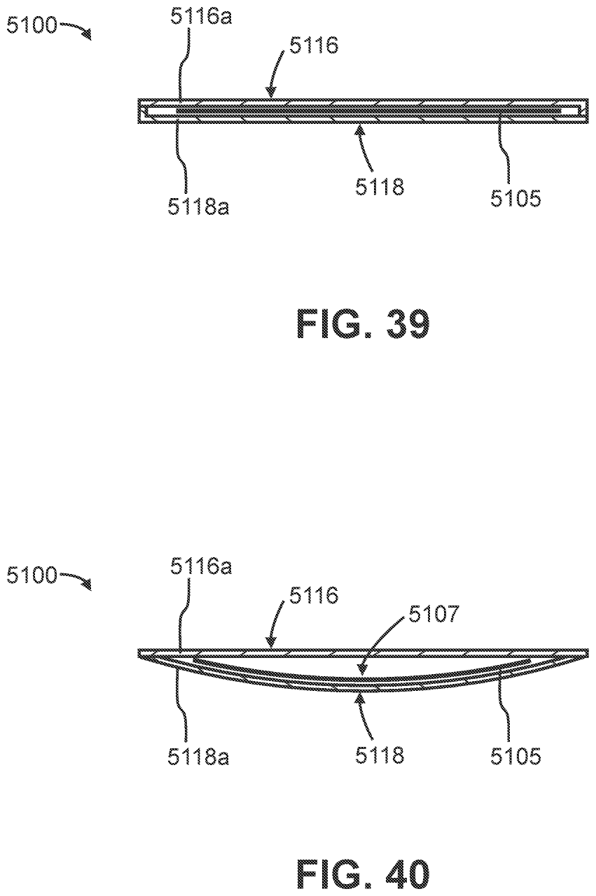

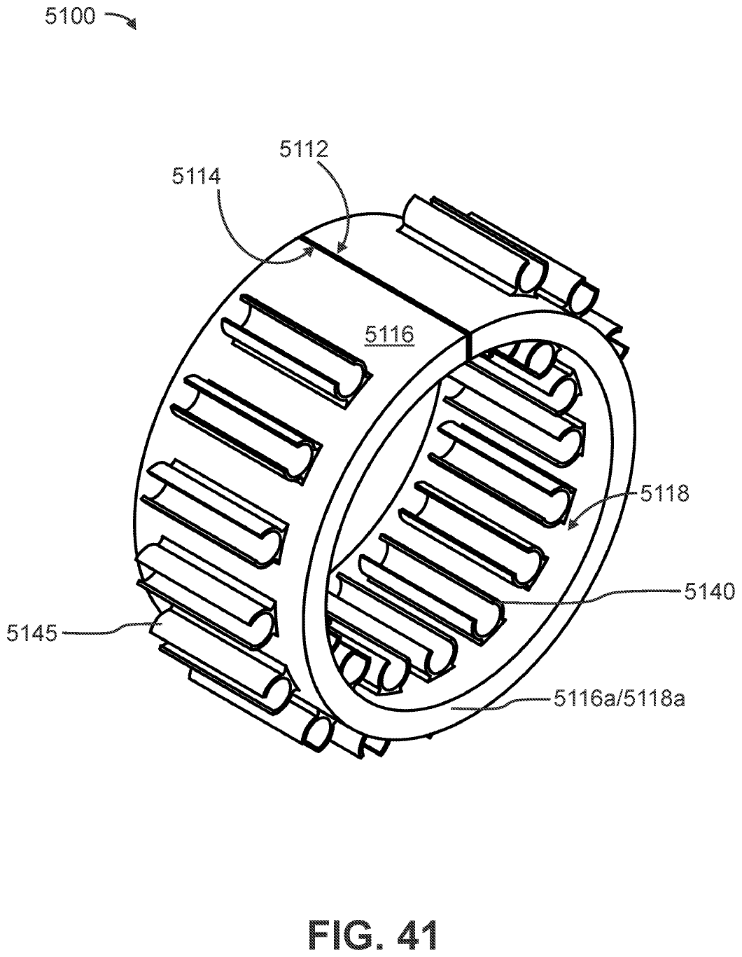

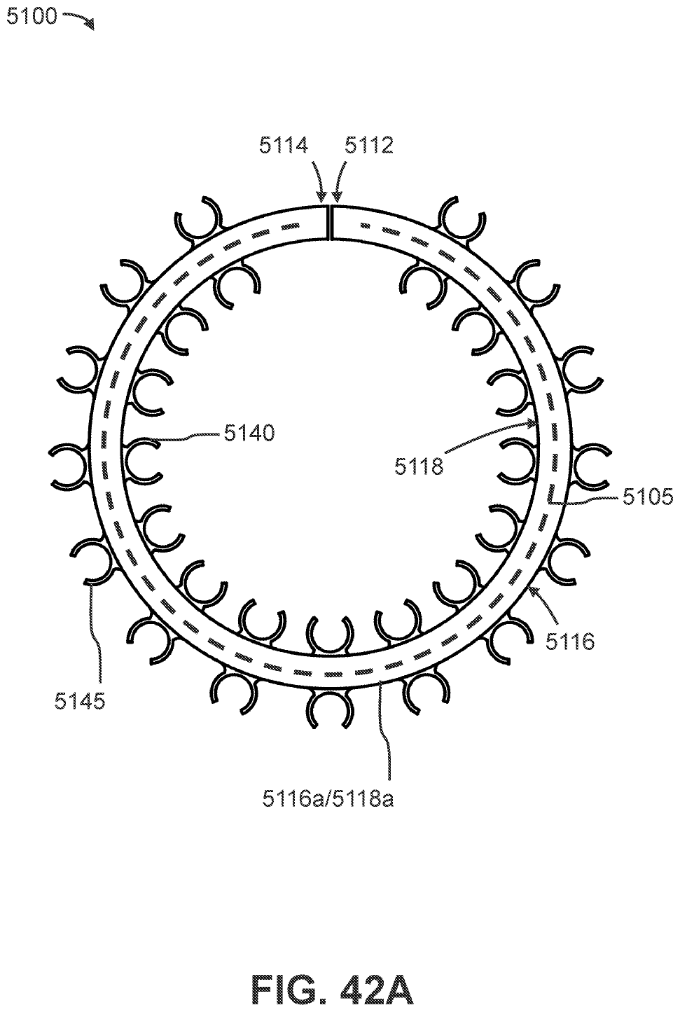

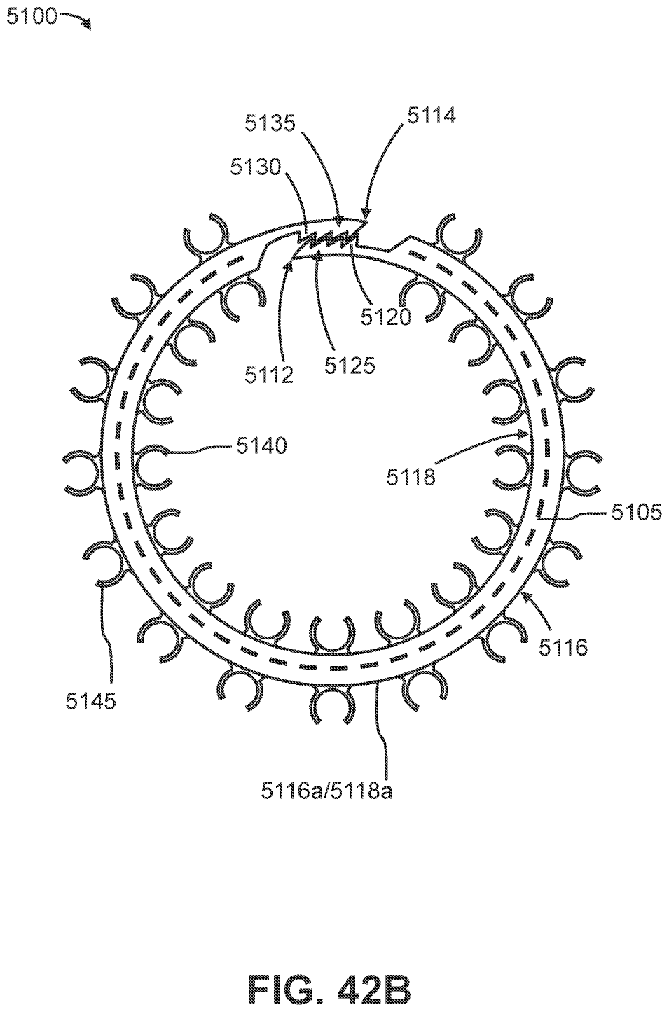

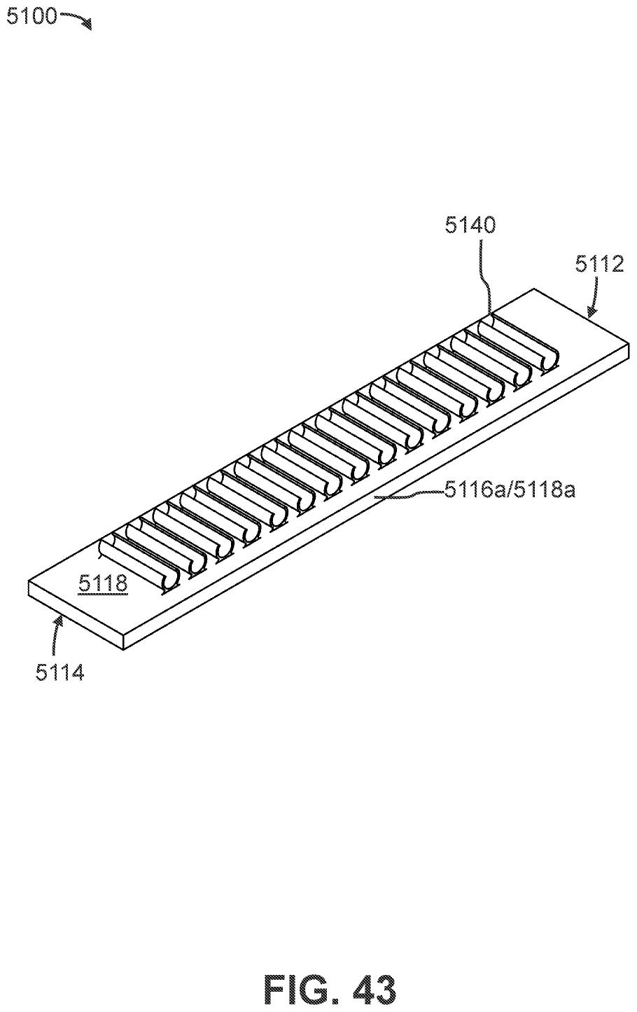

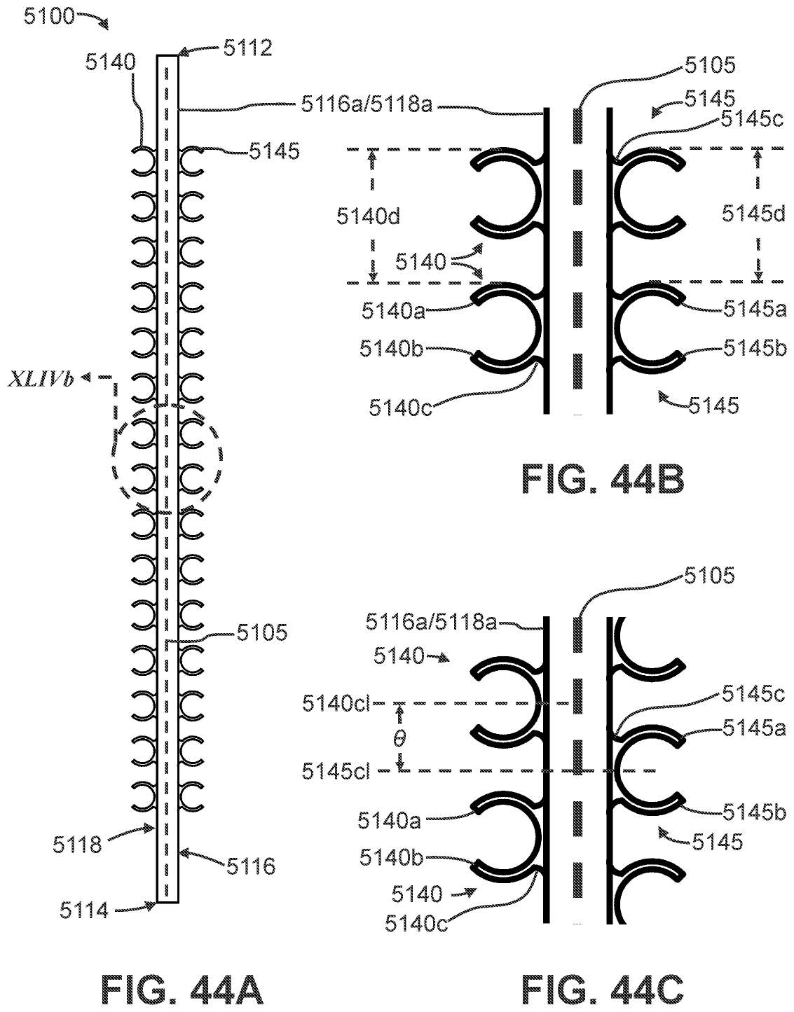

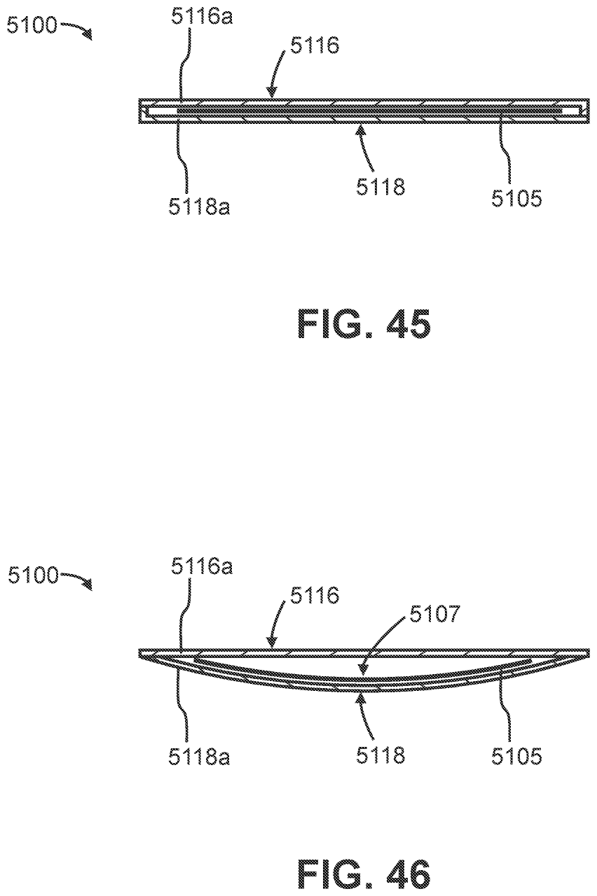

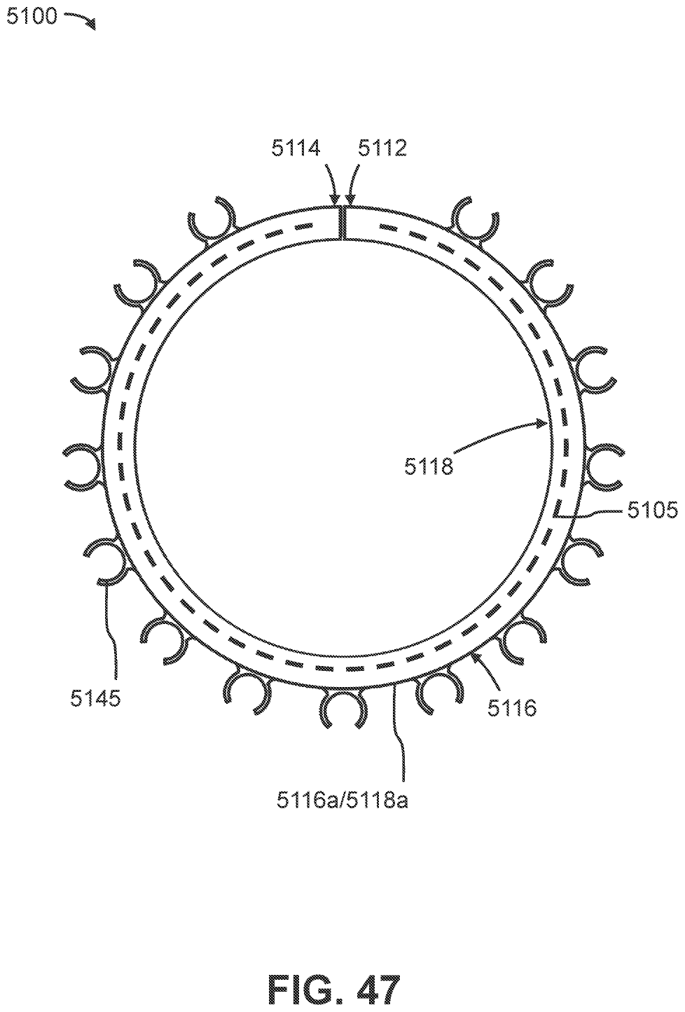

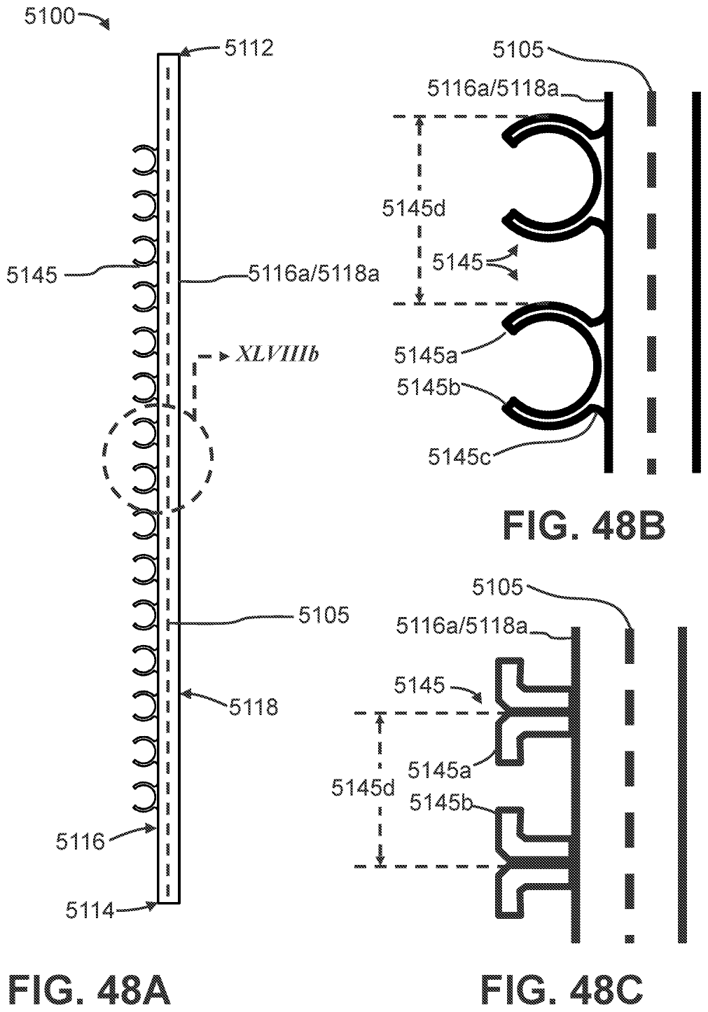

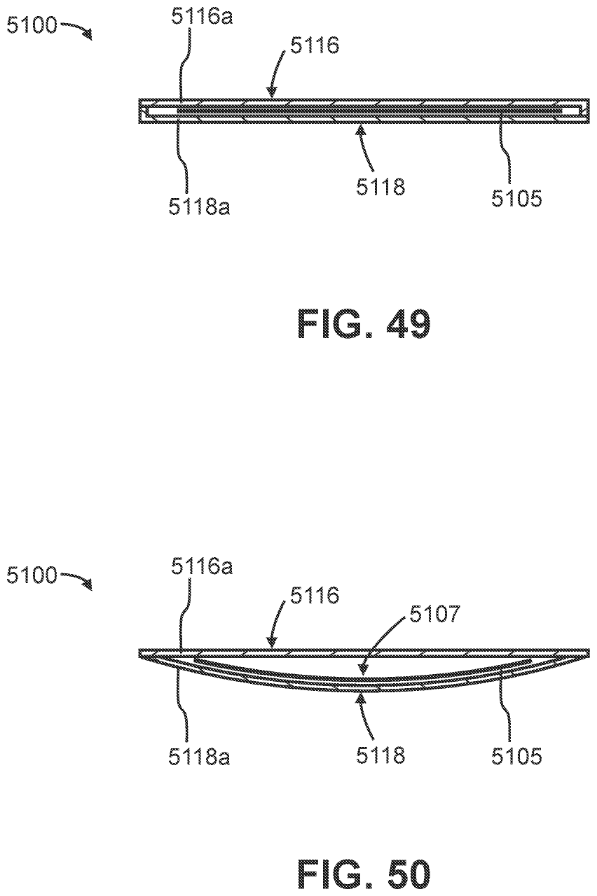

FIG. 10 shows a perspective view of the fastener of FIG. 8 wherein the multi-modal portion 2102 is in an open resting configuration.

FIG. 11 shows a side view of the fastener of FIG. 8 in an open resting configuration.

FIG. 12 shows a longitudinal cross-sectional view of a multi-modal portion of the fastener of FIG. 8 in a closed resting configuration.

FIG. 13 shows a longitudinal cross-sectional view of the multi-modal portion of the fastener of FIG. 8 in an open resting configuration.

FIG. 14 shows a longitudinal cross-sectional view of a unimodal portion of the fastener of FIG. 8 in one embodiment.

FIG. 15 shows a longitudinal cross-sectional view of a unimodal portion of the fastener of FIG. 8 in another embodiment.

FIG. 16A shows a perspective view of a fastener in a closed resting configuration according to another embodiment of the present disclosure.

FIG. 16B shows a side cross-sectional view of the fastener of FIG. 16A wherein the multi-modal portion 2102 is in a closed resting configuration.

FIG. 17 shows a perspective view of a fastener in a closed resting configuration according to one embodiment of the present disclosure.

FIG. 18 shows a side cross-sectional view of the fastener of FIG. 17 wherein multi-modal portion 3101 and multi-modal portion 3102 are each in a closed resting configuration.

FIG. 19 shows a perspective view of the fastener of FIG. 17 wherein multi-modal portion 3101 and multi-modal portion 3102 are each in an open resting configuration.

FIG. 20 shows a side cross-sectional view of the fastener of FIG. 19.

FIG. 21 shows a longitudinal cross-sectional view of a multi-modal portion of the fastener of FIG. 17 in a closed resting configuration.

FIG. 22 shows a longitudinal cross-sectional view of the multi-modal portion of the fastener of FIG. 17 in an open resting configuration.

FIG. 23 shows a longitudinal cross-sectional view of a unimodal portion of the fastener of FIG. 17 in one embodiment.

FIG. 24 shows a longitudinal cross-sectional view of a unimodal portion of the fastener of FIG. 17 in another embodiment.

FIG. 25A shows a perspective view of a multi-modal fastener in a closed resting configuration according to one embodiment of the present disclosure.

FIG. 25B shows an expanded view of a portion of the multi-modal fastener shown in FIG. 25A.

FIG. 26 shows a side cross-sectional view of the multi-modal fastener of FIG. 25A in a closed resting configuration.

FIG. 27 shows a perspective view of the multi-modal fastener of FIG. 25A in an open resting configuration.

FIG. 28 shows a side view of the multi-modal fastener of FIG. 27.

FIG. 29 shows a longitudinal cross-sectional view of the multi-modal fastener of FIG. 25A in a closed resting configuration.

FIG. 30 shows a longitudinal cross-sectional view of the multi-modal fastener of FIG. 25A in an open resting configuration.

FIG. 31A shows a perspective view of a fastener including a fastener consistent with one embodiment of the present disclosure.

FIG. 31B shows a perspective view of a fastening system including several fasteners mated with a mount consistent with one embodiment of the present disclosure.

FIG. 32 shows a perspective view of a fastener including a writable surface consistent with one embodiment of the present disclosure.

FIG. 33 shows a side plan view of a fastener including a handle consistent with one embodiment of the present disclosure.

FIG. 34A shows a perspective view of a fastener including a mating tab consistent with one embodiment of the present disclosure.

FIG. 34B shows a side plan view of the fastener of FIG. 34A.

FIG. 35 shows a perspective view of a multi-modal fastener in a closed resting configuration according to one embodiment of the present disclosure.

FIG. 36 shows a side cross-sectional view of the multi-modal fastener of FIG. 35 in a closed resting configuration.

FIG. 37 shows a perspective view of the multi-modal fastener of FIG. 35 in an open resting configuration.

FIG. 38A shows a side view of the multi-modal fastener of FIG. 37.

FIG. 38B shows an enlarged side view of the multi-modal fastener of FIG. 38A.

FIG. 38C shows an enlarged side view of a multi-modal fastener including alternative cable grip features according to another embodiment of the present disclosure.

FIG. 39 shows a longitudinal cross-sectional view of the multi-modal fastener of FIG. 35 in a closed resting configuration.

FIG. 40 shows a longitudinal cross-sectional view of the multi-modal fastener of FIG. 35 in an open resting configuration.

FIG. 41 shows a perspective view of a multi-modal fastener in a closed resting configuration according to another embodiment of the present disclosure.

FIG. 42A shows a side cross-sectional view of the multi-modal fastener of FIG. 41 in a closed resting configuration.

FIG. 42B shows a side cross-sectional view of a multi-modal fastener including a securing portion and a mating portion according to another embodiment of the present disclosure.

FIG. 43 shows a perspective view of the multi-modal fastener of FIG. 41 in an open resting configuration.

FIG. 44A shows a side view of the multi-modal fastener of FIG. 43.

FIG. 44B shows an enlarged side view of the multi-modal fastener of FIG. 44A.

FIG. 44C shows an enlarged side view of a multi-modal fastener including alternative cable grip features according to another embodiment of the present disclosure.

FIG. 45 shows a longitudinal cross-sectional view of the multi-modal fastener of FIG. 41 in a closed resting configuration.

FIG. 46 shows a longitudinal cross-sectional view of the multi-modal fastener of FIG. 41 in an open resting configuration.

FIG. 47 shows a cross-sectional view of a multi-modal fastener including external cable grip features according to another embodiment of the present disclosure.

FIG. 48A shows a side view of the multi-modal fastener of FIG. 47.

FIG. 48B shows an enlarged side view of the multi-modal fastener of FIG. 48A.

FIG. 48C shows an enlarged side view of a multi-modal fastener including alternative cable grip features according to another embodiment of the present disclosure.

FIG. 49 shows a longitudinal cross-sectional view of the multi-modal fastener of FIG. 47 in a closed resting configuration.

FIG. 50 shows a longitudinal cross-sectional view of the multi-modal fastener of FIG. 47 in an open resting configuration.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

### Definitions Applicable to All Disclosed Embodiments

Unless otherwise required by the specific context, the terms “bi-stable” and “multi-stable” generally refer to materials that adopt a first resting configuration, and remain substantially stable in that first resting configuration until a significant force is applied to the material to induce the material to adopt a second resting configuration, and wherein the material remains substantially stable in that second resting configuration until another significant force is applied to induce the material to adopt a third resting configuration (in the case of a multi-stable length of material) or return to the first resting configuration (in the case of a bi-stable length of material).

Unless otherwise required by the specific context, the term “multi-modal” generally refers to materials that adopt at least two resting configurations having different physical shapes.

Unless otherwise required by the specific context, the term “bi-modal” generally refers to materials that adopt a first resting configuration, and remain substantially stable in that first resting configuration until a significant force is applied to the material to induce the material to adopt a second resting configuration that is different than the first resting configuration, and remain substantially stable in that second resting configuration until a significant force is applied to the material to induce that material to return to the first resting configuration.

Unless otherwise required by the specific context, the term “tri-modal” generally refers to materials that adopt a first resting configuration, and remain substantially stable in that first resting configuration until a significant force is applied to the material to induce the material to adopt a second resting configuration that is different than the first resting configuration, and remain substantially stable in that second resting configuration until a significant force is applied to the material to induce the material to adopt a third resting configuration that is different than the first resting configuration or the second resting configuration or to return to the first resting configuration; and remain substantially stable in that third resting configuration until a significant force is applied to the material to induce the material to return to the first resting configuration or to the second resting configuration.

Unless otherwise required by the specific context, the term “unimodal” generally refers to materials that adopt a single resting configuration and substantially resist adopting a second stable configuration even upon application of a significant force that would be sufficient to induce a multi-modal material of similar composition, size, and shape to adopt a second stable resting configuration.

Unless otherwise required by the specific context, the term “open configuration” generally refers to a stable configuration of a device disclosed herein wherein the complementary mating portions of the device are not in proximity to each other.

Unless otherwise required by the specific context, the term “closed configuration” generally refers to a stable configuration of a device disclosed herein wherein the complementary mating portions are in close proximity but not in contact with each other or wherein the complementary mating portions are in contact with each other.

“Back-to-Back” Multi-Modal Fasteners

Referring generally to FIGS. 1A-7, the present disclosure provides fasteners and fastener systems, and methods of using same.

Generally, fasteners of the present disclosure can be selectively converted from a first, generally planar configuration, to a second, generally loop-shaped configuration. Fastener systems of the present disclosure generally include one or more than one such fastener.

### Systems

Referring now specifically to FIGS. 1A-2B, a fastener system 10 consistent with the present disclosure comprises a first loop-shaped fastener 1100 removably associated (e.g., temporarily attached) to a second device 1200. The first loop-shaped fastener 1100 comprises a length of material 1110 including a first face 1116, a first end 1112, a second end 114 opposite the first end 1112, and a second face 1118 opposite the first face 1116. A fastener 1120 is associated with the first face 1116 and enables the first loop-shaped fastener 1100 to be removably associated with the second device 1200. In some embodiments, the fastener 1120 is a snap. In other embodiments, the fastener 1120 is a magnet. In some embodiments, the fastener 1120 is an adhesive.

In some embodiments, the fastener 1120 is disposed generally equidistant between the first end 1112 and the second end 1114. In other embodiments, the fastener 1120 is disposed closer to the first end 1112 than the second end 1114. In still other embodiments, the fastener 1120 is disposed closer to the second end 1114 than the first end 1112.

As shown in FIGS. 1A and 1B, the fastener in some embodiments enables the first loop-shaped fastener 1100 to be rotatably associated with the second device 1200.

The length of material 1110 comprises a bi-stable or a multi-stable length of material that is movable between at least a first resting configuration and a second resting configuration.

For example, as shown in FIGS. 3A-3B, the length of material 1110 may adopt a first resting configuration that is generally flat or planar. In the first resting configuration, the first end 1112 and the second end 1114 are separated by a substantially maximum distance. Upon activation by a user, the length of material 1110 may then adopt a second resting configuration that is generally curved, as shown in FIGS. 1A-2B. In the second resting configuration, the first end 1112 and the second end 1114 are separated by a substantially smaller distance. The length of material 1110 is a generally thin, elongated component. In some embodiments, the length of material 1110 comprises, consists essentially of, or consists of a material such as spring steel that is formed into an elongated shape including a bend or cavity 1110d (illustrated in FIG. 10) in a middle portion thereof. The bend or cavity 1110d may extend a portion (or all) of the length of material 1110. In some embodiments, the length of material 1110 comprises metal that is heat treated. The length of material 1110 may feature any suitable dimensions such as, for example, a longitudinal length of about 2 inches to about 48 inches by a width of about 0.25 inches to about 12 inches, and a thickness ranging from about 0.05 inches to about 0.5 inches.

In some embodiments, the first end 1112 and the second end 1114 contact each other when the length of material 1110 adopts the second resting configuration; in such embodiments, the first end 1112 and the second end 1114 may overlap each other or may abut each other when the length of material 1110 adopts the second resting configuration. In other embodiments, such as those shown in FIGS. 1A-2B, a gap 1130 separates the first end 1112 and the second end 1114 when the length of material 1110 adopts the second resting configuration. In other embodiments, such as that shown in FIGS. 1E-1F, the first end 1112 and the second end 1114 overlap 1132 when the length of material 1110 adopts the second resting configuration. In some embodiments, the length of material 1110 is configured to adopt a third resting configuration, for example wherein one portion of the length of material 1110 may adopt a generally curved resting configuration while another portion of the length of material 1110 may adopt a generally planar or flat resting configuration.

In some embodiments, the length of material 1110 adopts a second resting configuration that includes two curved portions at or near the first end 1112 and at or near the second end 1114, separated by a portion 1115 that is generally planar.

In some embodiments, such as the embodiment shown specifically in FIG. 10, the length of material 1110 may comprise a multi-stable strip of material 1110a disposed between a first cover 1110b that includes the first face 1116 and a second cover 1110c that includes the second face 1118. The first cover 1110b and the second cover 1110c may comprise, consist essentially of, or consist of any suitable relatively flexible material including, for example and without limitation, a polymer, fabric, metal, or a combination thereof. The multi-stable strip of material 1110a may comprise, consist essentially of, or consist of a metal (e.g., steel, stainless steel, etc.), polymer, fiber, carbon fiber, or a combination thereof. In other embodiments, the length of material 1110 comprises a multi-stable strip of material 1110a that is coated, covered, painted, extruded, dipped, or molded to provide a first face 1116 on one surface of the multi-stable strip of material 1110a and a second face 1118 on a second, opposite surface of the multi-stable strip of material 1110a. In some embodiments, the first cover 1110b comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the second cover 1110c comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover 1110b and the second cover 1110c each comprise a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover 1110b is connected to the second cover 1110c through one or more holes (not shown) in the multi-stable strip of material 1110a, for example to reduce or eliminate slippage of the cover 1110b/1110c over the multi-stable strip of material 1110a.

The curved shape of the second resting configuration may be any shape that places the first end 1112 and the second end 1114 in close proximity. For example and without limitation, the curved shape may include a cross-sectional profile that is a circle, an oval, a triangle, a rectangle, a D-shape, a discorectangle, a pear shape, or an asymmetrical version of any of the foregoing.

In some embodiments, the length of material 1110 includes a spring steel component that has a generally arcuate cross-sectional shape, when viewed along its longitudinal direction (e.g., from first end 1112 towards second end 1114), when the length of material 1110 adopts its first, generally flat or planar resting configuration. Upon activation by a user, the length of material 1110 adopts the second generally curved resting configuration, in which the spring steel component has a generally flat cross-sectional shape, when viewed along the same longitudinal direction.

The second device 1200 includes a second fastener 1220 that removably mates with the fastener 1120 of the first loop-shaped fastener 1100.

The second device 1200 may be any physical structure that includes the second fastener 1220. In some embodiments, the first fastener 1120 and the second fastener 1220 mate in a manner that enables the first loop-shaped fastener 1100 to be rotated relative to the second device 1200. In some embodiments, the first fastener 1120 and the second fastener 1220 are snaps; in such embodiments one of the fasteners (e.g., first fastener 1120) includes a stud 1125 that mates with a cavity 1225 of the other fastener (e.g., second fastener 1220).

In some embodiments, the second device 1200 is a second loop-shaped fastener 1200. In such embodiments, the second loop-shaped fastener 1200 may include a second length of material 1210 including a first face 1216, a first end 1212, a second end 1214 opposite the first end 1212, and a second face 1218 opposite the first face 1216; and a fastener 1220 associated with the first face 1216. In some embodiments, the fastener 1220 is disposed generally equidistant between the first end 1212 and the second end 1214. In other embodiments, the fastener 1220 is disposed closer to the first end 1212 than the second end 1214. In still other embodiments, the fastener 1220 is disposed closer to the second end 1214 than the first end 1212. In some embodiments, the fastener 1220 is a snap. In other embodiments, the fastener 1220 is a magnet. In some embodiments, the fastener 1220 is an adhesive.

The length of material 1210 comprises a bi-stable or a multi-stable length of material that is movable between at least a first resting configuration and a second resting configuration. For example, as shown in FIGS. 3A-3B, the length of material 1210 may adopt a first resting configuration that is generally flat or planar. In the first resting configuration, the first end 1212 and the second end 1214 are separated by a substantially maximum distance. Upon activation by a user, the second length of material 1210 may then adopt a second resting configuration that is generally curved, as shown in FIGS. 1A-2B. In the second resting configuration, the first end 1212 and the second end 1214 are separated by a substantially smaller distance.

The length of material 1210 is a generally thin, elongated component. In some embodiments, the length of material 1210 comprises, consists essentially of, or consists of a material such as spring steel that is formed into an elongated shape including a bend or cavity 1210d (illustrated in FIG. 1D) in a middle portion thereof. The bend or cavity 1210d may extend a portion (or all) of the length of material 1210. In some embodiments, the length of material 1210 comprises metal that is heat treated. The length of material 1210 may feature any suitable dimensions such as, for example, a longitudinal length of about 2 inches to about 48 inches by a width of about 0.25 inches to about 12 inches, and a thickness ranging from about 0.05 inches to about 0.5 inches.

In some embodiments, the first end 1212 and the second end 1214 contact each other when the length of material 1210 adopts the second resting configuration; in such embodiments, the first end 1112 and the second end 1114 may overlap each other or may abut each other when the length of material 1110 adopts the second resting configuration. In other embodiments, such as those shown in FIGS. 1A-2B, a gap 1230 separates the first end 1212 and the second end 1214 when the second length of material 1210 adopts the second resting configuration. In other embodiments, such as that shown in FIGS. 1E-1F, the first end 1212 and the second end 1214 overlap 1232 when the length of material 1210 adopts the second resting configuration. In some embodiments, the length of material 1210 is configured to adopt a third resting configuration, for example wherein one portion of the length of material 1210 may adopt a generally curved resting configuration while another portion of the length of material 1210 may adopt a generally planar or flat resting configuration.

In some embodiments, the length of material 1210 adopts a second resting configuration that includes two curved portions at or near the first end 1212 and at or near the second end 1214, separated by a portion 1215 that is generally planar.

In some embodiments, such as the embodiment shown specifically in FIG. 1D, the length of material 1210 may comprise a multi-stable strip of material 1210a disposed between a first cover 1210b that includes the first face 1216 and a second cover 1210c that includes the second face 1218. The first cover 1210b and the second cover 1210c may comprise, consist essentially of, or consist of any suitable relatively flexible material including, for example and without limitation, a polymer, fabric, metal, or a combination thereof. The multi-stable strip of material 1210a may comprise, consist essentially of, or consist of a metal (e.g., steel, stainless steel, etc.) or carbon-fiber. In other embodiments, the length of material 1210 comprises a multi-stable strip of material 1210a that is coated, covered, painted, extruded, dipped, or molded to provide a first face 1216 on one surface of the multi-stable strip of material 1210a and a second face 1218 on a second, opposite surface of the multi-stable strip of material 1210a. In some embodiments, the first cover 1210b comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the second cover 1210c comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover 1210b and the second cover 1210c each comprise a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover 1210b is connected to the second cover 1210c through one or more holes (not shown) in the multi-stable strip of material 1210a, for example to reduce or eliminate slippage of the cover 1210b/1210c over the multi-stable strip of material 1210a.

The curved shape of the second resting configuration may be any shape that places the first end 1212 and the second end 1214 in close proximity. For example and without limitation, the curved shape may include a cross-sectional profile that is a circle, an oval, a triangle, a rectangle, a D-shape, a discorectangle, a pear shape, or an asymmetrical version of any of the foregoing.

In some embodiments, the length of material 1210 includes a spring steel component that has a generally arcuate cross-sectional shape, when viewed along its longitudinal direction (e.g., from first end 1212 towards second end 1214), when the length of material 1210 adopts its first, generally flat or planar resting configuration. Upon activation by a user, the length of material 1210 adopts the second generally curved resting configuration, in which the spring steel component has a generally flat cross-sectional shape, when viewed along the same longitudinal direction.

Referring now to FIG. 5, one embodiment of the present disclosure provides fastening system 20 comprising a first loop-shaped fastener 1100 and a second loop-shaped fastener 1200 connected to the first loop-shaped fastener 1100 by a non-releasable linkage 1300. In such an embodiment, the first loop-shaped fastener 1100 may be consistent with any first loop-shaped fastener 1100 disclosed herein. For example and without limitation, the first loop-shaped fastener 1100 may include a length of material 1110 that comprises a bi-stable or a multi-stable length of material that is movable between at least a first, generally flat or planar resting configuration, and a second, generally curved resting configuration. The second, generally curved resting configuration may place the first end 1112 and the second end 1114 in close proximity to each other, such as overlapping, abutting, or with a small gap separating the first end 1112 and the second end 1114. The second, curved configuration may include a portion 1115 of the length of material 1110 that is generally not curved. The portion 1115 is optional and, when present, may ease attachment of the fastener 1120 to the length of material 1110. The fastener 1120 may be any suitable shape for securing the first loop-shaped fastener 1100 to the non-releasable linkage 1300. In the embodiment shown in FIG. 5, for example, the fastener 1120 is a loop that interlocks with a loop at a first end of the non-releasable linkage 1300.

The second loop-shaped fastener 1200 may be consistent with any second loop-shaped fastener 1200 disclosed herein. For example and without limitation, the second loop-shaped fastener 1200 may include a length of material 1210 that comprises a bi-stable or a multi-stable length of material that is movable between at least a first, generally flat or planar resting configuration, and a second, generally curved resting configuration. The second, generally curved resting configuration may place the first end 1212 and the second end 1214 in close proximity to each other, such as overlapping, abutting, or with a small gap separating the first end 1212 and the second end 1214. The second, curved configuration may include a portion 1215 of the length of material 1210 that is generally not curved. The portion 1215 is optional and, when present, may ease attachment of the fastener 1220 to the length of material 1210. The fastener 1220 may be any suitable shape for securing the second loop-shaped fastener 1200 to the non-releasable linkage 1300. In the embodiment shown in FIG. 5, for example, the fastener 1220 is a loop that interlocks with a loop at a second end of the non-releasable linkage 1300.

The non-releasable linkage 1300 may comprise, consist essentially of, or consist of a rope, a chain, a strap, a cable, or a combination thereof.

Referring now to FIG. 6, one embodiment of the present disclosure provides a fastener system 30 comprising a first loop-shaped fastener 1100 and a second loop-shaped fastener 1200 connected to the first loop-shaped fastener 1100 by a releasable linkage 1300. In such an embodiment, the first loop-shaped fastener 1100 may be consistent with any first loop-shaped fastener 1100 disclosed herein. For example and without limitation, the first loop-shaped fastener 1100 may include a length of material 1110 that comprises a bi-stable or a multi-stable length of material that is movable between at least a first, generally flat or planar resting configuration, and a second, generally curved resting configuration. The second, generally curved resting configuration may place the first end 1112 and the second end 1114 in close proximity to each other, such as overlapping, abutting, or with a small gap separating the first end 1112 and the second end 1114. The second, curved configuration may include a portion 1115 of the length of material 1110 that is generally not curved. The fastener 1120 may be any suitable shape for securing the first loop-shaped fastener 1100 to the releasable linkage 1300. In the embodiment shown in FIG. 5, for example, the fastener 1120 includes a cavity 1125 into which a stud 1325a of the releasable linkage 1300 may be inserted.

The second loop-shaped fastener 1200 may be consistent with any second loop-shaped fastener 1200 disclosed herein. For example and without limitation, the second loop-shaped fastener 200 may include a length of material 1210 that comprises a bi-stable or a multi-stable length of material that is movable between at least a first, generally flat or planar resting configuration, and a second, generally curved resting configuration. The second, generally curved resting configuration may place the first end 1212 and the second end 1214 in close proximity to each other, such as overlapping, abutting, or with a small gap separating the first end 1212 and the second end 1214. The second, curved configuration may include a portion 1215 of the length of material 1210 that is generally not curved. The fastener 1220 may be any suitable shape for securing the second loop-shaped fastener 1200 to the releasable linkage 1300. In the embodiment shown in FIG. 5, for example, the fastener 1220 includes a cavity 1225 into which a stud 1325b of the releasable linkage 1300 may be inserted.

The releasable linkage 1300 may comprise, consist essentially of, or consist of a rope, a chain, a strap, a cable, or a combination thereof. A first fastener 1320a is disposed at a first end of the releasable linkage 1300, and may include a stud 1325a that mates with a cavity 1125 of the first loop-shaped fastener 1100. A second fastener 1320b may be disposed at a second end of the releasable linkage 1300, and may include a stud 1325b that mates with a cavity 1225 of the second loop-shaped fastener 1200.

Referring now to FIG. 7, one embodiment of the present disclosure provides a fastener system 40 comprising a first loop-shaped fastener 1100a, a second loop-shaped fastener 1100b, and a third loop-shaped fastener 1100c all connected to a central body 1400 by a first linkage 1300a, a second linkage 1300b, and a third linkage 1300c, respectively. The first loop-shaped fastener 1100a, the second loop-shaped fastener 1100b, and the third loop-shaped fastener 1100c may individually be consistent with any loop-shaped fastener disclosed herein. The first linkage 1300a, the second linkage 1300b, and the third linkage 1300c may individually be a releasable linkage or a non-releasable linkage consistent with any releasable or non-releasable linkage disclosed herein or known in the art. In some embodiments, the first linkage 1300a, the second linkage 1300b, and the third linkage 1300c form parts of a continuous linkage. In other embodiments, at least two of the first linkage 1300a, the second linkage 1300b, and the third linkage 1300c are separate components. In some embodiments, each of the first linkage 1300a, the second linkage 1300b, and the third linkage 1300c are separate components.

The central body 1400 may be a flexible sheet of material such as a tarp, a shade, a hammock, a mesh, or a net; or a rigid sheet of material such as a flat or curved plate of metal and/or plastic.

In the embodiment shown in FIG. 7, each of the first linkage 1300a, the second linkage 1300b, and the third linkage 1300c may be affixed around an anchor Tₐ, T_{b}, and T_{c}, respectively, to temporarily secure the central body 1400 between the anchors Tₐ, T_{b}, and T_{c}.

In some embodiments, the present disclosure provides a loop-shaped fastener comprising: a length of material including a first end, a second end opposite the first end, a first face, and a second face opposite the first face; and a fastener disposed on the first face, wherein the length of material is movable between a first resting configuration and a second resting configuration. In some embodiments, the fastener is disposed substantially equidistant from the first end and the second end. In some embodiments, the fastener is disposed closer to the first end than the second end. In some embodiments, the fastener is disposed closer to the second end than the first end. In some embodiments, the first resting configuration comprises a generally planar configuration. In some embodiments, the first end and the second end are separated by a substantially maximum distance when the loop-shaped fastener is in the generally planar configuration. In some embodiments, the second resting configuration comprises a generally curved configuration. In some embodiments, the first end and the second end are separated by a substantially smaller distance compared to when the first loop-shaped fastener is in the generally planar configuration. In some embodiments, the generally curved configuration comprises a loop. In some embodiments, the loop has a discorectangle cross-sectional shape. In some embodiments, the length of material comprises spring steel that has a generally arcuate cross-sectional shape in its longitudinal direction. In some embodiments, the fastener is configured to mate with a second fastener. In some embodiments, the second fastener is associated with a first face of a second device comprising a second length of material including a first end, a second end opposite the first end, a first face, and a second face opposite the first face. In some embodiments, the second length of material is movable between a first resting configuration and a second resting configuration. In some embodiments, the length of material of the loop-shaped fastener comprises a gap between the first end and the second end when the first length of material is in the second resting configuration. In some embodiments, the second length of material comprises a gap between the first end and the second end when the first length of material is in the second resting configuration.

In some embodiments, the present disclosure provides a fastener system comprising: a first loop-shaped fastener device comprising a first length of material including a first end, a second end opposite the first end, a first face, and a second face opposite the first face; and a fastener disposed on the first face; and a second device removably associated with the first loop-shaped fastener, wherein the first length of material is movable between a first resting configuration and a second resting configuration. In some embodiments, the second device comprises a fastener capable of removably mating with the fastener of the first loop-shaped fastener. In some embodiments, the second device is rotatably associated with the first loop-shaped fastener. In some embodiments, the first resting configuration comprises a generally planar configuration wherein the first end and the second end are separated by a substantially maximum distance when the loop-shaped fastener is in the generally planar configuration. In some embodiments, the second resting configuration comprises a generally curved configuration wherein the first end and the second end are separated by a substantially smaller distance compared to when the loop-shaped fastener is in the generally planar configuration. In some embodiments, the generally curved configuration comprises a loop. In some embodiments, the loop has a discorectangle cross-sectional shape. In some embodiments, the first length of material comprises spring steel that has a generally arcuate cross-sectional shape in its longitudinal direction. In some embodiments, the second device is a second loop-shaped fastener device comprising a second length of material including a first end, a second end opposite the first end, a first face, and a second face opposite the first face; and a fastener disposed on the first face, wherein the second length of material is movable between a first resting configuration and a second resting configuration. In some embodiments, the second resting configuration of the second loop-shaped fastener device comprises a generally planar configuration wherein the first end and the second end are separated by a substantially maximum distance when the second loop-shaped fastener is in the generally planar configuration. In some embodiments, the second resting configuration of the second loop-shaped fastener device comprises a generally curved configuration wherein the first end and the second end are separated by a substantially smaller distance when the second loop-shaped fastener is in the generally planar configuration. In some embodiments, the generally curved configuration comprises a loop. In some embodiments, loop has a discorectangle cross-sectional shape. In some embodiments, the second length of material comprises spring steel that has a generally arcuate cross-sectional shape in its longitudinal direction.

In some embodiments, the present disclosure provides a fastener system comprising: a first loop-shaped fastener device comprising a first length of material including a first end, a second end opposite the first end, a first face, and a second face opposite the first face; and a fastener disposed on the first face; and a second loop-shaped fastener removably associated with the first loop-shaped fastener and comprising a second length of material including a first end, a second end opposite the first end, a first face, and a second face opposite the first face; and a fastener disposed on the first face, wherein the first length of material is movable between an open resting configuration and a closed resting configuration, and wherein the second length of material is movable between an open resting configuration and a closed resting configuration.

In operation, a user may in some embodiments retain one or more loose objects, such as cables, cords, strings, ropes, etc., hoses, electronic devices, utilities, and/or any other suitable object in the length of material 1110 of a first loop-shaped fastener 1100 consistent with the present disclosure by causing the first loop-shaped fastener 1100 to transition from a first resting configuration that is generally planar to a second resting configuration that is generally curved while the loose object(s) are in close proximity to the second face 1118 of the length of material 1110. The user may then connect the first loop-shaped fastener 1110 to a second device 1200 using the fastener 1120 of the first loop-shaped fastener 1100, as shown in FIG. 4B. Thereafter, the user may retain additional loose objects in the first loop-shaped fastener 1100, if desired, by causing the first length of material 1110 to transition from the second resting configuration to the first configuration and then causing the length of material 1110 to re-transition back to the second resting configuration, this time with the additional loose objects in close proximity to the second face 1118 of the first length of material 1110. Alternatively, additional loose objects may be forced into the loop-shaped fastener 1100 while still in its second resting configuration by feeding the additional loose object(s) through the gap 1130 between the first end 1112 and the second end 1114.

In embodiments wherein the second device 1200 is a second loop-shaped fastener 1200, the method may additionally comprise retaining additional loose object(s) in the second loop-shaped fastener 1200 by causing the second loop-shaped fastener 1200 to transition from a first resting configuration that is generally planar to a second resting configuration that is generally curved, while the loose object(s) are in close proximity to the second face 1218 of the length of material 1210. Thereafter, the user may retain additional loose objects in the second loop-shaped fastener 1200, if desired, by causing the second length of material 1210 to transition from the second resting configuration to the first configuration and then causing the length of material 1210 to re-transition back to the second resting configuration, this time with the additional loose objects in close proximity to the second face 1218 of the second length of material 1210. Alternatively, additional loose objects may be forced into the second loop-shaped fastener 1200 while still in its second resting configuration by feeding the additional loose object(s) through the gap 1230 between the first end 1212 and the second end 1214.

Alternatively, the user may connect the first loop-shaped fastener 1100 consistent with the present disclosure to a second device 1200 while at least the first loop-shaped fastener 1100 is in a first generally planar configuration, as shown in FIGS. 3A-3B. Thereafter, the user may retain one or more loose objects, such as cables, cords, strings, ropes, etc., in the first loop-shaped fastener 1100 by causing the first loop-shaped fastener 1100 to transition from the first resting configuration to a second resting configuration that is generally curved while the loose object(s) are in close proximity to the second face 1118 of the length of material 1110, as shown in FIG. 4A. Thereafter, the user may retain additional loose objects in the first loop-shaped fastener 1100, if desired, by causing the first length of material 1110 to transition from the second resting configuration to the first configuration and then causing the length of material 1110 to re-transition back to the second resting configuration, this time with the additional loose objects in close proximity to the second face 1118 of the first length of material 1110. Alternatively, additional loose objects may be forced into the loop-shaped fastener 1100 while still in its second resting configuration by feeding the additional loose object(s) through the gap 1130 between the first end 1112 and the second end 1114.

In embodiments wherein the second device 1200 is a second loop-shaped fastener 1200, the method may additionally comprise retaining additional loose object(s) in the second loop-shaped fastener 1200, or attaching the second loop-shaped fastener 1200 to a stationary object, by causing the second loop-shaped fastener 1200 to transition from a first resting configuration that is generally planar to a second resting configuration that is generally curved, while the loose object(s) are in close proximity to the second face 1218 of the length of material 1210. Thereafter, the user may retain additional loose objects in the second loop-shaped fastener 1200, if desired, by causing the second length of material 1210 to transition from the second resting configuration to the first configuration and then causing the length of material 1210 to re-transition back to the second resting configuration, this time with the additional loose objects in close proximity to the second face 1218 of the second length of material 1210. Alternatively, additional loose objects may be forced into the second loop-shaped fastener 1200 while still in its second resting configuration by feeding the additional loose object(s) through the gap 1230 between the first end 1212 and the second end 1214.

J-Shaped Multi-Modal Fasteners

Referring now generally to FIGS. 8-16B, the present disclosure provides fasteners and methods of using same. Generally, fasteners of the present disclosure can be selectively converted from a first, generally planar configuration (e.g., an “open resting configuration”), to a second, generally loop-shaped or coil-shaped configuration.

A fastener 2100 consistent with the present disclosure has a first end 2112, a second end 2114 opposite the first end, a first face 2116 and a second face 2118 opposite the first face 2116. The fastener 2100 has a unimodal portion 2101 disposed near the first end 2112, and a multi-modal portion 2102 disposed near the second end 2114. The first face 2116 includes a first mating portion 2135 near the second end 2114 while the second face 2118 includes a second mating portion 2125 that selectively and temporarily mates with the first mating portion 2135.

The multi-modal portion 2102 maintains a first resting configuration until a significant force is applied to induce it to adopt a second resting configuration; and remains substantially stable in that second resting configuration until a significant force is applied to the multi-modal portion 2102 to induce the multi-modal portion 2102 to return to the first resting configuration (or adopt a third resting configuration). In some embodiments, the first resting configuration is planar or substantially planar. In some embodiments, the second resting configuration is loop-shaped or coil-shaped. In some embodiments, the multi-modal portion 2102 is bi-modal. In other embodiments, the multi-modal portion 2102 is tri-modal. In still other embodiments, the multi-modal portion 2102 is capable of adopting four or more substantially stable configurations.

In the embodiment specifically illustrated in FIGS. 8-10, for example, the multi-modal portion 2102 is a bi-modal portion 2102 that maintains a first resting configuration that is substantially planar (FIGS. 10-11), referred to herein as an “open configuration.” The bi-modal portion 2102, upon application of a significant force, adopts and maintains a second resting configuration that is curved (FIGS. 8-9B), referred to herein as a “closed configuration.” The term “closed configuration” as used with respect to J-Shaped Multi-modal Fasteners disclosed herein includes configurations wherein the first mating portion 2135 and the second mating portion 2125 are in close proximity but not in contact with each other (e.g., FIGS. 8, 9A), and configurations wherein the first mating portion 2135 and the second mating portion 2125 are in contact with each other (e.g., “mated”; FIG. 9B).

The unimodal portion 2101 substantially maintains its planar or near-planar configuration even when the multi-modal portion 2102 transitions between its first resting configuration and its second and any additional resting configurations. Application of the significant force to induce transition of the multi-modal portion 2102 does not induce transition of the unimodal portion 2101 from its initial configuration to a second stable configuration. In some embodiments, the unimodal portion 2101 includes a rigid band or sleeve surrounding a portion of the multi-modal length of material 2105. The rigid band or sleeve prevents the surrounded portion of the multi-modal length of material 2105 from transitioning from a substantially planar resting configuration to a coiled or loop-shaped resting configuration. In some embodiments, such as those in which the multi-modal length of material 2105 includes an arcuate cross-sectional shape 2107, the rigid band or sleeve is configured to preserve or maintain the arcuate cross-sectional shape 2107 of the length of material 2105 associated with the unimodal portion 2101.

In some embodiments, such as the embodiment shown specifically in FIGS. 11-13, the fastener 2100 comprises a length of material 2105 disposed inside a cover 2116a/2118a. In some embodiments, the cover 2116a/2118a includes a first cover piece 2116a and a second cover piece 2118a that, in combination, form the cover 2116a/2118a. The cover 2116a/2118a may comprise, consist essentially of, or consist of any suitable relatively flexible material including, for example and without limitation, a polymer, fabric, metal, or a combination thereof. The length of material 2105 may comprise, consist essentially of, or consist of a metal (e.g., steel, stainless steel, etc.), polymer, fiber, carbon fiber, or a combination thereof. In other embodiments, the fastener 2100 comprises a length of material 2105 that is coated, covered, painted, extruded, dipped, or molded to provide a first face 2116 on one surface of the length of material 2105 and a second face 2118 on a second, opposite surface of the length of material 2105. In some embodiments, the first cover piece 2116a comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the second cover piece 2118a comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover piece 2116a and the second cover piece 2118a each comprise a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover 2116a is connected to the second cover 2118a through one or more holes (not shown) in the strip of material 2105, for example to reduce or eliminate slippage of the cover 2116a/2118a over the strip of material 2105.

The fastener 2100 includes a length of material 2105 that includes a unimodal section 2105a and a multi-modal section 2105b. The unimodal section 2105a and the multi-modal section 2105b may be one continuous piece of material 2105 in some embodiments, while in other embodiments the unimodal section 2105a is a separate piece of material than the multi-modal section 2105b. The multi-modal section 2105b maintains a first resting configuration until a significant force is applied to induce it to adopt a second resting configuration; and remains substantially stable in that second resting configuration until a significant force is applied to the multi-modal section 2105b to induce the multi-modal section 2105b to return to the first resting configuration (or adopt a third resting configuration). In some embodiments, the first resting configuration is planar or substantially planar. In some embodiments, the second resting configuration is curved. In some embodiments, the multi-modal section 2105b is bi-modal. In other embodiments, the multi-modal section 2105b is tri-modal. In still other embodiments, the multi-modal section 2105b is capable of adopting four or more substantially stable configurations.

In some embodiments, such as that shown in FIGS. 12-13, the multi-modal section 2105b includes a spring steel component that has a generally arcuate cross-sectional shape 2107, when viewed along its longitudinal direction (e.g., from second end 2114 towards first end 2112), when the length of material 2105 adopts its first, generally flat or planar resting configuration (FIG. 13). Upon activation by a user, the spring steel component of the multi-modal section 2105b adopts the second generally curved resting configuration, in which the spring steel component has a generally flat cross-sectional shape, when viewed along the same longitudinal direction (FIG. 12).

The unimodal section 2105a substantially maintains its planar or near-planar configuration even when the multi-modal section 2105b transitions between its first resting configuration and its second and any additional resting configurations. Application of the significant force to induce transition of the multi-modal section 2105b does not induce transition of the unimodal section 2105a from its initial configuration to a second stable configuration. In some embodiments, the unimodal section 2105a includes a steel component that has a generally flat cross-sectional shape, when viewed along the same longitudinal direction (FIG. 14).

In some embodiments, the unimodal section 2105a includes a spring steel component that has a generally arcuate cross-sectional shape 2107, when viewed along its longitudinal direction (e.g., from second end 2114 towards first end 2112). Even when the length of material 2105 adopts its second and any subsequent non-flat/non-planar resting configuration(s), the unimodal section 2105a retains a generally flat/planar configuration, including an arcuate cross-sectional shape 2107 (e.g., FIG. 15).

The curved shape of the second resting configuration may be any shape that places the first mating portion 2135 and the second mating portion 2125 in close proximity. For example and without limitation, the curved shape may include a cross-sectional profile that is a circle, an oval, a triangle, a rectangle, a D-shape, a discorectangle, a pear shape, or an asymmetrical version of any of the foregoing.

The first face 2116 includes a first mating portion 2135 near the second end 2114. The first mating portion 2135 includes at least one first mating feature 2130 capable of mating with the second mating portion 2125. For example, the first mating feature 2130 may include any one or more of: a ratchet tooth, hook-and-loop material, a magnet, a snap, a button, a relatively high-friction surface, self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)), and/or glue.

The second face 2118 includes a second mating portion 2125 that mates with the first mating portion 2135, for example when the multi-modal portion 2102 is in the second resting configuration. The second mating portion 2125 includes at least one second mating feature 2120 capable of mating with the at least one first mating feature 2130 of the first mating portion 2135. For example, the second mating feature 2120 may include any one or more of: a receiving pawl that mates with a ratchet tooth 2130, hook-and-loop material complementary to hook-and-loop material of the first mating portion 2135, a magnet, a snap, a button socket, a relatively high-friction surface, self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)), and/or glue.

In embodiments wherein the first mating feature 2130 includes at least one locking tooth, such as the embodiments specifically shown in FIGS. 8-11, the at least one locking tooth 2130 may feature any suitable shape and size sufficient to releasably engage with at least one receiving pawl 2120 of the second mating portion 2125. In the embodiments specifically shown in FIGS. 8-11, for example, the at least one locking tooth 2130 comprises a plurality of locking teeth each having a wedge-shaped cross-sectional profile. The wedge-shaped cross-sectional profile of the at least one locking tooth 2130 specifically shown in FIGS. 8-11 allows the first mating feature 2130 to slide over and in contact with the at least one receiving pawl 2120 to tighten the multi-modal portion 2102, while preventing the first mating feature 2130 from sliding over and in contact with the at least one receiving pawl 2120 to loosen the multi-modal portion 2102. Although the embodiment shown in FIGS. 8-11 shows the at least one locking tooth 2130 as extending across the entire width of the first face 2116, other embodiments may include the at least one locking tooth 2130 as having a width that is narrower than the width of the first face 2116. In embodiments wherein the second mating portion 2125 includes a receiving pawl 2120, the receiving pawl(s) 2120 may have any suitable shape and size, so long as they effectively reversibly mate with at least one of the at least one locking tooth 2130. Although the embodiment shown in FIGS. 8-11 shows the at least one receiving pawl 2120 as extending across the entire width of the second face 2118, other embodiments may include the at least one receiving pawl 2120 as having a width that is narrower than the width of the second face 2118.

In some embodiments, the unimodal portion 2101 includes a throughhole 2108 through which a wall anchor (e.g., nail, screw, bolt, pushpin, zip tie, etc.) may be inserted for attaching the fastener 2100 to a wall, ceiling, beam, or other secure object. In some embodiments, the throughhole 2108 includes a first hole 2108a in the front cover 2116a, a second hole 2108b in the second cover 2118a, and a third hole 2108c in the unimodal section of material 2105a. In some embodiments, the first hole 2108a, the second hole 2108b, and the third hole 2108c align such that the direction of the throughhole 2108 thus formed is perpendicular to the first surface 2118 and/or to the second surface 2116. In other embodiments, such as that shown specifically in FIG. 9A, the first hole 2108a, the second hole 2108b, and the third hole 2108c align such that the direction of the throughhole 2108 thus formed is not perpendicular to the first surface 2118 or to the second surface 2116. For example, in the embodiment specifically shown in FIG. 9A, the first hole 108a, the second hole 2108b, and the third hole 2108c are arranged relative to each other to form a throughhole 2108 that angles downward from the first surface 2118 to the second surface 2116.

In some embodiments, the length of material 2105 includes a single piece of material including a unimodal section of material 2105a and a multi-modal section of material 105b. In other embodiments, the length of material 2105 includes a first piece of material that is unimodal 2105a, and a second piece of material that is multi-modal 2105b.

Referring now to FIGS. 16A-16B, in some embodiments the unimodal portion 2101 does not adopt a generally curved resting configuration even when the second portion 2102 adopts a generally curved resting configuration. In some embodiments, the unimodal portion 2101 comprises a rigid cover portion 2116b/2118b that substantially surrounds a multi-modal length of material 2105a. In other embodiments, the length of material 2105 includes a multi-modal length of material 2105b associated with the second portion 2102, and does not include a length of material 2105a associated with the first portion 2101; in such embodiments the first portion 2101 consists essentially of the rigid cover portion 2116b/2118b. In some embodiments, the rigid cover portion 2116b/2118b includes the second mating portion 2125 and its second mating feature 2120.

In some embodiments, a second cover portion 2116c/2118c associated with the second portion 2102 comprises the first mating portion 2135 and its first mating feature 2130, and may be disposed proximate to the second end 2114. In some such embodiments, the second cover portion 2116c/2118c may be rigid and may comprise a generally curved cross-sectional shape to facilitate convenient mating with the second mating portion 2125. In other embodiments, the second cover portion 2116c/2118c may be flexible and may substantially surround at least a portion of the multi-modal length of material 2105b. In some embodiments, the second cover portion 2116c/2118c comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, a first half of the second cover portion 2116c is connected to a second half of the second cover portion 2118c through one or more holes (not shown) in the multi-modal length of material 2105b, for example to reduce or eliminate slippage of the second cover portion 2116c/2118c over the multi-modal length of material 2105b.

In operation, a user may in some embodiments retain one or more loose objects, such as cables, cords, strings, ropes, etc., hoses, electronic devices, utilities, and/or any other suitable object in the fastener 2100 consistent with the present disclosure by causing the multi-modal portion 2102 of the fastener 2100 to transition from a first resting configuration that is generally planar to a second resting configuration that is generally curved while the loose object(s) are in close proximity to the second face 2118, such that the multi-modal portion 2102 wraps around or substantially around the loose object(s). The user may then push the second end 2114 towards the at least one receiving pawl 2120, eventually sliding the second end 2114 past the at least one receiving pawl 2120 until at least a portion of the first mating portion 2135 engages with at least a portion of the second mating portion 2125. Before or after engaging the first mating portion 2135 with the second mating portion 2125, the user may attach the unimodal portion 2101 to a surface by passing a nail, screw, pin, etc. through the throughhole 2108 and into the surface. Thereafter, the user may retain additional loose objects in the first loop/coil-shaped fastener 2100, if desired, by first pulling the second end 2114 away from the second face 2118 until the first mating portion 2135 disengages from the second mating portion 2125, passing the additional loose object(s) into the gap formed between the second end 2114 and the second face 2118, and then pushing the second end 2114 towards the second mating portion 2125 until at least a portion of the first mating portion 2135 engages with at least a portion of the second mating portion 2125. Removing the loose object(s) from the fastener 2100 may be accomplished by first pulling the second end 2114 away from the second face 2118 until the first mating portion 2135 disengages from the second mating portion 2125, and then passing the loose object(s) out of the gap formed between the second end 2114 and the second face 2118.

In some embodiments, the first mating portion 2135 and the second mating portion 2125 are disposed on the same face (e.g., both on the first face 2116 or both on the second face 2118). In such embodiments, the fastener 2100 may include a first unimodal portion 2101 disposed near the first end 2112 and configured consistent with other embodiments disclosed herein, a second unimodal portion 2103 (not shown) disposed near the second end 2114 and including the first mating portion 2135, and a multi-modal portion 2102 disposed between the first unimodal portion and the second unimodal portion 2103 and configured consistent with other embodiments disclosed herein.

In some embodiments, the present disclosure provides a fastener 2100 including a first end 2112, a second end 2114 opposite the first end 2112, a first face 2116, and a second face 2118 opposite the first face 2116, the fastener 2100 comprising: a unimodal portion 2101 near the first end 2112; a multi-modal portion 2102 near the second end 2114; a unimodal section 2101 of material associated with the unimodal portion 2101; and a multi-modal section of material associated with the multi-modal portion 2102, wherein the multi-modal portion 2102 is movable between a first stable resting configuration and a second stable resting configuration. In some embodiments, the fastener 2100 further comprises a first mating portion 2135 disposed on the first face 2116; and a second mating portion 2125 disposed on the second face 2118 and configured to selectively and temporarily mate with the first mating portion 2135 when the fastener 2100 is in the second stable resting configuration. In some embodiments, the first mating portion 2135 and the second mating portion 2125 are separated by a substantially maximum distance when the fastener 2100 is in the first resting configuration. In some embodiments, the first resting configuration comprises a generally planar configuration. In some embodiments, the first mating portion 2135 and the second mating portion 2125 are separated by a substantially smaller distance, compared to when the multi-modal portion 2102 is in the first resting configuration, when the multi-modal portion 2102 is in the second resting configuration. In some embodiments, the second resting configuration comprises a generally curved configuration. In some embodiments, the generally curved configuration comprises a loop or coil. In some embodiments, the first mating portion 2135 comprises at least one locking tooth 2130. In some embodiments, the second mating portion 2125 comprises at least one receiving pawl 2120. In some embodiments, the fastener 2100 further comprises a cover 2116a/2118a substantially surrounding the unimodal section of material 2105a and the multi-modal section of material 2105b, wherein the cover 2116a/2118a includes the first mating portion 2135 and the second mating portion 2125. In some embodiments, the unimodal section of material 2105a and the multi-modal section of material 2105b are a single continuous piece of material 2105. In some embodiments, the unimodal section of material 2105a is a single piece of material and the multi-modal section of material 2105b is a single piece of material separate from the unimodal section of material 2105a. In some embodiments, the multi-modal section of material 2105b has an arcuate cross-sectional area when the multi-modal portion 2102 is in the first stable resting configuration. In some embodiments, the multi-modal section of material 2105b has an arcuate cross-sectional area when the multi-modal portion 2102 is in the first stable resting configuration, and the multi-modal section of material 2105b has a generally planar cross-sectional area when the multi-modal portion 2102 is in the second stable resting configuration. In some embodiments, the unimodal section of material comprises a multi-modal length of material and a rigid band substantially surrounding the unimodal section of material configured to prevent the unimodal section of material from moving between the first stable resting configuration and the second stable resting configuration.

S-Shaped Multi-Modal Fasteners

Referring now generally to FIGS. 17-24, the present disclosure provides fasteners and methods of using same.

Generally, fasteners of the present disclosure include two multi-modal portions that can individually be selectively converted from a first, generally planar configuration, to a second, generally loop-shaped configuration.

A fastener 3100 consistent with the present disclosure has a first end 3112, a second end 3114 opposite the first end 3112, a first face 3116 and a second face 3118 opposite the first face 3116. The fastener 3100 has a first multi-modal portion 3101 disposed near the first end 3112, and a second multi-modal portion 3102 disposed near the second end 3114. The second face 3118 includes a first securing portion 3135a near the first end 3112, while the first face 3116 includes a first mating portion 3125a that selectively and temporarily mates with the first securing portion 3135a.

In some embodiments, the first face 3116 includes a second securing portion 3135b near the second end 3114, while the second face 3118 includes a second mating portion 3125b that selectively and temporarily mates with the second securing portion 3135b. In other embodiments, the second face 3118 includes a second securing portion 3135b near the second end 3114, while the first face 3116 includes a second mating portion 3125b that selectively and temporarily mates with the second securing portion 3135b.

The first multi-modal portion 101 and the second multi-modal portion 3102 are each configured to independently maintain a first resting configuration until a significant force is applied to induce the first multi-modal portion 3101 and/or the second multi-modal portion 3102 to adopt a second resting configuration. Once in the second resting configuration, the first multi-modal portion 3101 and/or the second multi-modal portion 3102 remains substantially stable in that second resting configuration until a significant force is applied to induce a return to the first resting configuration (or to adopt a third resting configuration). In some embodiments, the first resting configuration is planar or substantially planar. In some embodiments, the second resting configuration is loop-shaped or coil-shaped.

In some embodiments, the first multi-modal portion 3101 is bi-modal. In other embodiments, the first multi-modal portion 3101 is tri-modal. In still other embodiments, the first multi-modal portion 3101 is capable of adopting four or more substantially stable configurations. In some embodiments, the second multi-modal portion 3102 is bi-modal. In other embodiments, the multi-modal portion 3102 is tri-modal. In still other embodiments, the multi-modal portion 3102 is capable of adopting four or more substantially stable configurations.

In the embodiment specifically illustrated in FIGS. 17-20, for example, the first multi-modal portion 3101 and the second multi-modal portion 3102 are each bi-modal and maintain a first resting configuration that is substantially planar (FIGS. 19-20), referred to herein as an “open configuration.” The first multi-modal portion 3101 and the second bi-modal portion 3102, upon application of a significant force, each adopt and maintain a second resting configuration that is curved (FIGS. 17-18), referred to herein as a “closed configuration.” The term “closed configuration” as used with respect to S-Shaped Multi-Modal Fasteners disclosed herein includes configurations wherein the first securing portion 3135a and the first mating portion 3125a are in close proximity to each other but are not in contact with each other, and configurations wherein the first securing portion 3135a and the first mating portion 3125a are in contact with each other (e.g., “mated”). The term “closed configuration” as used herein also includes configurations wherein the second securing portion 3135b and the second mating portion 3125b are in close proximity to each other but are not in contact with each other, and configurations wherein the second securing portion 135b and the second mating portion 3125b are in contact with each other (e.g., “mated”).

In some embodiments, the central portion 3103 substantially maintains its planar or near-planar configuration even when the first multi-modal portion 3101 and/or the second multi-modal portion 3102 transitions between a first resting configuration and a second or any additional resting configurations. Application of the significant force to induce transition of the first multi-modal portion 3101 and the second multi-modal portion 3102 does not induce transition of the central portion 3103 from its initial configuration to a second stable configuration.

In some embodiments, such as the embodiment shown specifically in FIGS. 20-22, the fastener 3100 comprises a length of material 3105 disposed inside a cover 3116a/3118a. In some embodiments, the cover 3116a/3118a includes a first cover piece 3116a and a second cover piece 3118a that, in combination, form the cover 3116a/3118a. The cover 3116a/3118a may comprise, consist essentially of, or consist of any suitable relatively flexible material including, for example and without limitation, a polymer, fabric, metal, or a combination thereof. The length of material 3105 may comprise, consist essentially of, or consist of a metal (e.g., steel, stainless steel, etc.), polymer, fiber, carbon fiber, or a combination thereof. In other embodiments, the fastener 3100 comprises a length of material 3105 that is coated, covered, painted, extruded, dipped, or molded to provide a first face 3116 on one surface of the length of material 3105 and a second face 3118 on a second, opposite surface of the length of material 3105. In some embodiments, the first cover piece 3116a comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the second cover piece 3118a comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover piece 3116a and the second cover piece 3118a each comprise a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover piece 3116a is connected to the second cover piece 3118a through one or more holes (not shown) in the length of material 3105, for example to reduce or eliminate slippage of the cover 3116a/3118a over the length of material 3105.

The fastener 3100 includes a length of material 3105 that includes a first multi-modal section 3105a and a second multi-modal section 3105b. The first multi-modal section 3105a and the second multi-modal section 3105b may be one continuous piece of material 3105 in some embodiments, while in other embodiments the first multi-modal section 3105a is a separate piece of material than the second multi-modal section 3105b.

The first multi-modal section 3105a maintains a first resting configuration until a significant force is applied to induce it to adopt a second resting configuration; and remains substantially stable in that second resting configuration until a significant force is applied to the first multi-modal section 3105a to induce the first multi-modal section 3105a to return to the first resting configuration (or adopt a third resting configuration). In some embodiments, the first resting configuration is planar or substantially planar. In some embodiments, the second resting configuration is curved. In some embodiments, the multi-modal section 3105a is bi-modal. In other embodiments, the first multi-modal section 3105a is tri-modal. In still other embodiments, the first multi-modal section 3105a is capable of adopting four or more substantially stable configurations.

The second multi-modal section 3105b maintains a first resting configuration until a significant force is applied to induce it to adopt a second resting configuration; and remains substantially stable in that second resting configuration until a significant force is applied to the second multi-modal section 3105b to induce the second multi-modal section 3105b to return to the first resting configuration (or adopt a third resting configuration). In some embodiments, the first resting configuration is planar or substantially planar. In some embodiments, the second resting configuration is curved. In some embodiments, the multi-modal section 3105b is bi-modal. In other embodiments, the second multi-modal section 3105b is tri-modal. In still other embodiments, the second multi-modal section 3105b is capable of adopting four or more substantially stable configurations.

In some embodiments, such as that shown in FIGS. 21-22, the first multi-modal section 3105a and the second multi-modal section 3105b each include a spring steel component that has a generally arcuate cross-sectional shape 3107, when viewed along its longitudinal direction (e.g., from second end 3114 towards first end 3112 or vice versa), when the length of material 3105 adopts its first, generally flat or planar resting configuration (FIG. 22). Upon activation by a user, the spring steel component of the first multi-modal section 3105a and/or the second multi-modal section 3105b adopt the second generally curved resting configuration, in which the spring steel component has a generally flat cross-sectional shape, when viewed along the same longitudinal direction (FIG. 21).

The central section 3105c substantially maintains its planar or near-planar configuration even when the first multi-modal section 3105a and/or the second multi-modal section 3105b transition between a first resting configuration and a second or any additional resting configurations. Application of the significant force to induce transition of the first multi-modal section 3105a and/or the second multi-modal section 3105b does not induce transition of the central section 3105c from its initial configuration to a second stable configuration.

In some embodiments, the central section 3105c includes a steel component that has a generally flat cross-sectional shape, when viewed along the same longitudinal direction (FIG. 23). In some embodiments, the central section 3105c includes a spring steel component that has a generally arcuate cross-sectional shape 3107, when viewed along its longitudinal direction (e.g., from second end 3114 towards first end 3112). Even when the first multi-modal section 3105a and/or the second multi-modal section 3105b adopt its second and any subsequent non-flat/non-planar resting configuration(s), the central section 3105c retains a generally flat/planar configuration, including an arcuate cross-sectional shape 3107 (e.g., FIG. 24).

The curved shape of the second resting configuration of the first multi-modal portion 3101 may be any shape that places the first securing portion 3135a and the first mating portion 3125a in close proximity. For example and without limitation, the curved shape may include a cross-sectional profile that is a circle, an oval, a triangle, a rectangle, a D-shape, a discorectangle, a pear shape, or an asymmetrical version of any of the foregoing.

The curved shape of the second resting configuration of the second multi-modal portion 3102 may be any shape that places the second securing portion 3135b and the second mating portion 3125b in close proximity. For example and without limitation, the curved shape may include a cross-sectional profile that is a circle, an oval, a triangle, a rectangle, a D-shape, a discorectangle, a pear shape, or an asymmetrical version of any of the foregoing.

The second face 3118 includes a first securing portion 3135a near the first end 3112. The first securing portion 3135a includes at least one first securing feature 3130a capable of mating with the first mating portion 3125a. For example, the first securing feature 3130a may include any one or more of: a ratchet tooth, hook-and-loop material, a magnet, a snap, a button, a relatively high-friction surface, self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)), and/or glue. The first mating portion 3125a is disposed on the first face 3116 and includes at least one first mating feature 3120a that selectively mates with the at least one first securing feature 3130a. For example, the first mating feature 3120a may include a receiving pawl that engages the first securing feature 3130a (e.g., a tooth) as shown in FIGS. 17-18.

In some embodiments, such as those shown in FIGS. 17-20, the first face 3116 includes a second securing portion 3135b near the second end 3114. The second securing portion 3135b includes at least one second securing feature 3130b capable of mating with the second mating portion 3125b, which is disposed on the second face 3118 distal to the second end 3114. For example, the second securing feature 3130b may include any one or more of: a ratchet tooth, hook-and-loop material, a magnet, a snap, a button, a relatively high-friction surface, self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)), and/or glue. The second mating portion 3125b includes at least one second mating feature 3120b that selectively mates with the at least one second securing feature 3130b. For example, the second mating feature 3120b may include a receiving pawl that engages the second securing feature 3130b (e.g., a tooth) as shown in FIGS. 17-18.

In other embodiments, the second securing portion 3135b is disposed on the second face 3118 near the second end 3114. The second securing portion 3135b includes at least one second securing feature 3130b capable of mating with the second mating portion 3125b, which is disposed on the first face 3116 distal to the second end 3114. For example, the second securing feature 3130b may include any one or more of: a ratchet tooth, hook-and-loop material, a magnet, a snap, a button, a relatively high-friction surface, self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)), and/or glue. The second mating portion 3125b includes at least one second mating feature 3120b that selectively mates with the at least one second securing feature 3130b. For example, the second mating feature 3120b may include a receiving pawl that engages the second securing feature 3130b (e.g., a tooth).

In embodiments wherein the first securing feature 3130a includes at least one locking tooth, such as the embodiments specifically shown in FIGS. 17-20, the at least one locking tooth 3130a may feature any suitable shape and size sufficient to releasably engage with at least one receiving pawl 3120a of the first mating portion 3125a. In the embodiments specifically shown in FIGS. 17-20, for example, the at least one locking tooth 3130a comprises a single locking tooth having a wedge-shaped cross-sectional profile. The wedge-shaped cross-sectional profile of the locking tooth 3130a specifically shown in FIGS. 17-20 allows the first securing feature 130a to slide over and in contact with the first receiving pawl 3120a to lock the first multi-modal portion 3101 in a closed resting configuration, while preventing the first securing feature 3130a from sliding over and in contact with the first receiving pawl 3120a to loosen the first multi-modal portion 3101. Although the embodiment shown in FIGS. 17-20 shows the first locking tooth 3130a as extending across the entire width of the second face 3118, other embodiments may include the first locking tooth 3130a as having a width that is narrower than the width of the second face 3118. In embodiments wherein the first mating portion 3125a includes a first receiving pawl 3120a, the first receiving pawl 3120a may have any suitable shape and size, so long as it effectively reversibly mates with the first locking tooth 3130a. Although the embodiment shown in FIGS. 17-20 shows the first receiving pawl 3120a as extending across the entire width of the first face 3116, other embodiments may include the first receiving pawl 3120a as having a width that is narrower than the width of the first face 3116.

In embodiments wherein the second securing feature 3130b includes at least one locking tooth, such as the embodiments specifically shown in FIGS. 17-20, the at least one locking tooth 3130b may feature any suitable shape and size sufficient to releasably engage with at least one receiving pawl 3120b of the second mating portion 3125b. In the embodiments specifically shown in FIGS. 17-20, for example, the at least one locking tooth 3130b comprises a single locking tooth 3130b having a wedge-shaped cross-sectional profile. The wedge-shaped cross-sectional profile of the locking tooth 3130b specifically shown in FIGS. 17-20 allows the second securing feature 3130b to slide over and in contact with the second receiving pawl 3120b to lock the second multi-modal portion 3102 in a closed resting configuration, while preventing the second securing feature 3130b from sliding over and in contact with the second receiving pawl 3120b to loosen the second multi-modal portion 3102. Although the embodiment shown in FIGS. 17-20 shows the second locking tooth 3130b as extending across the entire width of the first face 3116, other embodiments may include the second locking tooth 3130b as having a width that is narrower than the width of the first face 3116. In embodiments wherein the second mating portion 3125b includes a second receiving pawl 3120b, the second receiving pawl 3120b may have any suitable shape and size, so long as it effectively reversibly mates with the second locking tooth 3130b. Although the embodiment shown in FIGS. 17-20 shows the second receiving pawl 3120b as extending across the entire width of the second face 3118, other embodiments may include the second receiving pawl 3120b as having a width that is narrower than the width of the second face 3118.

In some embodiments, the length of material 3105 includes a single piece of material including a first multi-modal portion 3105a, a second multi-modal section 3105b, and a central portion 3105c disposed between the first multi-modal portion 3105a and the second multi-modal portion 3105b. In other embodiments, the length of material 3105 includes a first piece of material including the first multi-modal portion 3105a, and a second piece of material including the central portion 3105c and the second multi-modal portion 3105b. In other embodiments, the length of material 3105 includes a first piece of material that includes the first multi-modal portion 3105a and the central portion 3105c, and a second piece of material that includes the second multi-modal portion 3105b. In other embodiments, the length of material 3105 includes a first piece of material that includes the multi-modal portion 3105a, a second piece of material that includes the central portion 3105c, and a third piece of material that includes the second multi-modal portion 3105b. In other embodiments, the length of material 3105 includes a first piece of material that includes the first multi-modal portion 3105a, and a second piece of material that includes the second multi-modal portion 3105b, while the central portion 3103 does not include a portion of the length of material 3105.

In some embodiments, the fastener 3100 includes an attachment point. The attachment point enables attachment of the fastener 3100 to be connected (e.g., reversibly connected) to another object, such as a wall, a fence, a pipe, a hook, a loop, or another fastener 3100. In some embodiments, the attachment point is disposed at or near the central portion or the central unimodal portion. The attachment point may be a throughhole, a post, a loop, a snap, or a magnet.

In operation, a user may in some embodiments retain one or more loose objects, such as cables, cords, strings, ropes, etc., hoses, electronic devices, utilities, and/or any other suitable object in the fastener 3100 consistent with the present disclosure by causing the first multi-modal portion 3101 of the fastener 3100 to transition from a first resting configuration that is generally planar to a second resting configuration that is generally curved while the loose object(s) are in close proximity to the first face 3116, such that the first multi-modal portion 3101 wraps around or substantially around the loose object(s). The user may then push the first mating portion 3135a towards the first mating portion 3125a, eventually sliding the first securing feature 3130a past the first receiving pawl 3120a until the first securing feature 3130a engages with the first mating feature 3120a. Before or after engaging the first securing portion 3135a with the first mating portion 3125a, the user may attach the second multi-modal portion 3102 to any suitable support structure, such as a pipe, a wire, a string or cable, etc., by wrapping the second multi-modal portion 3102 around the suitable support structure. Alternatively, the user may retain one or more additional loose objects, such as cables, cords, strings, ropes, etc., hoses, electronic devices, utilities, and/or any other suitable object, in the second multi-modal portion 3102 by causing the second multi-modal portion 3102 of the fastener 3100 to transition from a first resting configuration that is generally planar to a second resting configuration that is generally curved while the loose object(s) are in close proximity to the second face 3118, such that the second multi-modal portion 3102 wraps around or substantially around the loose object(s). The user may then push the second mating portion 3135b towards the second mating portion 3125b, eventually sliding the second securing feature 3130b past the second receiving pawl 3120b until the second securing feature 3130b engages with the second mating feature 3120b. Thereafter, the user may retain additional loose objects in the first multi-modal portion 3101, if desired, by first pulling the first end 3112 away from the first face 3116 until the first securing portion 3135a disengages from the first mating portion 3125a, passing the additional loose object(s) into the gap formed between the first end 3112 and the first face 3116, and then pushing the first securing portion 3135a towards the first mating portion 3125a until the first securing feature 3130a engages with the first mating feature 3120a. Similarly, the user may retain additional loose objects in the second multi-modal portion 3102, if desired, by first pulling the second end 3114 away from the second face 3118 until the second securing portion 3135b disengages from the second mating portion 3125b, passing the additional loose object(s) into the gap formed between the second end 3114 and the second face 3118, and then pushing the second securing portion 3135b towards the second mating portion 3125b until the second securing feature 3130b engages with the second mating feature 3120b.

Removing the loose object(s) from the first multi-modal portion 3101 may be accomplished by first pulling the first end 3112 away from the first face 116 until the first mating portion 3135a disengages from the first mating portion 3125a, and then passing the loose object(s) out of the gap formed between the first end 3112 and the first face 3116. Similarly, removing the loose object(s) from the second multi-modal portion 3102 may be accomplished by first pulling the second end 3114 away from the second face 3118 until the second mating portion 3135b disengages from the second mating portion 3125b, and then passing the loose object(s) out of the gap formed between the second end 3114 and the second face 3118.

In some embodiments, the present disclosure provides a fastener comprising a length of material including a first end, a second end substantially opposite the first end, a first face, and a second face substantially opposite the first face; a first multi-modal portion proximal to the first end; and a second multi-modal portion proximal to the second end, wherein each multi-modal portion is independently movable between a first resting configuration and a second resting configuration. In some embodiments, the fastener further comprises a first securing portion configured to secure the first multi-modal portion into a closed loop configuration. In some embodiments, the fastener further comprises a second securing portion configured to secure the second multi-modal portion into a closed loop configuration. In some embodiments, the first resting configuration is substantially planar. In some embodiments, the second resting configuration represents a loop or coil shape. In some embodiments, the fastener further comprises a central portion disposed between the first multi-modal portion and the second multi-modal portion. In some embodiments, the central portion is not multi-modal. In some embodiments, the first securing portion comprises: a first securing feature disposed proximal to the first end; and a first mating feature disposed proximal to the second multi-modal portion and configured to reversibly mate with the first securing feature. In some embodiments, the length of material further comprises a central portion disposed between the first multi-modal portion and the second multi-modal portion, and wherein the first mating feature is disposed on the central portion. In some embodiments, the first securing portion is disposed on the first face, and wherein the first mating portion is disposed on the second face. In some embodiments, the second securing portion comprises a second securing feature disposed proximal to the second end; and a second mating feature disposed proximal to the first multi-modal portion and configured to reversibly mate with the second securing feature. In some embodiments, the length of material further comprises a central portion disposed between the first multi-modal portion and the second multi-modal portion, and wherein the second mating feature is disposed on the central portion. In some embodiments, the second securing portion is disposed on the second face, and wherein the second mating portion is disposed on the first face. In some embodiments, the second securing portion is disposed on the first face, and wherein the second mating portion is disposed on the second face. In some embodiments, the central portion is not multi-modal. In some embodiments, the first securing portion includes at least one tooth, and wherein the first mating portion includes at least one pawl for selectably mating with the at least one tooth.

In some embodiments, the second securing portion includes at least one tooth, and wherein the second mating portion includes at least one pawl for selectably mating with the at least one tooth. In some embodiments, the present disclosure provides a fastener comprising a first multi-modal loop portion disposed at a first end; a second multi-modal loop portion disposed at a second end substantially opposite the first end; and a central unimodal portion disposed between the first multi-modal loop portion and the second multi-modal loop portion, wherein the first multi-modal loop portion and the second multi-modal loop portion are each configured to independently adopt a first closed resting configuration and a second open resting configuration. In some embodiments, the first multi-modal portion comprises a first securing portion disposed on a first face of the fastener and proximal to the first end; and a first mating portion disposed on a second face of the fastener and proximal to the central portion. In some embodiments, the second multi-modal portion comprises a second securing portion disposed proximal to the second end; and a second mating portion disposed proximal to the central portion. In some embodiments, the second securing portion is disposed on the second face, and wherein the second mating portion is disposed on the first face. In some embodiments, the second securing portion is disposed on the first face, and wherein the second mating portion is disposed on the second face. In some embodiments, the first multi-modal portion comprises spring steel that has a generally arcuate cross-sectional shape in its longitudinal direction when the first multi-modal portion is in its second resting configuration. In some embodiments, the second multi-modal portion comprises spring steel that has a generally arcuate cross-sectional shape in its longitudinal direction when the second multi-modal portion is in its second resting configuration. In some embodiments, the first securing portion includes at least one tooth, and wherein the first mating portion includes at least one pawl for selectably mating with the at least one tooth. In some embodiments, the second securing portion includes at least one tooth, and wherein the second mating portion includes at least one pawl for selectably mating with the at least one tooth.

In some embodiments, the present disclosure provides a fastener comprising a first bimodal portion at a first end of the fastener, the first bimodal portion configured to adopt a first generally planar mode and a second generally loop-shaped mode, the first bimodal portion comprising a first length of spring steel having a generally arcuate cross-sectional shape in its longitudinal direction when the first bimodal portion is in the first generally planar mode, and a first securing portion disposed at a first end of the first bimodal portion and on a first face of the fastener; a second bimodal portion at a second end of the fastener, the second bimodal portion configured to adopt, independently of the first bimodal portion, a first generally planar mode and a second generally loop-shaped mode, the second bimodal portion comprising a second length of spring steel having a generally arcuate cross-sectional shape in its longitudinal direction when the second bimodal portion is in the first generally planar mode, and a second securing portion disposed at a first end of the second bimodal portion; and a central unimodal portion disposed between the first bimodal portion and the second bimodal portion, the central unimodal portion comprising a first mating portion disposed proximal to the first bimodal portion and on a second face of the fastener opposite the first face of the fastener, and a second mating portion disposed proximal to the second bimodal portion. In some embodiments, the second securing portion is disposed on the second face of the fastener, and wherein the second mating portion is disposed on the first face of the fastener. In some embodiments, the second securing portion is disposed on the first face of the fastener, and wherein the second mating portion is disposed on the second face of the fastener. In some embodiments, the first securing portion comprises at least one tooth, and the first mating portion comprises at least one pawl. In some embodiments, the second securing portion comprises at least one tooth, and the second mating portion comprises at least one pawl. In some embodiments, the first length of spring steel and the second length of spring steel are continuous. In some embodiments, the fastener further comprises a cover substantially surrounding the first and second lengths of spring steel. In some embodiments the central portion or the central unimodal portion further comprises an attachment point. In some embodiments, the attachment point is a throughhole.

“Ratcheting” Multi-Modal Fasteners

Referring now generally to FIGS. 25A-34B, the present disclosure provides fasteners and methods of using same.

Generally, multi-modal fasteners of the present disclosure can be selectively converted from a first stable generally planar resting configuration (e.g., an “open resting configuration”), to a second stable generally loop-shaped or coil-shaped resting configuration (e.g., a “closed” resting configuration).

A multi-modal fastener 4100 consistent with the present disclosure includes a first end 4112, a second end 4114 opposite the first end, a first face 4116, and a second face 4118 opposite the first face 4116. The second face 4118 includes a mating portion 4125 proximal to the first end 4112, while the first face 4116 includes a securing portion 4135 proximal to the second end 4114. The securing portion 4135 is configured to selectively and reversibly mate with the mating portion 4125 via mechanical force(s), magnetic force(s), frictional force(s), electrical force(s), or a combination thereof.

The multi-modal fastener 4100 maintains a first stable resting configuration until a significant force is applied to induce it to adopt a second stable resting configuration. The multi-modal fastener 4100 remains substantially stable in that second stable resting configuration until a significant force is applied to the multi-modal fastener 4100 to induce it to return to the first stable resting configuration (or to adopt a third stable resting configuration). In some embodiments, the first stable resting configuration is planar or substantially planar. In some embodiments, the second stable resting configuration is generally loop-shaped or coil-shaped. In some embodiments, the multi-modal fastener 4100 is bi-modal—that is, it is configured to adopt exactly two distinct stable resting configurations. In other embodiments, the multi-modal fastener 4100 is tri-modal. In still other embodiments, the multi-modal fastener is capable of adopting four or more substantially stable configurations.

In the embodiment specifically illustrated in FIGS. 25A-28, for example, the multi-modal fastener 4100 is a bi-modal fastener 4100 that maintains a first stable resting configuration that is substantially planar (FIGS. 27-28), referred to herein as an “open configuration.” The bi-modal fastener 4100, upon application of a significant force, adopts and maintains a second stable resting configuration that is curved (FIGS. 25A-26), referred to herein as a “closed configuration.” The term “closed configuration” as used with respect to Ratcheting Multi-modal Fasteners disclosed herein includes configurations wherein the securing portion 4135 and the mating portion 4125 are in close proximity but not in contact with each other, and also to configurations wherein the securing portion 4135 and the mating portion 4125 are in contact with each other (e.g., “mated”; FIGS. 25A-26).

In some embodiments, such as the embodiment shown specifically in FIGS. 26 and 28-30, the multi-modal fastener 4100 comprises a length of material 4105 disposed inside a cover 4116a/4118a. In some embodiments, the cover 4116a/4118a includes a first cover piece 4116a and a second cover piece 4118a that, in combination, form the cover 4116a/4118a. The cover 4116a/4118a may comprise, consist essentially of, or consist of any suitable relatively flexible material including, for example and without limitation, a polymer, fabric, metal, or a combination thereof. The length of material 4105 may comprise, consist essentially of, or consist of a metal (e.g., steel, stainless steel, etc.), polymer, fiber, carbon fiber, or a combination thereof. In other embodiments, the fastener 4100 comprises a length of material 4105 that is coated, covered, painted, extruded, dipped, or molded to provide a first face 4116 on one surface of the length of material 4105 and a second face 4118 on a second, opposite surface of the length of material 4105. In some embodiments, the first cover piece 4116a comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the second cover piece 4118a comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover piece 4116a and the second cover piece 4118a each comprise a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover piece 4116a is connected to the second cover piece 4118a through one or more holes (not shown) in the length of material 4105, for example to reduce or eliminate slippage of the cover 4116a/4118a over the length of material 4105.

In embodiments wherein the multi-modal fastener 4100 is bi-modal, the length of material 4105 maintains a first stable resting configuration (e.g., a generally planar resting configuration as shown in FIGS. 27-28) until a significant force is applied to induce it to adopt a second stable resting configuration (e.g., a generally coil-shaped configurations as shown in FIGS. 25A-26); the length of material 4105 remains substantially stable in that second stable resting configuration until a significant force is applied to it to induce it to return to the first stable resting configuration. In some embodiments wherein the multi-modal fastener 4100 is tri-modal, the length of material 4105 is configured to adopt a third stable resting configuration when a significant force is applied to it to transition the length of material from the first stable resting configuration to the third stable resting configuration. In some embodiments wherein the multi-modal fastener 4100 is tri-modal, the length of material 4105 is configured to adopt a third stable resting configuration when a significant force is applied to it to transition the length of material from the second stable resting configuration to the third stable resting configuration.

In some embodiments, such as that shown in FIGS. 29-30, the length of material 4105 includes a spring steel component that has a generally arcuate cross-sectional shape 4107, when viewed along its longitudinal direction (e.g., from second end 4114 towards first end 4112), when the length of material 4105 adopts its first stable generally flat or planar resting configuration (FIG. 30). Upon activation by a user, the spring steel component of the length of material 4105 adopts the second stable generally coil-shaped resting configuration, in which the spring steel component has a generally flat cross-sectional shape, when viewed along the same longitudinal direction (FIG. 29).

The curved shape (e.g., coil shape or loop shape) of the second stable resting configuration may be any shape that places the securing portion 4135 and the mating portion 4125 in close proximity. For example and without limitation, the curved shape may include a cross-sectional profile that is a circle, an oval, a triangle, a rectangle, a D-shape, a discorectangle, a pear shape, or an asymmetrical version of any of the foregoing.

The first face 4116 includes a securing portion 4135 near the second end 4114. The securing portion 4135 includes at least one securing feature 4130 capable of selectively and reversibly mating with the mating portion 4125. For example, the securing feature 4130 may include any one or more of: a ratchet tooth, hook-and-loop material, a magnet, a snap, a button, a relatively high-friction surface, self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)), and/or glue.

The second face 4118 includes a mating portion 4125 configured to selectively and reversibly mate with the securing portion 4135, for example when the multi-modal fastener 4100 is in the second stable resting configuration. The mating portion 4125 includes at least one mating feature 4120 configured to selectively and reversibly mate with the at least one securing feature 4130 of the securing portion 4135. For example, the mating feature 4120 may include any one or more of: a receiving pawl that mates with a ratchet tooth 4130, hook-and-loop material complementary to hook-and-loop material of the securing portion 4135, a magnet, a snap, a button socket, a relatively high-friction surface, self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)), and/or glue.

In embodiments wherein the mating feature 4135 includes at least one locking tooth, such as the embodiments specifically shown in FIGS. 25A-28, the at least one locking tooth 4130 may feature any suitable shape and size sufficient to releasably engage with at least one receiving pawl 4120 of the mating portion 4125. In the embodiments specifically shown in FIGS. 25A-28, for example, the at least one locking tooth 4130 comprises a plurality of locking teeth each having a wedge-shaped cross-sectional profile. The wedge-shaped cross-sectional profile of the at least one locking tooth 4130 specifically shown in FIGS. 25A-28 allows the first mating feature 4130 to slide over and in contact with the at least one receiving pawl 4120 to tighten the multi-modal fastener 4100, while preventing the securing feature 4130 from sliding over and in contact with the at least one receiving pawl 4120 to loosen the multi-modal fastener 4100. Although the embodiment shown in FIGS. 25A-28 shows the at least one locking tooth 4130 as extending across the entire width of the first face 4116, other embodiments may include the at least one locking tooth 4130 as having a width that is narrower than the width of the first face 4116. In embodiments wherein the mating portion 4125 includes a receiving pawl 4120, the receiving pawl(s) 4120 may have any suitable shape and size, so long as they effectively reversibly mate with at least one of the at least one locking tooth 4130. Although the embodiment shown in FIGS. 25A-28 shows the at least one receiving pawl 4120 as extending across the entire width of the second face 4118, other embodiments may include the at least one receiving pawl 4120 as having a width that is narrower than the width of the second face 4118.

In some embodiments, the fastener 4100 includes a handle configured to enable a user to conveniently grasp the fastener 4100. In some embodiments, the handle is associated with the length of material; in some embodiments, the handle is disposed on (or as part of) the cover 4116a/4118a. In some embodiments, the handle includes a loop of material or a strap of material configured to enable convenient grasping by a user.

In some embodiments, the length of material 4105 includes a throughhole disposed therethrough. The throughhole enables attachment (e.g., reversible attachment) of the fastener 4100 to an object such as a wall.

Referring now to FIG. 31A, a fastener 4100 consistent with the present disclosure may include a fastener 4140 is associated with the first face 4116 for attaching to a mount 4150 or to a second fastener 4100. The fastener 4140 may include a screw, nail, staple, snap, a magnet, and/or an adhesive. In some embodiments, the fastener 4140 is disposed generally equidistant between the first end 4112 and the second end 4114. In other embodiments, the fastener 4140 is disposed closer to the first end 4112 than the second end 4114. In still other embodiments, the fastener 4140 is disposed closer to the second end 4114 than the first end 4112.

Referring now to FIG. 31B, in some embodiments, the fastener 4100 is configured to reversibly mate with a mount 4150. In some embodiments, the mount 4150 is configured to reversibly mate with a plurality of fasteners 4100. In such embodiments, one or more loose objects (e.g., cables CB) can be retained in a plurality of fasteners 4100 that are mated with a mount 4150. By using a plurality of fasteners 4100 in this manner, the loose object(s) can be routed and easily managed, reducing installation and maintenance time. In some embodiments, the loose object(s) are data cables (e.g., copper data cables), fiber optic cables (e.g., premise distribution fiber optic cables), and/or power cables.

Referring now to FIG. 32, in some embodiments, the fastener 4100 further comprises a writable surface 4160. The writable surface 4160 is configured to enable a user to label the fastener 4100, for example by writing letters, numbers, and/or symbols on the writable surface 4160 using a writing instrument (e.g., a pen, a pencil, or a marker). In some embodiments, the writable surface 4160 is disposed on the cover 4116a/4118a. In some embodiments, the writable surface 4160 is disposed proximate to the first end 4112. In other embodiments, the writable surface 4160 is disposed proximate to the second end 4114.

Referring now to FIG. 33, in some embodiments, the fastener 4100 includes a handle 4170 configured to enable a user to conveniently carry the fastener 4100 and any loose object(s) retained therein. In some embodiments, the handle 4170 is disposed on the first surface 4116. In some embodiments, the handle 4170 is disposed proximate to the first end 4112. In other embodiments, the handle 4170 is disposed proximate to the securing portion 4135. In still other embodiments, the handle 4170 is disposed between the first end 4112 and the second end 4114, for example approximately equidistant from the first end 4112 and the second end 4114.

Referring now to FIGS. 34A-34B, the mating portion 4125 in some embodiments is disposed on a mating tab 4180 that extends from the first end 4112 of the fastener 4100. In such embodiments, the mating portion 4125 is not disposed on the cover 4116a/4118a, or as a portion of the second surface 4118. Because the length of material 4105 does not extend into or through the mating tab 4180, the mating tab 4180 is not required to adopt a second stable resting configuration. The mating tab 4180 may be flexible, rigid, or semirigid, and may be formed of any suitable material capable of forming mating features 4120 that have a rigidity sufficient to reversibly mate with the securing features 4130 of the securing portion 4135. For example and without limitation, in some embodiments the mating tab 4180 is formed of a nylon webbing material, and the mating features 4120 are formed of a polyethylene resin and adhered to the mating tab 4180 by glue or fasteners. In some embodiments, the mating tab 4180 is secured between the first cover piece 4116a and the second cover piece 4118a.

In operation, a user may in some embodiments retain one or more loose objects, such as cables, cords, strings, ropes, etc., hoses, electronic devices, utilities, and/or any other suitable object in the multi-modal fastener 4100 consistent with the present disclosure by causing the multi-modal fastener 4100 to transition from a first stable resting configuration that is generally planar to a second stable resting configuration that is generally curved while the loose object(s) are in close proximity to the second face 4118, such that the multi-modal fastener 4100 wraps around or substantially around the loose object(s). The user may then push the first end 4112 towards the securing portion 4135, eventually sliding the first end 4112 past the at least one securing feature 4130 until at least a portion of the securing portion 4135 engages with at least a portion of the mating portion 4125. Thereafter, the user may retain additional loose objects in the multi-modal fastener 4100, if desired, by first pulling the first end 4112 away from the first face 4116 until the securing portion 4135 disengages from the mating portion 4125, then passing the additional loose object(s) into the gap formed between the first end 4112 and the first face 4116, and then pushing the first end 4112 towards the securing portion 4135 until at least a portion of the securing portion 4135 engages with at least a portion of the mating portion 4125. Removing the loose object(s) from the fastener 4100 may be accomplished by first pulling the first end 4112 away from the first face 4116 until the mating portion 4125 disengages from the securing portion 4135, and then passing the loose object(s) out of the gap formed between the first end 4112 and the first face 4116.

In some embodiments, the present disclosure provides a multi-modal fastener including a first end, a second end opposite the first end, a first face, and a second face opposite the first face, the multi-modal fastener comprising: a length of material extending substantially from the first end to the second end; a securing portion disposed on the first face proximal to the second end; and a mating portion disposed on the second face proximal to the first end and configured to reversibly mate with the securing portion, wherein the length of material is movable between a first stable resting configuration and a second stable resting configuration. In some embodiments, the securing portion and the mating portion are separated by a substantially maximum distance when the fastener is in the first resting configuration. In some embodiments, the first resting configuration comprises a generally planar configuration. In some embodiments, the securing portion comprises at least one securing feature configured to reversibly mate with the mating portion. In some embodiments, the at least one securing feature includes at least one tooth. In some embodiments, the mating portion comprises at least one mating feature configured to reversibly mate with the securing portion. In some embodiments, the at least one mating feature comprises at least one locking pawl. In some embodiments, the securing portion comprises at least one securing tooth, and wherein the mating portion comprises at least one locking pawl configured to reversibly mate with the at least one securing tooth. In some embodiments, the multi-modal fastener further comprises a cover surrounding the length of material, wherein the cover includes the securing portion and the mating portion. In some embodiments, the length of material comprises a length of spring steel having a generally arcuate cross-sectional shape when viewed along its longitudinal axis when the multi-modal fastener adopts the first stable resting configuration, wherein the first stable resting configuration is generally planar.

In some embodiments, the present disclosure provides a bi-modal fastener including a first end, a second end opposite the first end, the bi-modal fastener comprising: a bi-modal length of material extending substantially from the first end to the second end and configured to selectably adopt a first stable generally planar resting configuration and a second stable generally coil-shaped resting configuration; a cover substantially surrounding the bi-modal length of material and including a first face, and a second face opposite the first face; a mating portion comprising at least one mating feature disposed proximal to the first end and on the second face; and a securing portion comprising a plurality of securing features disposed proximal to the second end and on the first face, wherein the plurality of securing features are each configured to reversibly mate with the at least one mating feature. In some embodiments, the bi-modal length of material comprises spring steel having a generally arcuate cross-sectional shape when viewed along its longitudinal axis and when the bi-modal length of material adopts the first stable generally planar resting configuration. In some embodiments, the bi-modal length of material comprises spring steel having a generally planar cross-sectional shape when viewed along its longitudinal axis and when the bi-modal length of material adopts the second stable generally coil-shaped resting configuration. In some embodiments, the at least one mating feature comprises a locking pawl. In some embodiments, the at least one securing feature comprises a tooth. In some embodiments, the fastener further comprises a handle associated with the length of material. In some embodiments, the length of material further comprises a throughhole disposed therethrough. In some embodiments, the fastener is configured to reversibly mate with a mount. In some embodiments, the mount is configured to reversibly mate with a plurality of fasteners. In some embodiments, the fastener further comprises a writable surface.

“Wire Comb” Multi-Modal Fasteners

Referring now generally to FIGS. 35-50, the present disclosure provides fasteners and methods of using same.

Generally, multi-modal fasteners of the present disclosure can be selectively converted from a first stable generally planar resting configuration (e.g., an “open resting configuration”), to a second stable generally loop-shaped or coil-shaped resting configuration (e.g., a “closed” resting configuration).

A multi-modal fastener 5100 consistent with the present disclosure includes a first end 5112, a second end 5114 opposite the first end, a first face 5116, and a second face 5118 opposite the first face 5116. The multi-modal fastener 5100 includes a cable grip feature 5140 configured to receive loose objects such as electrical cables, ropes, etc. Retention of loose objects using multi-modal fasteners 5100 consistent with the present disclosure provides convenient guidance of the loose objects by reducing entanglement of multiple retained objects. In addition, retention of loose objects using multi-modal fasteners 5100 consistent with the present disclosure enable convenient removal of any one selected retained object with minimal or no disruption of the remaining retained objects. Furthermore, the high degree of organization of multiple retained objects enabled by multi-modal fasteners 5100 of the present disclosure allows easy tracing of any one retained object from a point on one side of the multi-modal fastener 5100 to a point on the other side of the multi-modal fastener 5100, even when many of the retained objects looks confusingly similar to each other and are not labeled.

The multi-modal fastener 5100 maintains a first stable resting configuration until a significant force is applied to induce it to adopt a second stable resting configuration. The multi-modal fastener 5100 remains substantially stable in that second stable resting configuration until a significant force is applied to the multi-modal fastener 5100 to induce it to return to the first stable resting configuration (or to adopt a third stable resting configuration). In some embodiments, the first stable resting configuration is planar or substantially planar. In some embodiments, the second stable resting configuration is generally loop-shaped or coil-shaped. In some embodiments, the multi-modal fastener 5100 is bi-modal—that is, it is configured to adopt exactly two distinct stable resting configurations. In other embodiments, the multi-modal fastener 5100 is tri-modal. In still other embodiments, the multi-modal fastener is capable of adopting four or more substantially stable configurations.

In the embodiment specifically illustrated in FIGS. 35-40, for example, the multi-modal fastener 5100 is a bi-modal fastener 5100 that maintains a first stable resting configuration that is substantially planar (FIGS. 37-38B), referred to herein as an “open configuration.” The bi-modal fastener 5100, upon application of a significant force, adopts and maintains a second stable resting configuration that is curved (FIGS. 35-36), referred to herein as a “closed configuration.” The term “closed configuration” as used with respect to Wire Comb Multi-modal Fasteners disclosed herein includes configurations wherein the first end 5112 and the second end 5114 are in close proximity but not in contact with each other, and also to configurations wherein the first end 5112 and the second end 5114 are in contact with each other and/or overlapping (e.g., “mated”; FIGS. 35-36).

In some embodiments, such as the embodiment shown specifically in FIGS. 36 and 38A-40, the multi-modal fastener 5100 comprises a length of material 5105 disposed inside a cover 5116a/5118a. In some embodiments, the cover 5116a/5118a includes a first cover piece 5116a and a second cover piece 5118a that, in combination, form the cover 5116a/5118a. The cover 5116a/5118a may comprise, consist essentially of, or consist of any suitable relatively flexible material including, for example and without limitation, a polymer, fabric, metal, or a combination thereof. The length of material 5105 may comprise, consist essentially of, or consist of a metal (e.g., steel, stainless steel, etc.), polymer, fiber, carbon fiber, or a combination thereof. In other embodiments, the fastener 5100 comprises a length of material 5105 that is coated, covered, painted, extruded, dipped, or molded to provide a first face 5116 on one surface of the length of material 5105 and a second face 5118 on a second, opposite surface of the length of material 5105. In some embodiments, the first cover piece 5116a comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the second cover piece 5118a comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover piece 5116a and the second cover piece 5118a each comprise a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover piece 5116a is connected to the second cover piece 5118a through one or more holes (not shown) in the length of material 5105, for example to reduce or eliminate slippage of the cover 5116a/5118a over the length of material 5105.

In embodiments wherein the multi-modal fastener 5100 is bi-modal, the length of material 5105 maintains a first stable resting configuration (e.g., a generally planar resting configuration as shown in FIGS. 37-38B) until a significant force is applied to induce it to adopt a second stable resting configuration (e.g., a generally coil-shaped configurations as shown in FIGS. 35-36); the length of material 5105 remains substantially stable in that second stable resting configuration until a significant force is applied to it to induce it to return to the first stable resting configuration. In some embodiments wherein the multi-modal fastener 5100 is tri-modal, the length of material 5105 is configured to adopt a third stable resting configuration when a significant force is applied to it to transition the length of material from the first stable resting configuration to the third stable resting configuration. In some embodiments wherein the multi-modal fastener 5100 is tri-modal, the length of material 5105 is configured to adopt a third stable resting configuration when a significant force is applied to it to transition the length of material from the second stable resting configuration to the third stable resting configuration.

In some embodiments, such as that shown in FIGS. 39-40, the length of material 5105 includes a spring steel component that has a generally arcuate cross-sectional shape 5107, when viewed along its longitudinal direction (e.g., from second end 5114 towards first end 5112), when the length of material 5105 adopts its first stable generally flat or planar resting configuration (FIG. 40). Upon activation by a user, the spring steel component of the length of material 5105 adopts the second stable generally coil-shaped resting configuration, in which the spring steel component has a generally flat cross-sectional shape, when viewed along the same longitudinal direction (FIG. 39).

The curved shape (e.g., coil shape or loop shape) of the second stable resting configuration may be any shape that places the first end 5112 and the second end 5114 in close proximity (e.g., near each other, in contact with each other, or overlapping with each other). For example and without limitation, the curved shape may include a cross-sectional profile that is a circle, an oval, a triangle, a rectangle, a D-shape, a discorectangle, a pear shape, or an asymmetrical version of any of the foregoing.

The multi-modal fastener 5100 includes at least one cable grip feature 5140 configured to receive (e.g., reversibly receive) a loose object such as a cable, a rope, a string, a wire, or any other suitably sized loose object. In some embodiments, the cable grip feature(s) 5140 includes a first flexible flap 5140a and a second flap 5140b opposing the first flexible flap 5140a. The flexible flaps 5140a, 5140b are configured to temporarily retain a loose object by, for example, flexing away from each other as a loose object is forced between the first flexible flap 5140a and the second flexible flap 5140b. Resilient forces inherent in the first flexible flap 5140a and the second flexible flap 5140b act to retain the loose object between the first flexible flap 5140a and the second flexible flap 5140b once the loose object has been inserted therebetween. Removal of the retained loose object may be accomplished by pulling on the loose object with a force sufficient to overcome the resilient forces imparted on the loose object by the first flexible flap 5140a and the second flexible flap 5140b. In some embodiments, the cable grip feature 5140 further includes a base 5140c disposed between the first flexible flap 5140a and the cover 5116a/5118a and disposed between the second flexible flap 5140b and the cover 5116a/5118a. In some embodiments, the cover 5116a/5118a includes the cable grip feature(s) 5140. In embodiments including more than one cable grip feature 5140, spacing 5140d between adjacent cable grip features 5140 may be determined by measuring the distance between analogous points on adjacent cable grip features 5140. For example, as shown in FIG. 38B, spacing between adjacent cable grip features 5140 may be determined by measuring the distance 5140d between the outermost edge of the first flexible flap 5140a of a first cable grip feature 5140 to the outermost edge of the first flexible flap 5140a of an immediate adjacent cable grip feature 5140.

Referring now to FIG. 38C, the cable grip feature(s) 5140 may each include a pair of opposing flaps 5140a,5140b configured to selectively retain a loose object. The opposing flaps 5140a,5140b are configured to temporarily retain a loose object by, for example, flexing away from each other as a loose object is forced between the first opposing flap 5140a and the second opposing flap 5140b. The shape and resilient forces inherent in the first opposing flap 5140a and the second opposing flap 5140b act to retain the loose object between the first opposing flap 5140a and the second opposing flap 5140b once the loose object has been inserted therebetween. Removal of the retained loose object may be accomplished by pulling on the loose object with a force sufficient to overcome the shape and resilient forces imparted on the loose object by the first opposing flap 5140a and the second opposing flap 5140b. In some embodiments, the cover 5116a/5118a includes the cable grip feature(s) 5140. In embodiments including more than one cable grip feature 5140, spacing 5140d between adjacent cable grip features 5140 may be determined by measuring the distance between analogous points on adjacent cable grip features 5140. For example, as shown in FIG. 38C, spacing between adjacent cable grip features 5140 may be determined by measuring the distance 5140d between the outermost edge of the first opposing flap 5140a of a first cable grip feature 5140 to the outermost edge of the first opposing flap 5140a of an immediate adjacent cable grip feature 5140.

In some embodiments, such as that shown representatively in FIG. 42B, the second face 5118 includes a securing portion 5135 near the second end 5114. The securing portion 5135 includes at least one securing feature 5130 capable of selectively and reversibly mating with the mating portion 5125. For example, the securing feature 5130 may include any one or more of: a ratchet tooth, hook-and-loop material, a magnet, a snap, a button, a relatively high-friction surface, self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)), and/or glue. The first face 5116 includes a mating portion 5125 configured to selectively and reversibly mate with the securing portion 5135, for example when the multi-modal fastener 5100 is in the second stable resting configuration. The mating portion 5125 includes at least one mating feature 5120 configured to selectively and reversibly mate with the at least one securing feature 5130 of the securing portion 5135. For example, the mating feature 5120 may include any one or more of: a receiving pawl that mates with a ratchet tooth, hook-and-loop material complementary to hook-and-loop material of the securing portion 5135, a magnet, a snap, a button socket, a relatively high-friction surface, self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)), and/or glue.

In embodiments wherein the securing feature 5130 includes at least one locking tooth, the at least one locking tooth may feature any suitable shape and size sufficient to releasably engage with at least one receiving pawl 5120 of the mating portion 5125. In some embodiments, the at least one locking tooth 5130 comprises a plurality of locking teeth 5130 each having a wedge-shaped cross-sectional profile. The wedge-shaped cross-sectional profile of the at least one locking tooth allows the first mating feature to slide over and in contact with the at least one receiving pawl 5120 to tighten the multi-modal fastener 5100, while preventing the securing feature 5130 from sliding over the at least one receiving pawl 5120 to loosen the multi-modal fastener 5100. In some embodiments, the at least one locking tooth 5130 extends across the entire width of the second face 5118. In other embodiments, the at least one locking tooth 5130 has a width that is narrower than the width of the second face 5118. In embodiments wherein the mating portion 5125 includes a receiving pawl 5120, the receiving pawl(s) 5120 may have any suitable shape and size, so long as they effectively reversibly mate with at least one of the at least one locking teeth 5130. In some embodiments, the at least one receiving pawl 5120 extends across the entire width of the first face 5116. In other embodiments, the at least one receiving pawl 5120 has width that is narrower than the width of the first face 5116.

In operation, a user may in some embodiments retain one or more loose objects, such as cables, cords, strings, ropes, etc., hoses, electronic devices, utilities, and/or any other suitable object in the multi-modal fastener 5100 consistent with the present disclosure by inserting the loose object(s) into the at least one cable grip features 5140, and then causing the multi-modal fastener 5100 to transition from a first stable resting configuration that is generally planar to a second stable resting configuration that is generally curved while the loose object(s) are in close proximity to the second face 5118, such that the multi-modal fastener 5100 wraps around or substantially around the loose object(s). Thereafter, the user may retain additional loose objects in the multi-modal fastener 5100, if desired, by first pulling the second end 5114 away from the first end 5112, passing the additional loose object(s) into the gap formed between the second end 5114 and the first face 5116, and inserting the additional loose object(s) into additional cable grip features 5140. Removing the loose object(s) from the multi-modal fastener 5100 may be accomplished by first pulling the object away from the cable grip feature 5140 in which the object is retained, pulling the second end 5114 away from the first face 5116, and then passing the loose object(s) out of the gap formed between the second end 5114 and the first face 5116.

Referring now to FIGS. 41-46, a multi-modal fastener 5100 consistent with another embodiment of the present disclosure includes at least one internal cable grip feature 5140 and at least one external cable grip feature 5145. In the embodiment specifically shown in FIGS. 41-46, the multi-modal fastener 5100 is a bi-modal fastener 5100 that maintains a first stable resting configuration that is substantially planar (FIGS. 43-44B), referred to herein as an “open configuration.” The bi-modal fastener 5100, upon application of a significant force, adopts and maintains a second stable resting configuration that is curved (FIGS. 41-42), referred to herein as a “closed configuration.” In the closed configuration, the at least one internal cable grip 5140 is disposed inside the closed shape formed by the multi-modal fastener 5100, while the at least one external cable grip 5145 is disposed on the outside of the closed shape formed by the multi-modal fastener 5100. The term “closed configuration” as used with respect to embodiments consistent with FIGS. 41-46 includes configurations wherein the first end 5112 and the second end 5114 are in close proximity but not in contact with each other, and also to configurations wherein the first end 5112 and the second end 5114 are in contact with each other and/or overlapping (e.g., “mated”; FIGS. 41-42).

In some embodiments, such as the embodiment shown specifically in FIGS. 42 and 44A-46, the multi-modal fastener 5100 comprises a length of material 5105 disposed inside a cover 5116a/5118a. In some embodiments, the cover 5116a/5118a includes a first cover piece 5116a and a second cover piece 5118a that, in combination, form the cover 5116a/5118a. The cover 5116a/5118a may comprise, consist essentially of, or consist of any suitable relatively flexible material including, for example and without limitation, a polymer, fabric, metal, or a combination thereof. The length of material 5105 may comprise, consist essentially of, or consist of a metal (e.g., steel, stainless steel, etc.), polymer, fiber, carbon fiber, or a combination thereof. In other embodiments, the fastener 5100 comprises a length of material 5105 that is coated, covered, painted, extruded, dipped, or molded to provide a first face 5116 on one surface of the length of material 5105 and a second face 5118 on a second, opposite surface of the length of material 5105. In some embodiments, the first cover piece 5116a comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the second cover piece 5118a comprises a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover piece 5116a and the second cover piece 5118a each comprise a self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), or a repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)). In some embodiments, the first cover piece 5116a is connected to the second cover piece 5118a through one or more holes (not shown) in the length of material 5105, for example to reduce or eliminate slippage of the cover 5116a/5118a over the length of material 5105.

In embodiments wherein the multi-modal fastener 5100 is bi-modal, the length of material 5105 maintains a first stable resting configuration (e.g., a generally planar resting configuration as shown in FIGS. 43-44B) until a significant force is applied to induce it to adopt a second stable resting configuration (e.g., a generally coil-shaped configurations as shown in FIGS. 41-42); the length of material 5105 remains substantially stable in that second stable resting configuration until a significant force is applied to it to induce it to return to the first stable resting configuration. In some embodiments wherein the multi-modal fastener 5100 is tri-modal, the length of material 5105 is configured to adopt a third stable resting configuration when a significant force is applied to it to transition the length of material from the first stable resting configuration to the third stable resting configuration. In some embodiments wherein the multi-modal fastener 5100 is tri-modal, the length of material 5105 is configured to adopt a third stable resting configuration when a significant force is applied to it to transition the length of material from the second stable resting configuration to the third stable resting configuration.

In some embodiments, such as that shown in FIGS. 45-46, the length of material 5105 includes a spring steel component that has a generally arcuate cross-sectional shape 5107, when viewed along its longitudinal direction (e.g., from second end 5114 towards first end 5112), when the length of material 5105 adopts its first stable generally flat or planar resting configuration (FIG. 46). Upon activation by a user, the spring steel component of the length of material 5105 adopts the second stable generally coil-shaped resting configuration, in which the spring steel component has a generally flat cross-sectional shape, when viewed along the same longitudinal direction (FIG. 45).

The curved shape (e.g., coil shape or loop shape) of the second stable resting configuration may be any shape that places the first end 5112 and the second end 5114 in close proximity (e.g., near each other, in contact with each other, or overlapping with each other). For example and without limitation, the curved shape may include a cross-sectional profile that is a circle, an oval, a triangle, a rectangle, a D-shape, a discorectangle, a pear shape, or an asymmetrical version of any of the foregoing.

The multi-modal fastener 5100 includes at least one internal cable grip feature 5140 configured to receive (e.g., reversibly receive) a loose object such as a cable, a rope, a string, a wire, or any other suitably sized loose object. In some embodiments, the internal cable grip feature(s) 5140 includes a first flexible flap 5140a and a second flap 5140b opposing the first flexible flap 5140a. The flexible flaps 5140a,5140b are configured to temporarily retain a loose object by, for example, flexing away from each other as a loose object is forced between the first flexible flap 5140a and the second flexible flap 5140b. Resilient forces inherent in the first flexible flap 5140a and the second flexible flap 5140b act to retain the loose object between the first flexible flap 5140a and the second flexible flap 5140b once the loose object has been inserted therebetween. Removal of the retained loose object may be accomplished by pulling on the loose object with force sufficient to overcome the resilient forces imparted on the loose object by the first flexible flap 5140a and the second flexible flap 5140b. In some embodiments, the internal cable grip feature 5140 further includes a base 5140c disposed between the first flexible flap 5140a and the cover 5116a/5118a and disposed between the second flexible flap 5140b and the cover 5116a/5118a. In some embodiments, the cover 5116a/5118a includes the internal cable grip feature(s) 5140.

The multi-modal fastener 5100 includes at least one external cable grip feature 5145 configured to receive (e.g., reversibly receive) a loose object such as a cable, a rope, a string, a wire, or any other suitably sized loose object. In some embodiments, the external cable grip feature(s) 5145 includes a first flexible flap 5145a and a second flap 5145b opposing the first flexible flap 5145a. The flexible flaps 5145a,5145b are configured to temporarily retain a loose object by, for example, flexing away from each other as a loose object is forced between the first flexible flap 5145a and the second flexible flap 5145b. Resilient forces inherent in the first flexible flap 5145a and the second flexible flap 5145b act to retain the loose object between the first flexible flap 5145a and the second flexible flap 5145b once the loose object has been inserted therebetween. Removal of the retained loose object may be accomplished by pulling on the loose object with force sufficient to overcome the resilient forces imparted on the loose object by the first flexible flap 5145a and the second flexible flap 5145b. In some embodiments, the external cable grip feature 5145 further includes a base 5145c disposed between the first flexible flap 5145a and the cover 5116a/5118a and disposed between the second flexible flap 5145b and the cover 5116a/5118a. In some embodiments, the cover 5116a/5118a includes the external cable grip feature(s) 5145.

The internal cable grip feature(s) 5140 and the external cable grip feature(s) 5145 may independently include different shapes, for example the shape of the first opposing flap 5140a and the second opposing flap 5140b shown in FIG. 38B.

Referring now specifically to FIG. 44B, in some embodiments, the internal cable grip features 5140 and the external cable grip features 5145 are aligned with each other across the cover 5116a/5118a. In other embodiments, such as that shown representatively in FIG. 44C, the internal cable grip features 5140 are not aligned with the external cable grip features 5145 across the cover 5116a/5118a, but are instead offset from each other. In some embodiments, the offset between the internal cable grip features 5140 and the external cable grip features 5145 is substantially regular, and may be quantified by an offset distance θ. In some embodiments, the offset distance is equal to the distance between an internal cable grip feature center line 5140c1 and the center line 5145c1 of the nearest opposing external cable grip 5145.

In some embodiments, the second face 5118 includes a securing portion 5135 near the second end 5114. The securing portion 5135 includes at least one securing feature 5130 capable of selectively and reversibly mating with the mating portion 5125. For example, the securing feature 5130 may include any one or more of: a ratchet tooth, hook-and-loop material, a magnet, a snap, a button, a relatively high-friction surface, self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)), and/or glue. The first face 5116 includes a mating portion 5125 configured to selectively and reversibly mate with the securing portion 5135, for example when the multi-modal fastener 5100 is in the second stable resting configuration. The mating portion 5125 includes at least one mating feature 5120 configured to selectively and reversibly mate with the at least one securing feature 5130 of the securing portion 5135. For example, the mating feature 5120 may include any one or more of: a receiving pawl that mates with a ratchet tooth, hook-and-loop material complementary to hook-and-loop material of the securing portion 5135, a magnet, a snap, a button socket, a relatively high-friction surface, self-fusing material (e.g., FLEX SEAL Products “Flex Tape,” 3M 583 Bonding Film (cat. no. S-14909), MOCAP's “X-Treme Tape” (cat. no. TPE-XR1536R), LOCTITE GO2 Repair Wrap (cat. nos. 1794791, 1958735, 1872161), SCOTCH Self-Fusing Silicone Rubber Electrical Tape 70 (cat. no. 15603), TOMMY TAPE Miracle Wrap (cat. nos. MW2010010XX-T, VP1014, VP 9901)), repositionable self-fusing material (e.g., Hugo's Amazing Tape for example as described in U.S. Pat. No. 6,230,711, NASHUA STRETCH & SEAL Self-Fusing Silicone Tape (cat. no. 684201), or Harbor Products F4 Tape (cat. no. CECOMINOD026831)), and/or glue.

In embodiments wherein the securing feature 5130 includes at least one locking tooth, the at least one locking tooth 5130 may feature any suitable shape and size sufficient to releasably engage with at least one receiving pawl 5120 of the mating portion 5125. In some embodiments, the at least one locking tooth 5130 comprises a plurality of locking teeth 5130 each having a wedge-shaped cross-sectional profile. The wedge-shaped cross-sectional profile of the at least one locking tooth 5130 allows the securing feature 5135 to slide over and in contact with the at least one receiving pawl 5120 to tighten the multi-modal fastener 5100, while preventing the securing feature 5130 from sliding over the at least one receiving pawl 5120 to loosen the multi-modal fastener 5100. In some embodiments, the at least one locking tooth 5130 extends across the entire width of the second face 5118. In other embodiments, the at least one locking tooth has a width that is narrower than the width of the second face 5118. In embodiments wherein the mating portion 5125 includes a receiving pawl, the receiving pawl(s) 5120 may have any suitable shape and size, so long as they effectively reversibly mate with at least one of the at least one locking teeth. In some embodiments, the at least one receiving pawl 5120 extends across the entire width of the first face 5116.

In other embodiments, the at least one receiving pawl has width that is narrower than the width of the first face 5116. In some embodiments, the securing portion 5135 and the mating portion 5125 are disposed on the same face of the multi-modal fastener 5100. For example, in some embodiments, the securing portion 5135 is disposed on the first face 5116, and the mating portion 5125 is also disposed on the first face 5116. In other embodiments, the securing portion 5135 is disposed on the second face 5118, and the mating portion 5125 is also disposed on the second face 5118.

Referring now to FIGS. 47-50, a multi-modal fastener 5100 according to some embodiments of the present disclosure include at least one external cable grip feature 5145 configured to receive (e.g., reversibly receive) a loose object such as a cable, a rope, a string, a wire, or any other suitably sized loose object. In some embodiments, the external cable grip feature(s) 5145 includes a first flexible flap 5145a and a second flap 5145b opposing the first flexible flap 5145a. The flexible flaps 5145a,5145b are configured to temporarily retain a loose object by, for example, flexing away from each other as a loose object is forced between the first flexible flap 5145a and the second flexible flap 5145b. Resilient forces inherent in the first flexible flap 5145a and the second flexible flap 5145b act to retain the loose object between the first flexible flap 5145a and the second flexible flap 5145b once the loose object has been inserted therebetween. Removal of the retained loose object may be accomplished by pulling on the loose object with a force sufficient to overcome the resilient forces imparted on the loose object by the first flexible flap 5145a and the second flexible flap 5145b. In some embodiments, the external cable grip feature 5145 further includes a base 5145c disposed between the first flexible flap 5145a and the cover 5116a/5118a and disposed between the second flexible flap 5145b and the cover 5116a/5118a. In some embodiments, the cover 5116a/5118a includes the external cable grip feature(s) 5145. In embodiments including more than one external cable grip feature 5145, spacing 5145d between adjacent external cable grip features 5145 may be determined by measuring the distance between analogous points on adjacent external cable grip features 5145. For example, as shown in FIG. 48B, spacing between adjacent cable grip features 5145 may be determined by measuring the distance 5145d between the outermost edge of the first flexible flap 5145a of a first external cable grip feature 5145 to the outermost edge of the first flexible flap 5145a of an immediate adjacent external cable grip feature 5145.

Referring now to FIG. 48C, the external cable grip feature(s) 5145 may each include a pair of opposing flaps 5145a,5145b configured to selectively retain a loose object. The opposing flaps 5145a,5145b are configured to temporarily retain a loose object by, for example, flexing away from each other as a loose object is forced between the first opposing flap 5145a and the second opposing flap 5145b. The shape and resilient forces inherent in the first opposing flap 5145a and the second opposing flap 5145b act to retain the loose object between the first opposing flap 5140a and the second opposing flap 5145b once the loose object has been inserted therebetween. Removal of the retained loose object may be accomplished by pulling on the loose object with a force sufficient to overcome the shape and resilient forces imparted on the loose object by the first opposing flap 5145a and the second opposing flap 5145b. In some embodiments, the cover 5116a/5118a includes the external cable grip feature(s) 5145. In embodiments including more than one cable grip feature 5145, spacing 5145d between adjacent cable grip features 5145 may be determined by measuring the distance between analogous points on adjacent external cable grip features 5145. For example, as shown in FIG. 48C, spacing between adjacent external cable grip features 5145 may be determined by measuring the distance 5145d between the outermost edge of the first opposing flap 5145a of a first external cable grip feature 5145 to the outermost edge of the first opposing flap 5145a of an immediate adjacent external cable grip feature 5145.

In some embodiments, such as that shown in FIGS. 49-50, the length of material 5105 includes a spring steel component that has a generally arcuate cross-sectional shape 5107, when viewed along its longitudinal direction (e.g., from second end 5114 towards first end 5112), when the length of material 5105 adopts its first stable generally flat or planar resting configuration (FIG. 50). Upon activation by a user, the spring steel component of the length of material 5105 adopts the second stable generally coil-shaped resting configuration, in which the spring steel component has a generally flat cross-sectional shape, when viewed along the same longitudinal direction (FIG. 49).

The curved shape (e.g., coil shape or loop shape) of the second stable resting configuration may be any shape that places the first end 5112 and the second end 5114 in close proximity (e.g., near each other, in contact with each other, or overlapping with each other). For example and without limitation, the curved shape may include a cross-sectional profile that is a circle, an oval, a triangle, a rectangle, a D-shape, a discorectangle, a pear shape, or an asymmetrical version of any of the foregoing.

In operation, a user may in some embodiments retain one or more loose objects, such as cables, cords, strings, ropes, etc., hoses, electronic devices, utilities, and/or any other suitable object in the multi-modal fastener 5100 consistent with the present disclosure by inserting the loose object(s) into the at least one internal cable grip features 5140, and then causing the multi-modal fastener 5100 to transition from a first stable resting configuration that is generally planar to a second stable resting configuration that is generally curved while the loose object(s) are in close proximity to the second face 5118, such that the multi-modal fastener 5100 wraps around or substantially around the loose object(s). Additional loose objects may be retained in the external cable grip(s) 5145 either before or after the multi-modal fastener 5100 adopts its second closed stable resting configuration by inserting the loose object into an external cable grip feature 5145. Thereafter, the user may retain additional loose objects in the multi-modal fastener 5100, if desired, by first pulling the second end 5114 away from the first face 5116, passing the additional loose object(s) into the gap formed between the second end 5114 and the first face 5116, and inserting the additional loose object(s) into additional internal cable grip features 5140. Additional loose objects may be also be retained without separating the first end 5112 and the second end 5114 by inserting the additional loose object in an external cable grip feature 5145. Removing the loose object(s) from the multi-modal fastener 5100 may be accomplished by first pulling the object away from the internal cable grip feature 5140 in which the object is retained, pulling the second end 5114 away from the first face 5116, and then passing the loose object(s) out of the gap formed between the second end 5114 and the first face 5116. Removing an object from the external cable grip feature 5145 may be accomplished by pulling the object away from the first face 5116 without separating the first end 5112 and the second end 5114.

In some embodiments, the present disclosure provides a multi-modal fastener including a first end, a second end opposite the first end, a first face, and a second face opposite the first face, the multi-modal fastener comprising: a length of material extending substantially from the first end to the second end; and at least one cable grip feature disposed on the second face, wherein the length of material is movable between a first stable resting configuration and a second stable resting configuration. In some embodiments, the first stable resting configuration comprises a generally planar configuration. In some embodiments, the second stable resting configuration comprises a generally coil-shaped configuration. In some embodiments, the length of material comprises a length of spring steel having a generally arcuate cross-sectional shape when viewed along its longitudinal axis when the multi-modal fastener adopts the first stable resting configuration, wherein the first stable resting configuration is generally planar. In some embodiments, the multi-modal fastener further comprises: a securing portion disposed on one face (e.g., the second face) and proximal to the second end; and a mating portion disposed on the opposite face from the securing feature (e.g., the first face) and proximal to the first end and configured to reversibly mate with the securing portion. In some embodiments, the at least one securing feature includes at least one tooth. In some embodiments, the mating portion comprises at least one mating feature configured to reversibly mate with the securing portion. In some embodiments, the at least one mating feature comprises at least one locking pawl. In some embodiments, the securing portion comprises at least one securing tooth, and wherein the mating portion comprises at least one locking pawl configured to reversibly mate with the at least one securing tooth. In some embodiments, the multi-modal fastener further comprises a cover surrounding the length of material, wherein the cover includes the securing portion and the mating portion. In some embodiments, the multi-modal fastener further comprises a cover surrounding the length of material, wherein the cover includes the at least one cable grip feature. In some embodiments, the multi-modal fastener is bi-modal, and wherein the length of material is bi-modal.

In some embodiments, the present disclosure provides a multi-modal fastener including a first end, a second end opposite the first end, a first face, and a second face opposite the first face, the multi-modal fastener comprising: a length of material extending substantially from the first end to the second end; at least one internal cable grip feature disposed on the second face; and at least one external cable grip feature disposed on the first face, wherein the length of material is movable between a first stable resting configuration and a second stable resting configuration. In some embodiments, the first stable resting configuration comprises a generally planar configuration. In some embodiments, the second stable resting configuration comprises a generally coil-shaped configuration. In some embodiments, the length of material comprises a length of spring steel having a generally arcuate cross-sectional shape when viewed along its longitudinal axis when the multi-modal fastener adopts the first stable resting configuration, wherein the first stable resting configuration is generally planar. In some embodiments, the multi-modal fastener further comprises: a securing portion disposed on the first face and proximal to the second end; and a mating portion disposed on the second face and proximal to the first end and configured to reversibly mate with the securing portion. In some embodiments, the at least one securing feature includes at least one tooth. In some embodiments, the mating portion comprises at least one mating feature configured to reversibly mate with the securing portion. In some embodiments, the at least one mating feature comprises at least one locking pawl. In some embodiments, the securing portion comprises at least one securing tooth, and wherein the mating portion comprises at least one locking pawl configured to reversibly mate with the at least one securing tooth. In some embodiments, the multi-modal fastener further comprises a cover surrounding the length of material, wherein the cover includes the securing portion and the mating portion. In some embodiments, the multi-modal fastener further comprises a cover surrounding the length of material, wherein the cover includes the at least one internal cable grip feature and the at least one external cable grip feature. In some embodiments, the multi-modal fastener is bi-modal, and wherein the length of material is bi-modal.

In some embodiments, the present disclosure provides a bi-modal fastener including a first end, a second end opposite the first end, the bi-modal fastener comprising: a bi-modal length of material extending substantially from the first end to the second end and configured to selectively adopt a first stable generally planar resting configuration and a second stable generally coil-shaped resting configuration; a cover substantially surrounding the bi-modal length of material and including a first face, and a second face opposite the first face; and at least one cable grip feature disposed on the second face. In some embodiments, the bi-modal length of material comprises spring steel having a generally arcuate cross-sectional shape when viewed along its longitudinal axis and when the bi-modal length of material adopts the first stable generally planar resting configuration. In some embodiments, the bi-modal length of material comprises spring steel having a generally planar cross-sectional shape when viewed along its longitudinal axis and when the bi-modal length of material adopts the second stable generally coil-shaped resting configuration. In some embodiments, the bi-modal fastener further comprises: a securing portion disposed on the first face and proximal to the second end; and a mating portion disposed on the second face and proximal to the first end and configured to reversibly mate with the securing portion. In some embodiments, the at least one securing feature includes at least one tooth. In some embodiments, the mating portion comprises at least one mating feature configured to reversibly mate with the securing portion. In some embodiments, the at least one mating feature comprises at least one locking pawl. In some embodiments, the securing portion comprises at least one securing tooth, and wherein the mating portion comprises at least one locking pawl configured to reversibly mate with the at least one securing tooth. In some embodiments, the bi-modal fastener further comprises a cover surrounding the length of material, wherein the cover includes the securing portion and the mating portion. In some embodiments, the at least one cable grip feature is disposed on the second face. In some embodiments, the at least one cable grip feature is disposed on the first face. In some embodiments, the at least one cable grip feature includes at least one internal cable grip feature disposed on the second face, and at least one external grip feature disposed on the first face. In some embodiments, the bi-modal fastener further comprises a cover surrounding the length of material, wherein the cover includes the at least one cable grip feature. In some embodiments, the at least one internal cable grip is directly opposed from the at least one external cable grip feature. In some embodiments, the at least one internal cable grip is offset from the at least one external cable grip feature. In some embodiments, the at least one cable grip comprises a first flexible flap, and a second flexible flap disposed opposite the first flexible flap. In some embodiments, the at least one cable grip further comprises a base disposed between the first flexible flap and the second flexible flap.

### EXAMPLES

### Example 1

A loop-shaped fastener 1100 is prepared from a length of material 1110 having a first end 1112 and a second end 1114, an arcuate cross-sectional shape that is movable between a first generally planar resting configuration and a second generally curved configuration, and including a generally planar portion 1115 that does not adopt a generally curved second configuration. The loop-shaped fastener 1100 further includes a fastener 1120 including an adhesive patch on its first face 1116 and adjacent to the generally planar portion 1115.

This loop-shaped fastener 1100 is affixed to a sturdy surface, such as a wall, a ceiling, a floor, a beam, a truss, etc. While the loop-shaped fastener 1100 is in its first, generally planar configuration, a wire or cable is placed approximately mid-way between the first end 1112 and the second end 1114 of the length of material 1110. The length of material 1110 is then moved to its second generally curved configuration, thus securing the wire or cable to the sturdy surface. When the wire or cable must be removed, the loop-shaped fastener 1100 is moved back to its first generally planar configuration and the wire or cable is easily separated from the sturdy surface.

### Example 2

A fastener 2100 is prepared from a unimodal length of material by using a series of rollers and a mandrel to form an arcuate cross-sectional shape 2107 proximal to the second end 2114, creating bi-modal section 2105b. The resulting length of material 2105 includes a unimodal section 2105a at the first end 2112 and a bi-modal section 2105b at the second end. The bi-modal section 2105b includes an arcuate cross-sectional shape that is movable between a first generally planar, stable resting configuration and a second generally curved, stable resting configuration. The unimodal section 2105a includes a generally planar cross-sectional shape and does not adopt a generally curved second configuration. The length of material 2105 is surrounded by a cover 2116a/2118a made of a durable and flexible plastic material. A throughhole 2108 having a diameter sufficient to enable a #12 screw to pass therethrough (e.g., about 0.22 inches) extends through the unimodal portion 2101 of the fastener 2100.

The first face 2116 includes 5 to 15 locking teeth 2130 having a wedge-shaped cross-sectional shape near the second end 2114. The second face 2118 includes 1-5 receiving pawls 2120 each having a wedge-shaped cross-sectional shape and sized similarly to the locking teeth 2130. The receiving pawls 2120 are located near the intersection of the unimodal portion 2101 and the bi-modal portion 2102. When the locking teeth 2130 are slid past the receiving pawls 2120, a spring force created by flexing the bi-modal portion 2102 to adopt a radius that is smaller than its natural baseline radius pushes the locking teeth 2130 in an upward direction (e.g., towards the first end 2112). The receiving pawl(s) 2120 releasably engage with the locking teeth 2130, which in turn keeps the second end 2114 in contact or near-contact with the second face 2118.

### Example 3

A bi-modal fastener 4100 consistent with the present disclosure was prepared by adhering a plurality of teeth 4130 near the second end 4114 of a first face 4116 of a bi-modal steel strip 4105. A plurality of locking pawls 4120 were adhered near the first end 4112 of a second face 4118 of the bi-modal steel strip 4105. The bi-modal steel strip 4105 included an arcuate-shaped cross-sectional profile 4107 when the bi-modal steel strip 4105 adopted a first, substantially planar resting configuration. Application of force to the convex side of the arcuate-shaped cross-sectional profile 4107 caused the bi-modal steel strip 4105 to adopt a second, generally coil-shaped resting configuration; in this second stable configuration, the bi-modal steel strip 4105 did not include an arcuate-shaped cross-sectional profile 4107. Forcing the first end 4112 to overlap with the second end 4114 caused the teeth 4130 to engage with the locking pawls 4120. Lifting the first end 4112 away from the second end 4114 caused the teeth 4130 to disengage from the locking pawls 4120, enabling the bi-modal fastener to be returned to its first, substantially planar resting configuration.

### Example 4

A bi-modal fastener 4100 consistent with the present disclosure was prepared by surrounding a bimodal length of spring steel 4107 with repositionable self-fusing silicone tape (Harbor Products F4 Tape, part number CECOMINOD026831) such that substantially the entire length and width of the first cover piece 4116a exposed the self-fusing silicone tape material and such that substantially the entire length and width of the second cover piece 4118a also exposed the self-fusing silicone tape material. When inducing the bi-modal fastener 4100 to adopt its second (closed) resting configuration, the self-fusing silicone tape material on the first cover piece 4116a near the second end 4114 contacted the self-fusing silicone tape material on the second cover piece 4118a near the first end 4112. Upon contact, or shortly thereafter, the self-fusing silicone tape segments in contact with each other spontaneously fused, securing the second end 4114 to the first end 4112.

### FURTHER EXAMPLES

Further Example 1. A loop-shaped fastener comprising:
   a length of material including a first end, a second end opposite the first end, a first face, and a second face opposite the first face; and
   a fastener disposed on the first face,
wherein the length of material is movable between a first resting configuration and a second resting configuration.
Further Example 2. The loop-shaped fastener of Further Example 1, wherein the fastener is disposed substantially equidistant from the first end and the second end.
Further Example 3. The loop-shaped fastener of Further Example 1, wherein the fastener is disposed closer to the first end than the second end.
Further Example 4. The loop-shaped fastener of Further Example 1, wherein the fastener is disposed closer to the second end than the first end.
Further Example 5. The loop-shaped fastener of any one of Further Examples 1-4, wherein the first resting configuration comprises a generally planar configuration.
Further Example 6. The loop-shaped fastener of Further Example 5, wherein the first end and the second end are separated by a substantially maximum distance when the loop-shaped fastener is in the generally planar configuration.
Further Example 7. The loop-shaped fastener of any one of Further Examples 1-6, wherein the second resting configuration comprises a generally curved configuration.
Further Example 8. The loop-shaped fastener of Further Example 7, wherein the first end and the second end are separated by a substantially smaller distance compared to when the first loop-shaped fastener is in the generally planar configuration.
Further Example 9. The loop-shaped fastener of Further Example 7 or Further Example 8, wherein the generally curved configuration comprises a loop.
Further Example 10. The loop-shaped fastener of Further Example 9, wherein the loop has a discorectangle cross-sectional shape.
Further Example 11. The loop-shaped fastener of any one of Further Examples 1-10, wherein the length of material comprises spring steel that has a generally arcuate cross-sectional shape in its longitudinal direction.
Further Example 12. The loop-shaped fastener of any one of Further Examples 1-11, wherein the fastener is configured to mate with a second fastener.
Further Example 13. The loop-shaped fastener of Further Example 12, wherein the second fastener is associated with a first face of a second device comprising a second length of material including a first end, a second end opposite the first end, a first face, and a second face opposite the first face.
Further Example 14. The loop-shaped fastener of Further Example 13, wherein the second length of material is movable between a first resting configuration and a second resting configuration.
Further Example 15. The loop-shaped fastener of any of Further Examples 1-14, wherein the length of material of the loop-shaped fastener comprises a gap between the first end and the second end when the first length of material is in the second resting configuration.
Further Example 16. The loop-shaped fastener of any one of Further Examples 13-15, wherein the second length of material comprises a gap between the first end and the second end when the first length of material is in the second resting configuration.
Further Example 17. The loop-shaped fastener of any of Further Examples 1-16, wherein the first length of material comprises a generally planar portion that does not adopt a generally curved configuration when the first length of material adopts the second resting configuration.
Further Example 18. The loop-shaped fastener of any one of Further Examples 14-17, wherein the second length of material comprises a generally planar portion that does not adopt a generally curved configuration when the second length of material adopts the second resting configuration.
Further Example 19. A fastener system comprising:
   a first loop-shaped fastener device comprising a first length of material including a first end, a second end opposite the first end, a first face, and a second face opposite the first face; and a fastener disposed on the first face; and
   a second device removably associated with the first loop-shaped fastener,
wherein the first length of material is movable between a first resting configuration and a second resting configuration.
Further Example 20. The fastener system of Further Example 19, wherein the second device comprises a fastener capable of removably mating with the fastener of the first loop-shaped fastener.
Further Example 21. The fastener system of Further Example 19 or Further Example 20, wherein the second device is rotatably associated with the first loop-shaped fastener.
Further Example 22. The fastener system of any one of Further Examples 19-21, wherein the first resting configuration comprises a generally planar configuration wherein the first end and the second end are separated by a substantially maximum distance when the loop-shaped fastener is in the generally planar configuration.
Further Example 23. The fastener system of any one of Further Examples 19-22, wherein the second resting configuration comprises a generally curved configuration wherein the first end and the second end are separated by a substantially smaller distance compared to when the loop-shaped fastener is in the generally planar configuration.
Further Example 24. The fastener system of Further Example 22 or Further Example 23, wherein the generally curved configuration comprises a loop.
Further Example 25. The fastener system of Further Example 24, wherein the loop has a discorectangle cross-sectional shape.
Further Example 26. The fastener system of any one of Further Examples 19-25, wherein the first length of material comprises spring steel that has a generally arcuate cross-sectional shape in its longitudinal direction.
Further Example 27. The fastener system of any one of Further Examples 19-26, wherein the second device is a second loop-shaped fastener device comprising a second length of material including a first end, a second end opposite the first end, a first face, and a second face opposite the first face; and a fastener disposed on the first face, wherein the second length of material is movable between a first resting configuration and a second resting configuration.
Further Example 28. The fastener system of Further Example 27, wherein the second resting configuration of the second loop-shaped fastener device comprises a generally planar configuration wherein the first end and the second end are separated by a substantially maximum distance when the second loop-shaped fastener is in the generally planar configuration.
Further Example 29. The fastener system of Further Example 27 or Further Example 28, wherein the second resting configuration of the second loop-shaped fastener device comprises a generally curved configuration wherein the first end and the second end are separated by a substantially smaller distance compared to when the second loop-shaped fastener is in the generally planar configuration.
Further Example 30. The fastener system of Further Example 29, wherein the generally curved configuration comprises a loop.
Further Example 31. The fastener system of Further Example 30, wherein the loop has a discorectangle cross-sectional shape.
Further Example 32. The fastener system of any one of Further Examples 27-31, wherein the second length of material comprises spring steel that has a generally arcuate cross-sectional shape in its longitudinal direction.
Further Example 33. The fastener system of any one of Further Examples 19-32, wherein the first length of material comprises a generally planar portion that does not adopt a generally curved configuration when the first length of material adopts the second resting configuration.
Further Example 34. The fastener system of any one of Further Examples 27-33, wherein the second length of material comprises a generally planar portion that does not adopt a generally curved configuration when the second length of material adopts the second resting configuration.
Further Example 35. A fastener system comprising:
   a first loop-shaped fastener device comprising a first length of material including a first end, a second end opposite the first end, a first face, and a second face opposite the first face; and a fastener disposed on the first face; and
   a second loop-shaped fastener removably associated with the first loop-shaped fastener and comprising a second length of material including a first end, a second end opposite the first end, a first face, and a second face opposite the first face; and a fastener disposed on the first face,
wherein the first length of material is movable between an open resting configuration and a closed resting configuration, and
wherein the second length of material is movable between an open resting configuration and a closed resting configuration.
Further Example 36. A fastener including a first end, a second end opposite the first end, a first face, and a second face opposite the first face, the fastener comprising:
   a unimodal portion near the first end;
   a multi-modal portion near the second end;
   a unimodal section of material associated with the unimodal portion; and
   a multi-modal section of material associated with the multi-modal portion,
      wherein the multi-modal portion is movable between a first stable resting configuration and a second stable resting configuration.
Further Example 37. The fastener of Further Example 36 further comprising:
   a first mating portion disposed on the first face; and
   a second mating portion disposed on the second face and configured to selectively and temporarily mate with the first mating portion when the fastener is in the second stable resting configuration.
Further Example 38. The fastener of Further Example 37, wherein the first mating portion and the second mating portion are separated by a substantially maximum distance when the fastener is in the first resting configuration.
Further Example 39. The fastener of any one of Further Examples 36-38, wherein the first resting configuration comprises a generally planar configuration.
Further Example 40. The fastener of any one of Further Examples 36-39, wherein the first mating portion and the second mating portion are separated by a substantially smaller distance, compared to when the multi-modal portion is in the first resting configuration, when the multi-modal portion is in the second resting configuration.
Further Example 41. The fastener of Further Example 40, wherein the second resting configuration comprises a generally curved configuration.
Further Example 42. The fastener of Further Example 41, wherein the generally curved configuration comprises a loop or coil.
Further Example 43. The fastener of any one of Further Examples 36-42, wherein the first mating portion comprises at least one locking tooth.
Further Example 44. The fastener of any one of Further Examples 36-43, wherein the second mating portion comprises at least one receiving pawl.
Further Example 45. The fastener of any one of Further Examples 36-44 further comprising a cover substantially surrounding the unimodal section of material and the multi-modal section of material, wherein the cover includes the first mating portion and the second mating portion.
Further Example 46. The fastener of any one of Further Examples 36-45, wherein the unimodal section of material and the multi-modal section of material are a single continuous piece of material.
Further Example 47. The fastener of any one of Further Examples 36-45, wherein the unimodal section of material is a single piece of material and the multi-modal section of material is a single piece of material separate from the unimodal section of material.
Further Example 48. The fastener of any one of Further Examples 36-47, wherein the multi-modal section of material has an arcuate cross-sectional area when the multi-modal portion is in the first stable resting configuration.
Further Example 49. The fastener of Further Example 48, wherein the multi-modal section of material has a generally planar cross-sectional area when the multi-modal portion is in the second stable resting configuration.
Further Example 50. The fastener of any one of Further Examples 36-49, wherein the unimodal section of material comprises a multi-modal length of material and a rigid band substantially surrounding the unimodal section of material configured to prevent the unimodal section of material from moving between the first stable resting configuration and the second stable resting configuration.
Further Example 51. A fastener comprising:
   a length of material including a first end, a second end substantially opposite the first end, a first face, and a second face substantially opposite the first face;
   a first multimodal portion proximal to the first end; and
   a second multimodal portion proximal to the second end,
      wherein each multimodal portion is independently movable between a first resting configuration and a second resting configuration.
Further Example 52. The fastener of Further Example 51 further comprising a first securing portion configured to secure the first multimodal portion into a closed loop configuration.
Further Example 53. The fastener of Further Example 51 or Further Example 52 further comprising a second securing portion configured to secure the second multimodal portion into a closed loop configuration.
Further Example 54. The fastener of any one of Further Examples 51-53, wherein the first resting configuration is substantially planar.
Further Example 55. The fastener of any one of Further Examples 51-54, wherein the second resting configuration represents a loop or coil shape.
Further Example 56. The fastener of any one of Further Examples 51-55 further comprising a central portion disposed between the first multimodal portion and the second multimodal portion.
Further Example 57. The fastener of Further Example 56, wherein the central portion is not multimodal.
Further Example 58. The fastener of any one of Further Examples 51-57, wherein the first securing portion comprises:
   a first securing feature disposed proximal to the first end; and
   a first mating feature disposed proximal to the second multimodal portion and configured to reversibly mate with the first securing feature.
Further Example 59. The fastener of Further Example 58, wherein the length of material further comprises a central portion disposed between the first multimodal portion and the second multimodal portion, and wherein the first mating feature is disposed on the central portion.
Further Example 60. The fastener of Further Example 58 or Further Example 59, wherein the first securing portion is disposed on the first face, and wherein the first mating portion is disposed on the second face.
Further Example 61. The fastener of any one of Further Examples 51-60, wherein the second securing portion comprises:
   a second securing feature disposed proximal to the second end; and
   a second mating feature disposed proximal to the first multimodal portion and configured to reversibly mate with the second securing feature.
Further Example 62. The fastener of Further Example 61, wherein the length of material further comprises a central portion disposed between the first multimodal portion and the second multimodal portion, and wherein the second mating feature is disposed on the central portion.
Further Example 63. The fastener of Further Example 61 or Further Example 62, wherein the second securing portion is disposed on the second face, and wherein the second mating portion is disposed on the first face.
Further Example 64. The fastener of Further Example 61 or Further Example 62, wherein the second securing portion is disposed on the first face, and wherein the second mating portion is disposed on the second face.
Further Example 65. The fastener of any one of Further Examples 56-64, wherein the central portion is not multimodal.
Further Example 66. A fastener comprising:
   a first multimodal loop portion disposed at a first end;
   a second multimodal loop portion disposed at a second end substantially opposite the first end; and
   a central unimodal portion disposed between the first multimodal loop portion and the second multimodal loop portion,
      wherein the first multimodal loop portion and the second multimodal loop portion are each configured to independently adopt a first closed resting configuration and a second open resting configuration.
Further Example 67. The fastener of Further Example 66, wherein the first multimodal portion comprises:
   a first securing portion disposed on a first face of the fastener and proximal to the first end; and
   a first mating portion disposed on a second face of the fastener and proximal to the central portion.
Further Example 68. The fastener of Further Example 66 or Further Example 67, wherein the second multimodal portion comprises: a second securing portion disposed proximal to the second end; and a second mating portion disposed proximal to the central portion.
Further Example 69. The fastener of Further Example 68, wherein the second securing portion is disposed on the second face, and wherein the second mating portion is disposed on the first face.
Further Example 70. The fastener of Further Example 68, wherein the second securing portion is disposed on the first face, and wherein the second mating portion is disposed on the second face.
Further Example 71. The fastener of any one of Further Examples 51-70, wherein the first multimodal portion comprises spring steel that has a generally arcuate cross-sectional shape in its longitudinal direction when the first multimodal portion is in its second first resting configuration.
Further Example 72. The fastener of any one of Further Examples 51-71, wherein the second multimodal portion comprises spring steel that has a generally arcuate cross-sectional shape in its longitudinal direction when the second multimodal portion is in its second first resting configuration.
Further Example 73. The fastener of any one of Further Examples 51-72, wherein the first securing portion includes at least one tooth, and wherein the first mating portion includes at least one pawl for selectably mating with the at least one tooth.
Further Example 74. The fastener of any one of Further Examples 51-73, wherein the second securing portion includes at least one tooth, and wherein the second mating portion includes at least one pawl for selectably mating with the at least one tooth.
Further Example 75. A fastener comprising:
   a first bimodal portion at a first end of the fastener, the first bimodal portion configured to adopt a first generally planar mode and a second generally loop-shaped mode, the first bimodal portion comprising:
      a first length of spring steel having a generally arcuate cross-sectional shape in its longitudinal direction when the first bimodal portion is in the first generally planar mode, and
      a first securing portion disposed at a first end of the first bimodal portion and on a first face of the fastener;
   a second bimodal portion at a second end of the fastener, the second bimodal portion configured to adopt, independently of the first bimodal portion, a first generally planar mode and a second generally loop-shaped mode, the second bimodal portion comprising:
      a second length of spring steel having a generally arcuate cross-sectional shape in its longitudinal direction when the second bimodal portion is in the first generally planar mode, and
      a second securing portion disposed at a first end of the second bimodal portion; and
   a central unimodal portion disposed between the first bimodal portion and the second bimodal portion, the central unimodal portion comprising:
      a first mating portion disposed proximal to the first bimodal portion and on a second face of the fastener opposite the first face of the fastener, and
      a second mating portion disposed proximal to the second bimodal portion.
Further Example 76. The fastener of Further Example 75, wherein the second securing portion is disposed on the second face of the fastener, and wherein the second mating portion is disposed on the first face of the fastener.
Further Example 77. The fastener of Further Example 75, wherein the second securing portion is disposed on the first face of the fastener, and wherein the second mating portion is disposed on the second face of the fastener.
Further Example 78. The fastener of any one of Further Examples 75-77, wherein the first securing portion comprises at least one tooth, and the first mating portion comprises at least one pawl.
Further Example 79. The fastener of any one of Further Examples 75-78, wherein the second securing portion comprises at least one tooth, and the second mating portion comprises at least one pawl.
Further Example 80. The fastener of any one of Further Examples 75-79, wherein the first length of spring steel and the second length of spring steel are continuous.
Further Example 81. The fastener of any one of Further Example 75-80 further comprising a cover substantially surrounding the first and second lengths of spring steel.
Further Example 82. The fastener of any one of Further Examples 51-81, wherein the central portion or the central unimodal portion further comprises an attachment point.
Further Example 83. The fastener of Further Example 82, wherein the attachment point is a throughhole.
Further Example 84. A multi-modal fastener including a first end, a second end opposite the first end, a first face, and a second face opposite the first face, the multi-modal fastener comprising:
   a length of material extending substantially from the first end to the second end;
   a securing portion disposed proximal to the second end; and
   a mating portion disposed proximal to the first end and configured to reversibly mate with the securing portion,
      wherein the length of material is movable between a first stable resting configuration and a second stable resting configuration.
Further Example 85. The multi-modal fastener of Further Example 84, wherein the securing portion and the mating portion are separated by a substantially maximum distance when the fastener is in the first resting configuration.
Further Example 86. The multi-modal fastener of Further Example 84 or Further Example 85, wherein the first resting configuration comprises a generally planar configuration.
Further Example 87. The multi-modal fastener of any one of Further Examples 84-86, wherein the securing portion comprises at least one securing feature configured to reversibly mate with the mating portion.
Further Example 88. The multi-modal fastener of Further Example 87, wherein the at least one securing feature includes at least one tooth.
Further Example 89. The multi-modal fastener of any one of Further Examples 84-88, wherein the mating portion comprises at least one mating feature configured to reversibly mate with the securing portion.
Further Example 90. The multi-modal fastener of Further Example 89, wherein the at least one mating feature comprises at least one locking pawl.
Further Example 91. The multi-modal fastener of any one of Further Examples 84-90, wherein the securing portion comprises at least one securing tooth, and wherein the mating portion comprises at least one locking pawl configured to reversibly mate with the at least one securing tooth.
Further Example 92. The multi-modal fastener of any one of Further Examples 84-91 further comprising a cover surrounding the length of material, wherein the cover includes the securing portion and the mating portion.
Further Example 93. The multi-modal fastener of any one of Further Examples 84-92, wherein the length of material comprises a length of spring steel having a generally arcuate cross-sectional shape when viewed along its longitudinal axis when the multi-modal fastener adopts the first stable resting configuration, wherein the first stable resting configuration is generally planar.
Further Example 94. The multi-modal fastener of any one of Further Examples 84-93, wherein the securing portion is disposed on a first face and wherein the mating portion is disposed on a second face.
Further Example 95. A bi-modal fastener including a first end, a second end opposite the first end, the bi-modal fastener comprising:
   a bi-modal length of material extending substantially from the first end to the second end and configured to selectably adopt a first stable generally planar resting configuration and a second stable generally coil-shaped resting configuration;
   a cover substantially surrounding the bi-modal length of material and including a first face, and a second face opposite the first face;
   a mating portion comprising at least one mating feature disposed proximal to the first end and on the second face; and
   a securing portion comprising a plurality of securing features disposed proximal to the second end and on the first face, wherein the plurality of securing features are each configured to reversibly mate with the at least one mating feature.
Further Example 96. The bi-modal fastener of Further Example 95, wherein the bi-modal length of material comprises spring steel having a generally arcuate cross-sectional shape when viewed along its longitudinal axis and when the bi-modal length of material adopts the first stable generally planar resting configuration.
Further Example 97. The bi-modal fastener of Further Example 95 or Further Example 96, wherein the bi-modal length of material comprises spring steel having a generally planar cross-sectional shape when viewed along its longitudinal axis and when the bi-modal length of material adopts the second stable generally coil-shaped resting configuration.
Further Example 98. The bi-modal fastener of any one of Further Examples 95-97, wherein the at least one mating feature comprises a locking pawl.
Further Example 99. The bi-modal fastener of any one of Further Examples 95-98, wherein the at least one securing feature comprises a tooth.
Further Example 100. The fastener of any one of Further Examples 84-99 further comprising a handle associated with the length of material.
Further Example 101. The fastener of any one of Further Examples 84-100, wherein the length of material further comprises a throughhole disposed therethrough.
Further Example 102. The fastener of any one of Further Examples 84-101, wherein the fastener is configured to reversibly mate with a mount.
Further Example 103. The fastener of Further Example 102, wherein the mount is configured to reversibly mate with a plurality of fasteners.
Further Example 104. The fastener of any one of Further Examples 84-103 further comprising a writable surface.
Further Example 105. A multi-modal fastener including a first end, a second end opposite the first end, a first face, and a second face opposite the first face, the multi-modal fastener comprising:
   a length of material extending substantially from the first end to the second end; and
   at least one cable grip feature disposed on the second face,
      wherein the length of material is movable between a first stable resting configuration and a second stable resting configuration.
Further Example 106. The multi-modal fastener of Further Example 105, wherein the first stable resting configuration comprises a generally planar configuration.
Further Example 107. The multi-modal fastener of Further Example 105 or Further Example 106, wherein the second stable resting configuration comprises a generally coil-shaped configuration.
Further Example 108. The multi-modal fastener of any one of Further Examples 105-107, wherein the length of material comprises a length of spring steel having a generally arcuate cross-sectional shape when viewed along its longitudinal axis when the multi-modal fastener adopts the first stable resting configuration, wherein the first stable resting configuration is generally planar.
Further Example 109. The multi-modal fastener of any one of Further Examples 105-108 further comprising:
   a securing portion disposed on the second face and proximal to the second end; and
   a mating portion disposed on the first face and proximal to the first end and configured to reversibly mate with the securing portion.
Further Example 110. The multi-modal fastener of Further Example 109, wherein the at least one securing feature includes at least one tooth.
Further Example 111. The multi-modal fastener of Further Example 109 or Further Example 110, wherein the mating portion comprises at least one mating feature configured to reversibly mate with the securing portion.
Further Example 112. The multi-modal fastener of Further Example 111, wherein the at least one mating feature comprises at least one locking pawl.
Further Example 113. The multi-modal fastener of any one of Further Examples 109-112, wherein the securing portion comprises at least one securing tooth, and wherein the mating portion comprises at least one locking pawl configured to reversibly mate with the at least one securing tooth.
Further Example 114. The multi-modal fastener of any one of Further Examples 109-113 further comprising a cover surrounding the length of material, wherein the cover includes the securing portion and the mating portion.
Further Example 115. The multi-modal fastener of any one of Further Examples 105-114 further comprising a cover surrounding the length of material, wherein the cover includes the at least one cable grip feature.
Further Example 116. The multi-modal fastener of any one of Further Examples 105-115, wherein the multi-modal fastener is bi-modal, and wherein the length of material is bi-modal.
Further Example 117. A multi-modal fastener including a first end, a second end opposite the first end, a first face, and a second face opposite the first face, the multi-modal fastener comprising:
   a length of material extending substantially from the first end to the second end;
   at least one internal cable grip feature disposed on the second face; and
   at least one external cable grip feature disposed on the first face,
      wherein the length of material is movable between a first stable resting configuration and a second stable resting configuration.
Further Example 118. The multi-modal fastener of Further Example 117, wherein the first stable resting configuration comprises a generally planar configuration.
Further Example 119. The multi-modal fastener of Further Example 117 or Further Example 118, wherein the second stable resting configuration comprises a generally coil-shaped configuration.
Further Example 120. The multi-modal fastener of any one of Further Examples 117-119, wherein the length of material comprises a length of spring steel having a generally arcuate cross-sectional shape when viewed along its longitudinal axis when the multi-modal fastener adopts the first stable resting configuration, wherein the first stable resting configuration is generally planar.
Further Example 121. The multi-modal fastener of any one of Further Examples 117-120 further comprising:
   a securing portion disposed on the first face and proximal to the second end; and
   a mating portion disposed on the second face and proximal to the first end and configured to reversibly mate with the securing portion.
Further Example 122. The multi-modal fastener of Further Example 121, wherein the at least one securing feature includes at least one tooth.
Further Example 123. The multi-modal fastener of Further Example 121 or Further Example 122, wherein the mating portion comprises at least one mating feature configured to reversibly mate with the securing portion.
Further Example 124. The multi-modal fastener of Further Example 123, wherein the at least one mating feature comprises at least one locking pawl.
Further Example 125. The multi-modal fastener of any one of Further Examples 121-124, wherein the securing portion comprises at least one securing tooth, and wherein the mating portion comprises at least one locking pawl configured to reversibly mate with the at least one securing tooth.
Further Example 126. The multi-modal fastener of any one of Further Examples 121-125 further comprising a cover surrounding the length of material, wherein the cover includes the securing portion and the mating portion.
Further Example 127. The multi-modal fastener of any one of Further Examples 121-126 further comprising a cover surrounding the length of material, wherein the cover includes the at least one internal cable grip feature and the at least one external cable grip feature.
Further Example 128. The multi-modal fastener of any one of Further Examples 121-127, wherein the multi-modal fastener is bi-modal, and wherein the length of material is bi-modal.
Further Example 129. A bi-modal fastener including a first end, a second end opposite the first end, the bi-modal fastener comprising:
   a bi-modal length of material extending substantially from the first end to the second end and configured to selectively adopt a first stable generally planar resting configuration and a second stable generally coil-shaped resting configuration;
   a cover substantially surrounding the bi-modal length of material and including a first face, and a second face opposite the first face; and at least one cable grip feature disposed on the second face.
Further Example 130. The bi-modal fastener of Further Example 129, wherein the bi-modal length of material comprises spring steel having a generally arcuate cross-sectional shape when viewed along its longitudinal axis and when the bi-modal length of material adopts the first stable generally planar resting configuration.
Further Example 131. The bi-modal fastener of Further Example 129 or Further Example 130, wherein the bi-modal length of material comprises spring steel having a generally planar cross-sectional shape when viewed along its longitudinal axis and when the bi-modal length of material adopts the second stable generally coil-shaped resting configuration.
Further Example 132. The bi-modal fastener of any one of Further Examples 129-131 further comprising:
   a securing portion disposed on the first face and proximal to the second end; and
   a mating portion disposed on the second face and proximal to the first end and configured to reversibly mate with the securing portion.
Further Example 133. The bi-modal fastener of Further Example 132, wherein the at least one securing feature includes at least one tooth.
Further Example 134. The bi-modal fastener of Further Example 132 or Further Example 133, wherein the mating portion comprises at least one mating feature configured to reversibly mate with the securing portion.
Further Example 135. The bi-modal fastener of Further Example 134, wherein the at least one mating feature comprises at least one locking pawl.
Further Example 136. The bi-modal fastener of any one of Further Examples 132-135, wherein the securing portion comprises at least one securing tooth, and wherein the mating portion comprises at least one locking pawl configured to reversibly mate with the at least one securing tooth.
Further Example 137. The bi-modal fastener of any one of Further Example 132-136 further comprising a cover surrounding the length of material, wherein the cover includes the securing portion and the mating portion.
Further Example 138. The bi-modal fastener of any one of Further Examples 129-137, wherein the at least one cable grip feature is disposed on the second face.
Further Example 139. The bi-modal fastener of any one of Further Example 129-138, wherein the at least one cable grip feature is disposed on the first face.
Further Example 140. The bi-modal fastener of any one of Further Examples 129-137, wherein the at least one cable grip feature includes at least one internal cable grip feature disposed on the second face, and at least one external grip feature disposed on the first face.
Further Example 141. The bi-modal fastener of any one of Further Examples 132-140 further comprising a cover surrounding the length of material, wherein the cover includes the at least one cable grip feature.
Further Example 142. The bi-modal fastener of Further Example 140 or Further Example 141, wherein the at least one internal cable grip is directly opposed from the at least one external cable grip feature.
Further Example 143. The bi-modal fastener of Further Example 140 or Further Example 141, wherein the at least one internal cable grip is offset from the at least one external cable grip feature.
Further Example 144. The fastener of any one of Further Examples 105-143, wherein the at least one cable grip comprises a first flexible flap, and a second flexible flap disposed opposite the first flexible flap.
Further Example 145. The fastener of Further Example 144, wherein the at least one cable grip further comprises a base disposed between the first flexible flap and the second flexible flap.

1. A multi-modal fastener including a first end, a second end opposite the first end, a first face, and a second face opposite the first face, the multi-modal fastener comprising:
a length of material extending substantially from the first end to the second end;
a securing portion disposed proximal to the second end; and
a mating portion disposed proximal to the first end and configured to reversibly mate with the securing portion,
wherein the length of material is movable between a first stable resting configuration and a second stable resting configuration.

2. The multi-modal fastener of claim 1, wherein the securing portion and the mating portion are separated by a substantially maximum distance when the fastener is in the first resting configuration.

3. The multi-modal fastener of claim 1, wherein the first resting configuration comprises a generally planar configuration.

4. The multi-modal fastener of claim 1, wherein the securing portion comprises at least one securing feature configured to reversibly mate with the mating portion.

5. The multi-modal fastener of claim 4, wherein the at least one securing feature includes at least one tooth.

6. The multi-modal fastener of claim 1, wherein the mating portion comprises at least one mating feature configured to reversibly mate with the securing portion.

7. The multi-modal fastener of claim 6, wherein the at least one mating feature comprises at least one locking pawl.

8. The multi-modal fastener of claim 1, wherein the securing portion comprises at least one securing tooth, and wherein the mating portion comprises at least one locking pawl configured to reversibly mate with the at least one securing tooth.

9. The multi-modal fastener of claim 1 further comprising a cover surrounding the length of material, wherein the cover includes the securing portion and the mating portion.

10. The multi-modal fastener of claim 1 wherein the length of material comprises a length of spring steel having a generally arcuate cross-sectional shape when viewed along its longitudinal axis when the multi-modal fastener adopts the first stable resting configuration, wherein the first stable resting configuration is generally planar.

11. The multi-modal fastener of claim 1, wherein the securing portion is disposed on a first face and wherein the mating portion is disposed on a second face.

12. (canceled)

13. (canceled)

14. (canceled)

15. (canceled)

16. (canceled)

17. The multi-modal fastener of claim 1 further comprising a handle associated with the length of material.

18. The multi-modal fastener of claim 1, wherein the length of material further comprises a throughhole disposed therethrough.

19. The multi-modal fastener of claim 1, wherein the fastener is configured to reversibly mate with a mount.

20. The multi-modal fastener of claim 19, wherein the mount is configured to reversibly mate with a plurality of fasteners.

21. The multi-modal fastener of claim 1 further comprising a writable surface.

22. The multi-modal fastener of claim 4, wherein the securing feature comprises a self-fusing material.

23. The multi-modal fastener of claim 6, wherein the mating feature comprises a self-fusing material.

24. The multi-modal fastener of claim 1, wherein the length of material comprises spring steel having a generally arcuate cross-sectional shape when viewed along its longitudinal axis.

25. The multi-modal fastener of claim 22, wherein the self-fusing material is a repositionable self-fusing material.
